(19) United States
(12) Patent Application Publication
(10) Pub. No.: US 2024/0308505 A1
(43) Pub. Date: Sep. 19, 2024

(54) PREDICTION USING A COMPRESSION NETWORK

(71) Applicant: QUALCOMM Incorporated, San Diego, CA (US)

(72) Inventors: Thomas Alexander RYDER, San Diego, CA (US); Muhammed Zeyd COBAN, Carlsbad, CA (US); Marta KARCZEWICZ, San Diego, CA (US)

(21) Appl. No.: 18/183,867

(22) Filed: Mar. 14, 2023

(51) Int. Cl. B60W 30/095; G06T 7/215

(52) U.S. Cl. CPC B60W 30/0953; G06T 7/215

(57) ABSTRACT

A device includes one or more processors configured to obtain encoded data associated with one or more motion values. The one or more processors are also configured to obtain conditional input of a compression network, wherein the conditional input is based on one or more first predicted motion values. The one or more processors are further configured to process, using the compression network, the encoded data and the conditional input to generate one or more second predicted motion values.

### I. FIELD

The present disclosure is generally related to performing prediction using a compression network.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to process large amounts of data. Compressing the data prior to storage or transmission can conserve resources such as memory and bandwidth. For example, a computing device can generate an encoded version of an image frame that uses fewer bits than the original image frame. Techniques that reduce the size of the compressed data can further conserve resources.

### III. SUMMARY

According to one implementation of the present disclosure, a device includes one or more processors configured to obtain encoded data associated with one or more motion values. The one or more processors are also configured to obtain conditional input of a compression network, wherein the conditional input is based on one or more first predicted motion values. The one or more processors are further configured to process, using the compression network, the encoded data and the conditional input to generate one or more second predicted motion values.

According to another implementation of the present disclosure, a method includes obtaining, at a device, encoded data associated with one or more motion values. The method also includes obtaining, at the device, conditional input of a compression network, wherein the conditional input is based on one or more first predicted motion values. The method also includes processing, using the compression network, the encoded data and the conditional input to generate one or more second predicted motion values.

According to another implementation of the present disclosure, a non-transitory computer-readable medium includes instructions that, when executed by one or more processors, cause the one or more processors to obtain encoded data associated with one or more motion values. The instructions, when executed by the one or more processors, also cause the one or more processors to obtain conditional input of a compression network, wherein the conditional input is based on one or more first predicted motion values. The instructions, when executed by the one or more processors, further cause the one or more processors to process, using the compression network, the encoded data and the conditional input to generate one or more second predicted motion values.

According to another implementation of the present disclosure, an apparatus includes means for obtaining encoded data associated with one or more motion values. The apparatus also includes means for obtaining conditional input of a compression network, wherein the conditional input is based on one or more first predicted motion values. The apparatus further includes means for processing, using the compression network, the encoded data and the conditional input to generate one or more second predicted motion values.

According to another implementation of the present disclosure, a device includes one or more processors configured to obtain conditional input of a compression network, wherein the conditional input is based on one or more first predicted motion values. The one or more processors are further configured to process, using the compression network, the conditional input and one or more motion values to generate encoded data associated with the one or more motion values.

According to another implementation of the present disclosure, a method includes obtaining, at a device, conditional input of a compression network, wherein the conditional input is based on one or more first predicted motion values. The method also includes processing, using the compression network, the conditional input and one or more motion values to generate encoded data associated with the one or more motion values.

According to another implementation of the present disclosure, a non-transitory computer-readable medium includes instructions that, when executed by one or more processors, cause the one or more processors to obtain conditional input of a compression network, wherein the conditional input is based on one or more first predicted motion values. The instructions, when executed by the one or more processors, also cause the one or more processors to process, using the compression network, the conditional input and one or more motion values to generate encoded data associated with the one or more motion values.

According to another implementation of the present disclosure, an apparatus includes means for obtaining conditional input of a compression network, wherein the conditional input is based on one or more first predicted motion values. The apparatus also includes means for processing, using the compression network, the conditional input and one or more motion values to generate encoded data associated with the one or more motion values.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a compression network operable to perform prediction, in accordance with some examples of the present disclosure.

FIG. 2 is a diagram of an illustrative aspect of a system operable to perform prediction using a compression network, in accordance with some examples of the present disclosure.

FIG. 3 is a diagram of an illustrative aspect of a system operable to perform prediction using a compression network, in accordance with some examples of the present disclosure.

FIG. 4 is a diagram of an illustrative aspect of an example of an encoder portion of a compression network that is operable to perform prediction, in accordance with some examples of the present disclosure.

FIG. 5 is a diagram of an illustrative aspect of an example of a decoder portion of the compression network that is operable to perform prediction, in accordance with some examples of the present disclosure.

FIG. 6 is a diagram of an illustrative aspect of an example of an encoder portion of a compression network that is operable to perform prediction corresponding to reconstruction, in accordance with some examples of the present disclosure.

FIG. 7 is a diagram of an illustrative aspect of an example of a decoder portion of the compression network that is operable to perform prediction corresponding to reconstruction, in accordance with some examples of the present disclosure.

FIG. 8 is a diagram of an illustrative aspect of an example of an encoder portion of a compression network that is operable to perform prediction corresponding to reconstruction based on auxiliary prediction, in accordance with some examples of the present disclosure.

FIG. 9 is a diagram of an illustrative aspect of an example of a decoder portion of the compression network that is operable to perform prediction corresponding to reconstruction based on auxiliary prediction, in accordance with some examples of the present disclosure.

FIG. 10 is a diagram of an illustrative aspect of an example of an encoder portion of a compression network that is operable to perform prediction corresponding to low-latency reconstruction, in accordance with some examples of the present disclosure.

FIG. 11 is a diagram of an illustrative aspect of an example of a decoder portion of the compression network that is operable to perform prediction corresponding to low-latency reconstruction, in accordance with some examples of the present disclosure.

FIG. 12 is a diagram of an illustrative aspect of an example of an encoder portion of a compression network that is operable to perform prediction corresponding to future prediction, in accordance with some examples of the present disclosure.

FIG. 13 is a diagram of an illustrative aspect of an example of a decoder portion of the compression network that is operable to perform prediction corresponding to future prediction, in accordance with some examples of the present disclosure.

FIG. 14 is a diagram of an illustrative aspect of an example of a motion estimation encoder portion of a compression network that is operable to perform prediction corresponding to image reconstruction, in accordance with some examples of the present disclosure.

FIG. 15 is a diagram of an illustrative aspect of an example of a motion estimation decoder portion of the compression network that is operable to perform prediction corresponding to image reconstruction, in accordance with some examples of the present disclosure.

FIG. 16 is a diagram of an illustrative aspect of an example of an image estimator of a compression network that is operable to perform prediction corresponding to image reconstruction, in accordance with some examples of the present disclosure.

FIG. 17 is a diagram of an illustrative aspect of an example of an image encoder portion of the compression network that is operable to perform prediction corresponding to image reconstruction, in accordance with some examples of the present disclosure.

FIG. 18 is a diagram of an illustrative aspect of an example of an image decoder portion of the compression network that is operable to perform prediction corresponding to image reconstruction, in accordance with some examples of the present disclosure.

FIG. 19 is a diagram of an illustrative aspect of an example of a motion estimation encoder portion of a compression network that is operable to perform prediction corresponding to low-latency image reconstruction, in accordance with some examples of the present disclosure.

FIG. 20 is a diagram of an illustrative aspect of an example of a motion estimation decoder portion of the compression network that is operable to perform prediction corresponding to low-latency image reconstruction, in accordance with some examples of the present disclosure.

FIG. 21 is a diagram of an illustrative aspect of an example of an image estimator of a compression network that is operable to perform prediction corresponding to low-latency image reconstruction, in accordance with some examples of the present disclosure.

FIG. 22 is a diagram of an illustrative aspect of an example of an image encoder portion of the compression network that is operable to perform prediction corresponding to low-latency image reconstruction, in accordance with some examples of the present disclosure.

FIG. 23 is a diagram of an illustrative aspect of an example of an image decoder portion of the compression network that is operable to perform prediction corresponding to low-latency image reconstruction, in accordance with some examples of the present disclosure.

FIG. 24 illustrates an example of an integrated circuit operable to perform prediction using a compression network, in accordance with some examples of the present disclosure.

FIG. 25 is a diagram of a mobile device operable to perform prediction using a compression network, in accordance with some examples of the present disclosure.

FIG. 26 is a diagram of a headset operable to perform prediction using a compression network, in accordance with some examples of the present disclosure.

FIG. 27 is a diagram of a wearable electronic device operable to perform prediction using a compression network, in accordance with some examples of the present disclosure.

FIG. 28 is a diagram of a voice-controlled speaker system operable to perform prediction using a compression network, in accordance with some examples of the present disclosure.

FIG. 29 is a diagram of a camera operable to perform prediction using a compression network, in accordance with some examples of the present disclosure.

FIG. 30 is a diagram of a headset, such as a virtual reality, mixed reality, or augmented reality headset, operable to perform prediction using a compression network, in accordance with some examples of the present disclosure.

FIG. 31 is a diagram of a first example of a vehicle operable to perform prediction using a compression network, in accordance with some examples of the present disclosure.

FIG. 32 is a diagram of a second example of a vehicle operable to perform prediction using a compression network, in accordance with some examples of the present disclosure.

FIG. 33 is a diagram of a particular implementation of a method of generating encoded data using the compression network of FIG. 1, in accordance with some examples of the present disclosure.

FIG. 34 is a diagram of a particular implementation of a method of generating predicted data from encoded data using the compression network of FIG. 1, in accordance with some examples of the present disclosure.

FIG. 35 is a block diagram of a particular illustrative example of a device that is operable to perform prediction using a compression network, in accordance with some examples of the present disclosure.

### V. DETAILED DESCRIPTION

Computing devices often incorporate functionality to process large amounts of data. Compressing the data prior to storage or transmission can conserve resources such as memory and bandwidth. For example, a computing device can generate an encoded version of an image frame that uses fewer bits than the original image frame. Techniques that reduce the size of the compressed data can further conserve resources. The compressed data can be processed to generate predicted data. For example, the predicted data can correspond to a reconstructed version of the image frame, a predicted future image frame in a sequence of images that includes the image frame, a classification of the image frame, other types of data associated with the image frame, or a combination thereof.

Systems and methods of performing prediction using a compression network are disclosed. For example, a compression network includes an encoder portion and a decoder portion. The encoder portion is configured to process an input value of a sequence of input values and encoder conditional input to generate encoded data. The encoded data corresponds to a compressed version of (has fewer bits than) the input value. The decoder portion is configured to process the encoded data and decoder conditional input to generate a predicted value associated with the input value.

The encoder conditional input is an estimate of the decoder conditional input. For example, the decoder conditional input is based on a previously predicted value generated at the decoder portion, a local decoder portion at the encoder portion is used to generate an estimate of the previously predicted value, and the encoder conditional input is based on the estimate of the previously predicted value. Generating the encoded data based on an estimate of information (e.g., the previously predicted value) that is available at the decoder portion can reduce the size of information (e.g., the encoded data) that has to be provided to the decoder portion to generate the predicted value.

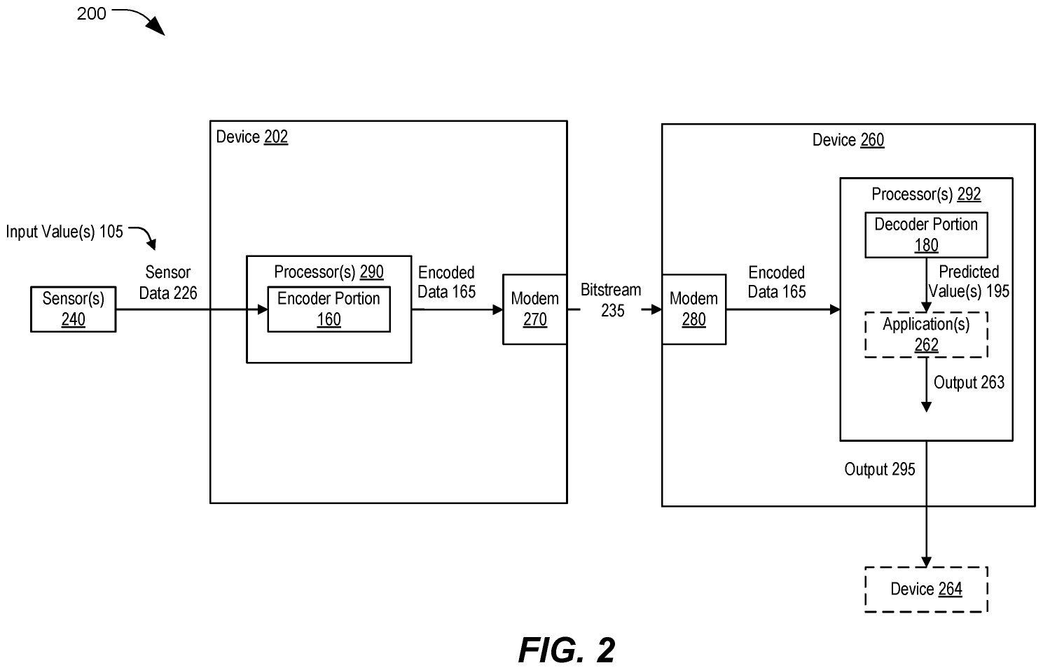

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 2 depicts a device 202 including one or more processors (“processor(s)” 290 of FIG. 2), which indicates that in some implementations the device 202 includes a single processor 290 and in other implementations the device 202 includes multiple processors 290. For ease of reference herein, such features are generally introduced as “one or more” features and are subsequently referred to in the singular unless aspects related to multiple of the features are being described.

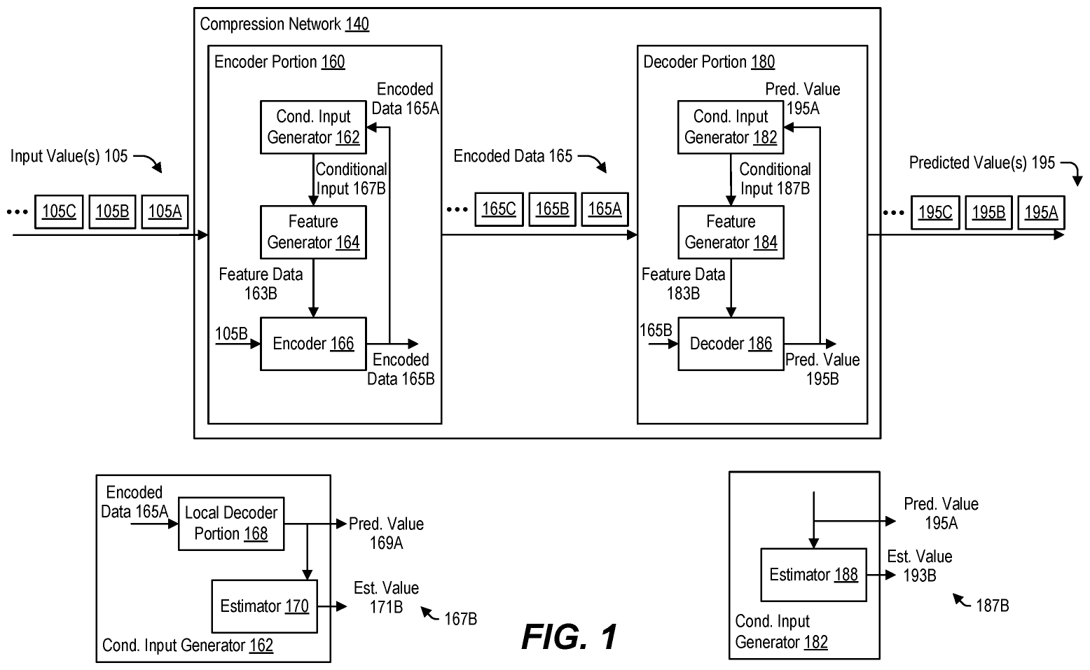

In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple input values are illustrated and associated with reference numbers 105A, 105B, and 105C. When referring to a particular one of these input values, such as an input value 105A, the distinguishing letter “A” is used. However, when referring to any arbitrary one of these input values or to these input values as a group, the reference number 105 is used without a distinguishing letter.

As used herein, the terms “comprise,” “comprises,” and “comprising” may be used interchangeably with “include.” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating.” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a compression network configured to perform prediction is disclosed and generally designated 140. The compression network 140 includes an encoder portion 160 that is configured to be coupled to a decoder portion 180.

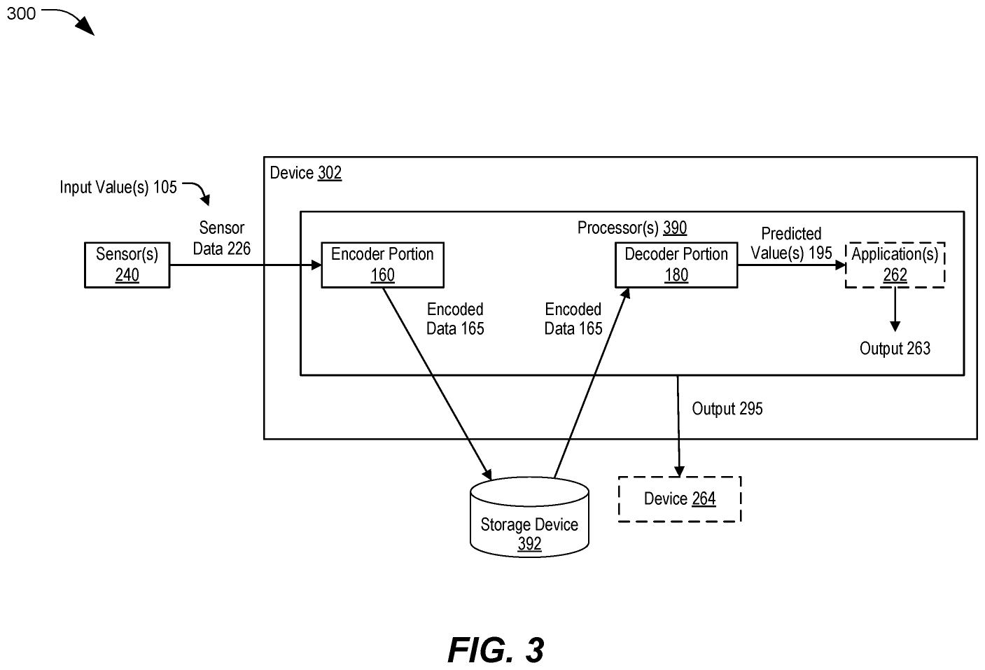

In some aspects, the encoder portion 160 is included in a first device that is different from a second device that includes the decoder portion 180, as further described with reference to FIG. 2. To illustrate, in these aspects, the compression network 140 can be used to reduce resource usage (e.g., memory, bandwidth, transmission time, etc.) associated with transmission of data from the first device to the second device. In other aspects, the encoder portion 160 and the decoder portion 180 are included in a single device, as further described with reference to FIG. 3. To illustrate, in these aspects, the compression network 140 can be used to reduce resource usage (e.g., memory) associated with storing data for access by the device.

The encoder portion 160 is configured to process one or more input values 105 to generate one or more sets of encoded data 165. In an example, the one or more input values 105 include an input value 105A, an input value 105B, and an input value 105C, one or more additional input values, or a combination thereof. The encoder portion 160 is configured to process the input value 105A to generate encoded data 165A, process the input value 105B to generate encoded data 165B, process the input value 105C to generate encoded data 165C, and so on.

The encoder portion 160 includes a conditional input generator 162 coupled via a feature generator 164 to an encoder 166. In some examples, the encoder 166 is configured to process some of the one or more input values 105 (e.g., key values) to generate corresponding encoded data independently of others of the input values 105. In an example, the input value 105A corresponds to a key image frame (e.g., an intra-frame or I-frame) and the encoder 166 processes the input value 105A to generate the encoded data 165A independently of others of the one or more input values 105. In some examples, the encoder 166 is configured to process some of the one or more input values 105 based on at least one other of the one or more input values 105 (e.g., non-key values) to generate corresponding encoded data. In an example, the input value 105B corresponds to a non-key image frame, such as a predicted frame (P-frame) or a bi-directional frame (B-frame), and the encoder 166 processes the input value 105B based on the encoded data 165A (corresponding to the input value 105A) to generate the encoded data 165B. To illustrate, the conditional input generator 162 is configured to process the encoded data 165A to generate conditional input 167B, the feature generator 164 is configured to process the conditional input 167B to generate feature data 163B, and the encoder 166 is configured to process the input value 105B and the feature data 163B to generate the encoded data 165B.

The decoder portion 180 is configured to process the one or more sets of encoded data 165 to generate one or more predicted values 195. In an example, the decoder portion 180 is configured to process the encoded data 165A to generate a predicted value 195A, process the encoded data 165B to generate a predicted value 195B, process the encoded data 165C to generate a predicted value 195C, and so on.

The decoder portion 180 includes a conditional input generator 182 coupled via a feature generator 184 to a decoder 186. In some examples, the decoder 186 is configured to process some of the sets of encoded data 165 to generate corresponding predicted values independently of other sets of the encoded data 165. In an example, the decoder 186 processes the encoded data 165A to generate the predicted value 195A independently of others of the sets of the encoded data 165. In some examples, the decoder 186 is configured to process some of the sets of encoded data 165 based on at least one other set of the encoded data 165 to generate corresponding predicted values. For example, the decoder 186 processes the encoded data 165B based on a predicted value 195A (corresponding to the encoded data 165A) to generate the predicted value 195B. To illustrate, the conditional input generator 182 is configured to process the predicted value 195A to generate conditional input 187B, the feature generator 184 is configured to process the conditional input 187B to generate feature data 183B, and the decoder 186 is configured to process the encoded data 165B and the feature data 183B to generate the predicted value 195B.

The conditional input 167B at the encoder portion 160 corresponds to an estimate of the conditional input 187B available at the decoder portion 180. A technical advantage of generating the encoded data 165B based on an estimate of information (e.g., the conditional input 187B) that is available at the decoder portion 180 can include reducing the size of information (e.g., the encoded data 165B) that has to be provided to the decoder portion 180 to generate the predicted value 195B.

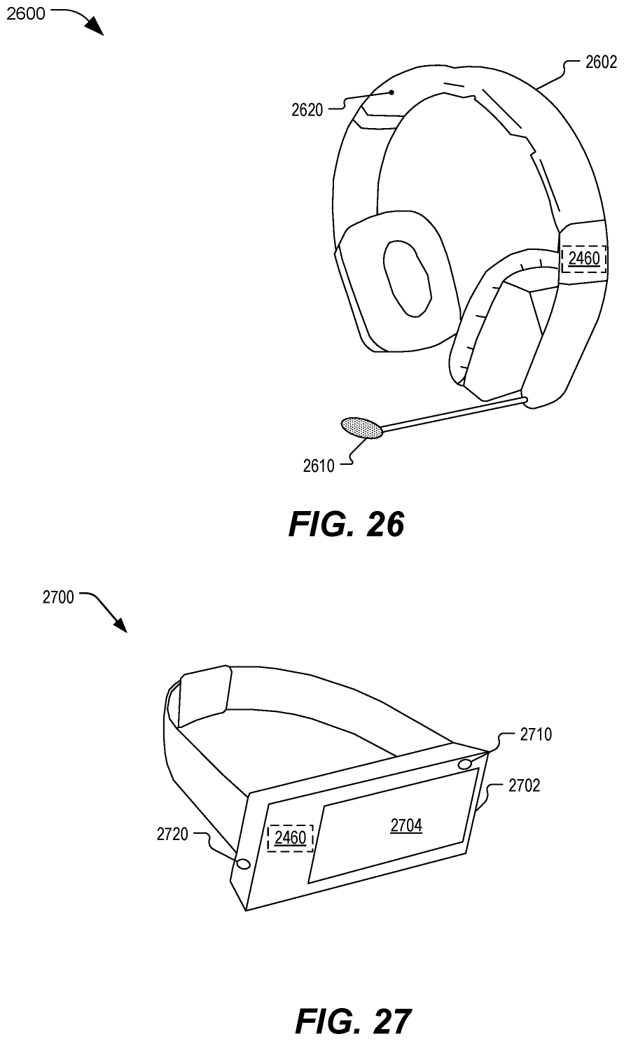

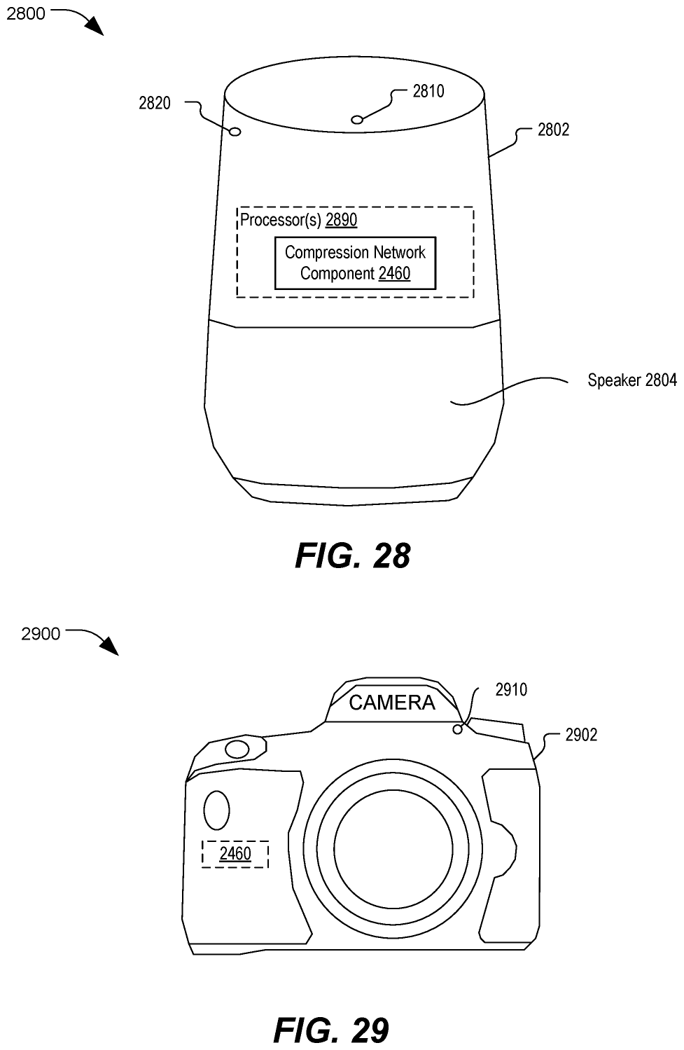

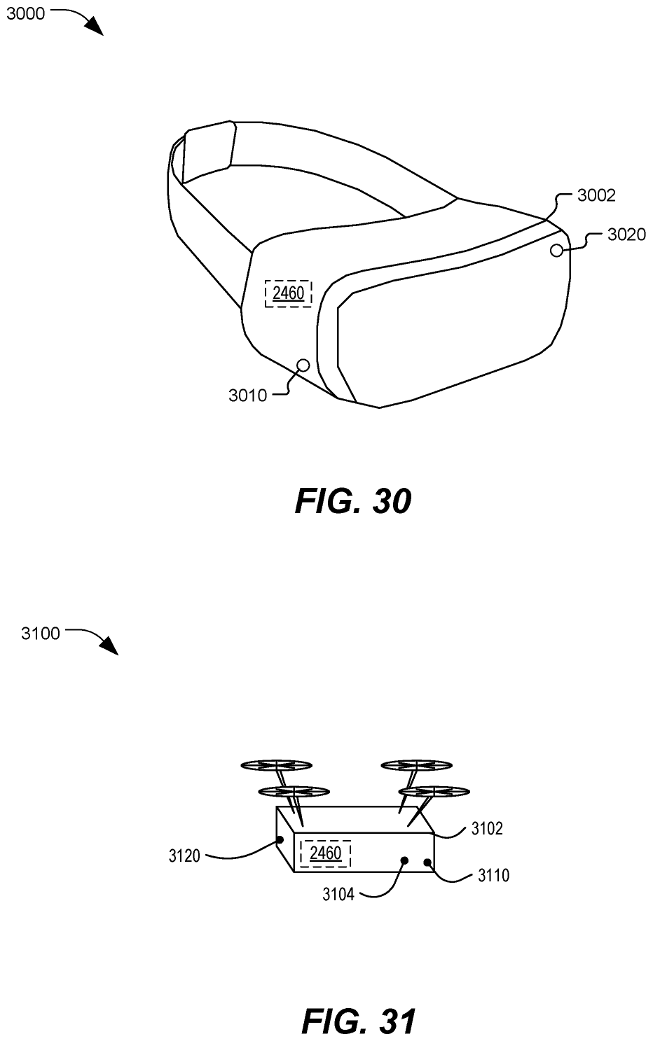

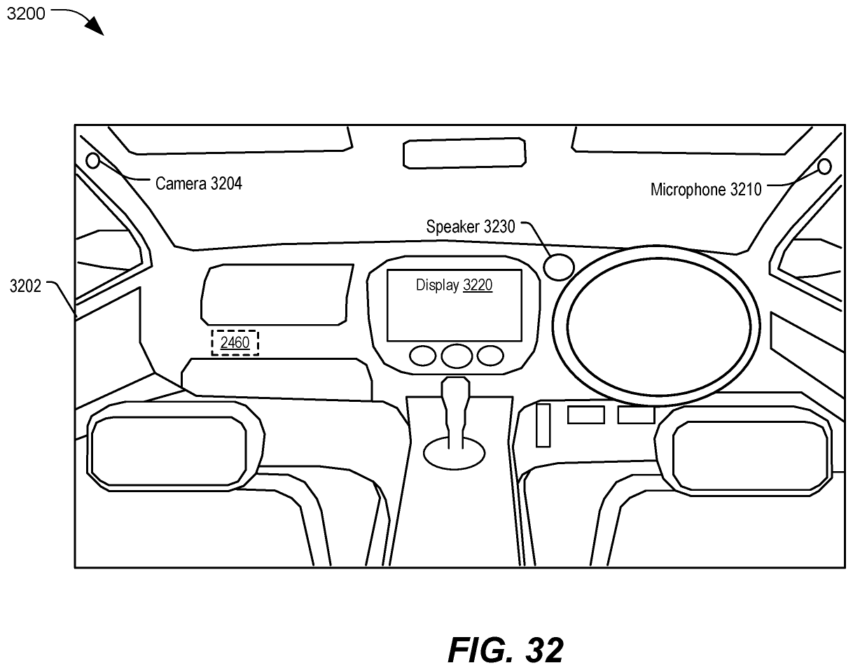

In some implementations, a compression network component (e.g., the encoder portion 160, the decoder portion 180, or both) of the compression network 140 corresponds to, or is included in, one of various types of devices. In an illustrative example, the compression network component is integrated in a headset device, such as described further with reference to FIG. 26. In other examples, the compression network component is integrated in at least one of a mobile phone or a tablet computer device, as described with reference to FIG. 25, a wearable electronic device, as described with reference to FIG. 27, a voice-controlled speaker system, as described with reference to FIG. 28, a camera device, as described with reference to FIG. 29, or a virtual reality, mixed reality, or augmented reality headset, as described with reference to FIG. 30. In another illustrative example, the compression network component is integrated into a vehicle, such as described further with reference to FIG. 31 and FIG. 32.

During operation, the encoder portion 160 obtains one or more input values 105. In some implementations, the one or more input values 105 are based on output of one or more sensors, as further described with reference to FIG. 2. As illustrative non-limiting examples, the one or more sensors can include an image sensor, an inertial measurement unit (IMU), a motion sensor, a temperature sensor, another type of sensor, or a combination thereof. In some implementations, the encoder portion 160 obtains the one or more input values 105 from a storage device, a processor, another device, or a combination thereof.

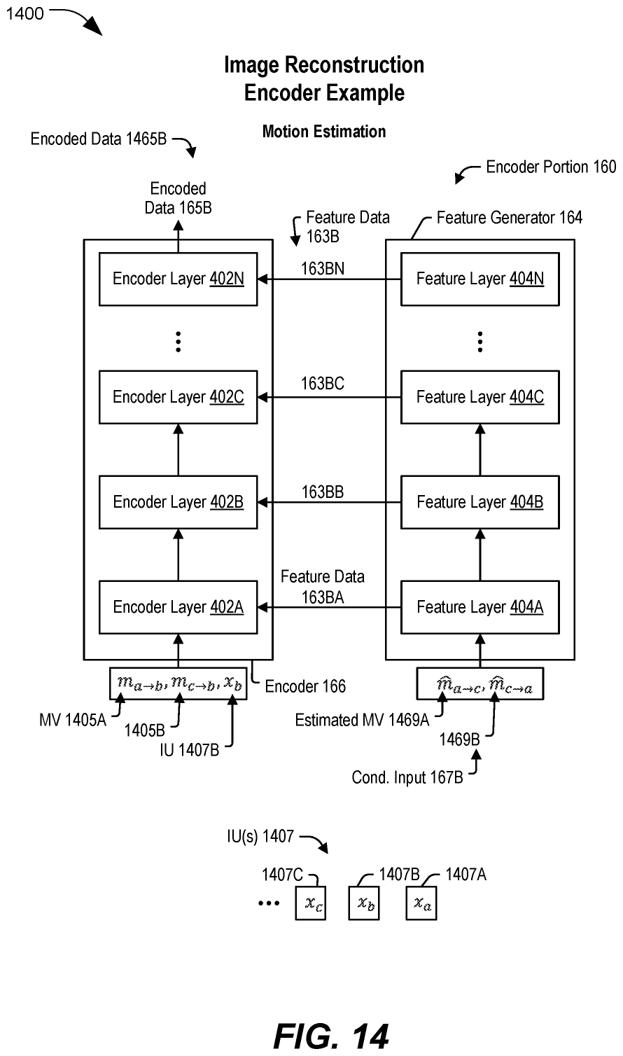

In some implementations, the one or more input values 105 indicate motion, as further described with reference to FIG. 14. For example, the input value 105A includes a first image frame captured by a camera of a vehicle, and the input value 105B includes a second image frame captured by the camera. A difference between the first image frame and the second image frame can indicate a speed and direction of movement of the vehicle. The one or more input values 105 including image frames indicating motion is provided as an illustrative example, in other examples the one or more input values 105 can include other types of data indicating motion. The one or more input values 105 indicating motion is provided as an illustrative example, in other examples the one or more input values 105 can correspond to data indicating other types of information.

The encoder portion 160 generates sets of encoded data 165 corresponding to the one or more input values 105. For example, the encoder 166 processes the input value 105A to generate the encoded data 165A. In some implementations, the encoder 166, based on determining that the input value 105A satisfies an independent encoding criterion, processes (e.g., encodes) the input value 105A to generate the encoded data 165A independently of others of the one or more input values 105. In an example, the encoder 166 determines that the independent encoding criterion is satisfied based on determining that the input value 105A is an initial value of the one or more input values 105, that the input value 105A corresponds to a key value (e.g., an I-frame), that at least a threshold count of input values have been encoded since a most recently independently encoded input value, that a difference between the input value 105A and a previous input value of the one or more input values 105 is greater than a difference threshold (e.g., because of a scene change in image frames), or a combination thereof.

As another example, the encoder 166 processes the input value 105B to generate the encoded data 165B. In some implementations, the encoder 166, in response to determining that the input value 105B fails to satisfy the independent encoding criterion, processes the input value 105B based at least in part on encoded data 165A of an input value 105A. In some aspects, the encoder 166 selects the encoded data 165A for processing the input value 105B based on determining that the input value 105A corresponds to a value (e.g., a key value) of the one or more input values 105 that is most recently independently encoded to generate the encoded data 165A. In some aspects, the encoder 166 selects the encoded data 165A for processing the input value 105B based on determining the input value 105B corresponds to a next value in the one or more input values 105 after the input value 105A. In these aspects, the input value 105A can correspond to a key value that is independently encoded to generate the encoded data 165A or a non-key value that is encoded based on at least one other of the one or more input values 105.

The encoder portion 160, in response to determining that the input value 105B fails to satisfy the independent encoding criterion, provides the encoded data 165A to the conditional input generator 162 to obtain conditional input 167B of the compression network 140. The conditional input generator 162 includes a local decoder portion 168, an estimator 170, or both. In some aspects, the local decoder portion 168 is configured to perform similar operations as the decoder portion 180. For example, the local decoder portion 168 performs one or more operations described herein with reference to the decoder portion 180 to process the encoded data 165A to generate a predicted value 169A. The predicted value 169A corresponds to an estimate of a predicted value 195A that can be generated at the decoder portion 180 by processing the encoded data 165A.

Optionally, in some implementations, the estimator 170 processes the predicted value 169A to generate an estimated value 171B. In some aspects, the estimated value 171B corresponds to an estimate of the input value 105B that can be generated at the decoder portion 180 based on the predicted value 195A. In some aspects, the more closely the estimated value 171B approximates the input value 105B, the less information has to be provided to the decoder portion 180 as the encoded data 165B.

The conditional input 167B is based on the predicted value 169A, the estimated value 171B, or both. In some implementations, the conditional input 167B can be based on one or more additional predicted values, one or more additional estimated values, or a combination thereof, associated with one or more others of the one or more input values 105.

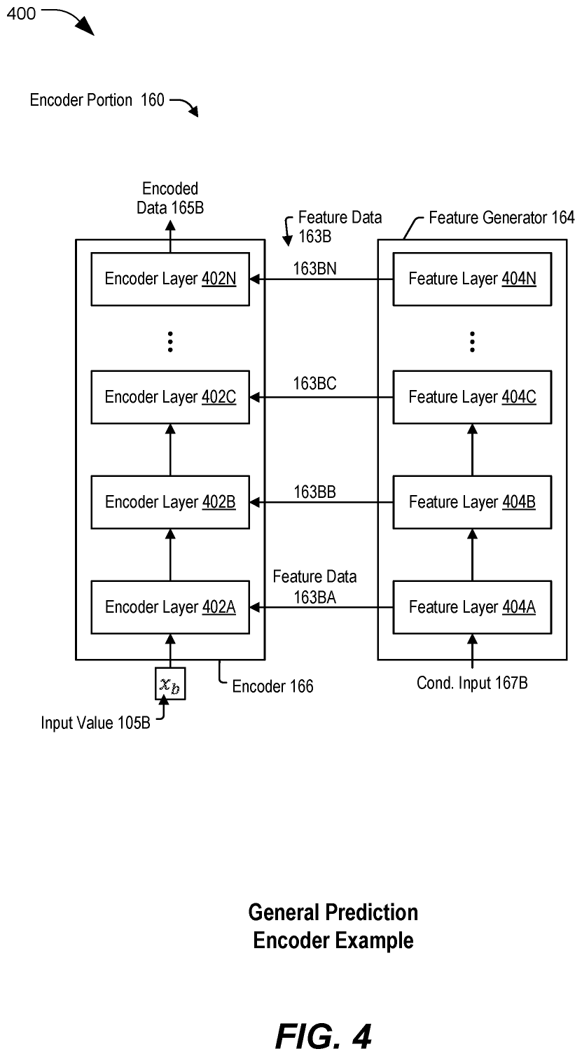

The encoder portion 160, in response to determining that the input value 105B fails to satisfy the independent encoding criterion, uses the compression network 140 to process the input value 105B and the conditional input 167B to generate the encoded data 165B associated with the input value 105B. For example, the feature generator 164 processes the conditional input 167B to generate feature data 163B, as further described with reference to FIG. 4. In some implementations, the feature data 163B corresponds to multi-scale feature data having different resolutions (e.g., different spatial resolutions). In some implementations, the feature data 163B includes multi-scale wavelet transform data. The encoder 166 processes the input value 105B and the feature data 163B to generate the encoded data 165B, as further described with reference to FIG. 4.

The decoder portion 180 obtains one or more of the sets of encoded data 165 associated with the one or more input values 105. In some implementations, the encoder portion 160 at a first device provides the encoded data 165 via a bitstream to the decoder portion 180 at a second device, as further described with reference to FIG. 2. In other implementations, the encoder portion 160 stores the encoded data 165 at a storage device, and the decoder portion 180 retrieves the encoded data 165 from the storage device, as further described with reference to FIG. 3.

The decoder portion 180 generates one or more predicted values 195 corresponding to the sets of encoded data 165. For example, the decoder 186 processes the encoded data 165A to generate a predicted value 195A. In some implementations, the decoder 186, based on determining that the encoded data 165A satisfies an independent decoding criterion, processes (e.g., decodes) the encoded data 165A to generate the predicted value 195A independently of others of the one or more predicted values 195. In an example, the decoder 186 determines that the independent encoding criterion is satisfied based on determining that metadata associated with the encoded data 165 indicates that the encoded data 165 corresponds to a key value (e.g., an I-frame), that the encoded data 165 is to be decoded independently, or both.

As another example, the decoder 186 processes the encoded data 165B to generate the predicted value 195B. In some implementations, the decoder 186, in response to determining that the encoded data 165B fails to satisfy the independent decoding criterion, processes the encoded data 165B based at least in part on a predicted value 195A corresponding to encoded data 165A that is associated with an input value 105A. In some aspects, the decoder 186 selects the predicted value 195A for processing the encoded data 165B based on determining that the predicted value 195A corresponds to a value (e.g., a key value) that is most recently independently decoded. In some aspects, the decoder 186 selects the predicted value 195A for processing the encoded data 165B based on determining that the predicted value 195B corresponds to a next value in the one or more predicted values 195 after the predicted value 195A. In these aspects, the predicted value 195A can correspond to a key value that is independently decoded or a non-key value that is decoded based on at least one other of the one or more predicted values 195.

The decoder portion 180, in response to determining that the encoded data 165B fails to satisfy the independent decoding criterion, provides the predicted value 195A to the conditional input generator 182 to obtain conditional input 187B of the compression network 140. In some implementations, the conditional input generator 182 outputs the predicted value 195A as the conditional input 187B. Optionally, in some implementations, the conditional input generator 182 includes an estimator 188 that processes the predicted value 195A to generate an estimated value 193B. In some aspects, the estimated value 193B corresponds to an estimate of the input value 105B based on the predicted value 195A. In some aspects, the more closely the estimated value 193B approximates the input value 105B, the less information has to be processed by the decoder portion 180 as the encoded data 165B to generate the predicted value 195B.

The conditional input 187B is based on the predicted value 195A, the estimated value 193B, or both. In some implementations, the conditional input 187B can be based on at least an additional one of the one or more predicted values 195, one or more additional estimated values, or a combination thereof.

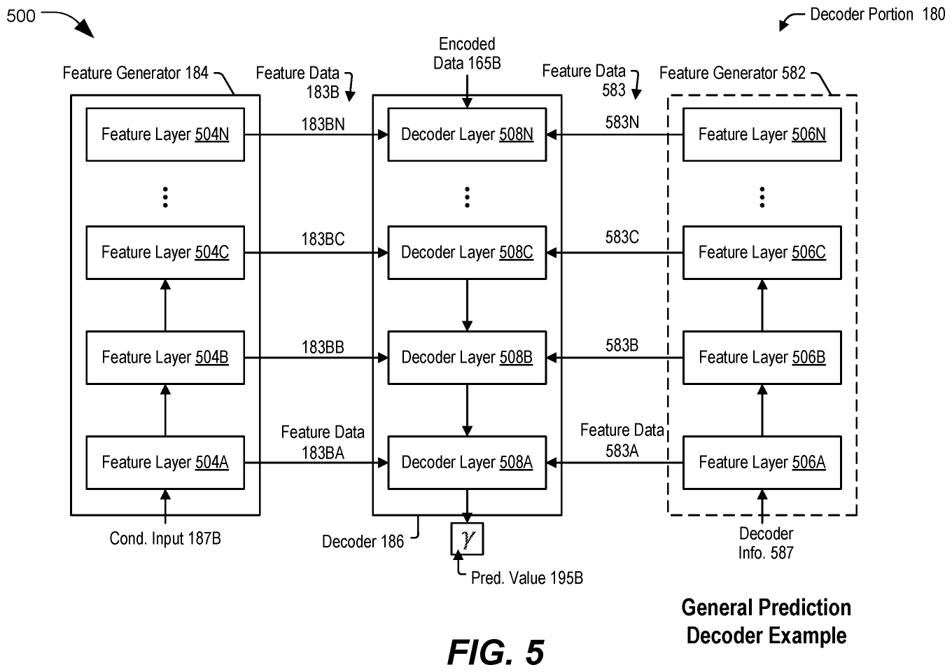

The decoder portion 180, in response to determining that the encoded data 165B fails to satisfy the independent decoding criterion, uses the compression network 140 to process the encoded data 165B and the conditional input 187B to generate the predicted value 195B associated with the input value 105B. For example, the feature generator 184 processes the conditional input 187B to generate feature data 183B, as further described with reference to FIG. 5. In some implementations, the feature data 183B corresponds to multi-scale feature data having different resolutions (e.g., different spatial resolutions). In some implementations, the feature data 183B includes multi-scale wavelet transform data. The decoder 186 processes the encoded data 165B and the feature data 183B to generate the predicted value 195B, as further described with reference to FIG. 5.

In some examples, the predicted value 195B corresponds to a reconstructed version of the input value 105B. In some examples, the predicted value 195B corresponds to a predicted future value, such as a prediction of a future value of the one or more input values 105. To illustrate, the future value can be an input value 105C that is not yet available at the encoder portion 160 at the time of generating the encoded data 165B. In some examples, the predicted value 195B corresponds to a classification associated with the input value 105B. To illustrate, the predicted value 195B can indicate whether the input value 105B corresponds to an alert condition.

In some examples, the predicted value 195B corresponds to a detection result associated with the input value 105B. To illustrate, the predicted value 195B indicates whether a face is detected in an image frame associated with the input value 105B. In some examples, the predicted value 195B corresponds to a collision avoidance output. For example, the input value 105B indicates a first position of a vehicle relative to a second position of an object. In some aspects, the predicted value 195B indicates a first predicted future position of the vehicle relative to a second predicted future position of the object. In some aspects, the predicted value 195B indicates whether the first predicted future position of the vehicle is within a collision threshold of the second future position of the object. In some examples, the one or more predicted values 195 are processed by one or more downstream applications, and the compression network 140 is trained (e.g., configured) based on a performance metric associated with a downstream application. For example, the compression network 140 is trained to reduce a loss metric associated with the downstream application.

A technical advantage of using the compression network 140 to generate the one or more predicted values 195 can include reduced resource usage. For example, generating the encoded data 165B based on the conditional input 167B as an estimate of information (e.g., the conditional input 187B) available at the decoder portion 180 reduces the information that has to be provided as the encoded data 165B to the decoder portion 180 to maintain accuracy of the predicted value 195B.

Referring to FIG. 2, an illustrative aspect of a system operable to perform prediction using a compression network is shown and generally designated 200. The system 200 includes a device 202 configured to be coupled to or include one or more sensors 240. The device 202 is configured to communicate with a device 260. For example, the device 202 is configured to be coupled via a network (e.g., a wired network, a wireless network, or both) to the device 260.

The encoder portion 160 is included in one or more processors 290 of the device 202, and the decoder portion 180 is included in one or more processors 292 of the device 260. The one or more processors 290 are coupled to the one or more sensors 240 and to the modem 270. The one or more processors 292 are coupled to the modem 280. Optionally, in some implementations, the one or more processors 292 include one or more applications 262. Optionally, in some implementations, the device 260 is configured to be coupled to a device 264.

During operation, the encoder portion 160 receives sensor data 226, as the one or more input values 105, from the one or more sensors 240. As illustrative non-limiting examples, the one or more sensors 240 can include an image sensor, an IMU, a motion sensor, an accelerometer, a speedometer, a gyroscope, a radar, a temperature sensor, a microphone, another type of sensor, or a combination thereof. The encoder portion 160 processes the one or more input values 105 (e.g., the sensor data 226) to generate the sets of encoded data 165, as described with reference to FIG. 1. The encoder portion 160 provides the sets of encoded data 165 to the modem 270 for transmission as a bitstream 235 to the device 260. The modem 280 receives the bitstream 235 and provides the sets of encoded data 165 to the decoder portion 180.

The decoder portion 180 processes the sets of encoded data 165 to generate the one or more predicted values 195, as described with reference to FIG. 1. The one or more processors 292 generate an output 295 based on the one or more predicted values 195. Optionally, in some implementations, the decoder portion 180 provides the one or more predicted values 195 to one or more applications 262, and the one or more applications 262 generate an output 263 based on the one or more predicted values 195. For example, the one or more predicted values 195 can correspond to image frames and an application 262 processes the predicted value 195B corresponding to an image frame to generate the output 263 indicating a classification associated with the image frame. The output 295 is based on the output 263, the one or more predicted values 195, or a combination thereof.

In some implementations, the encoder portion 160, the decoder portion 180, or both, are trained (e.g., configured) based on a performance metric associated with the one or more applications 262. For example, a network trainer trains (e.g., configures network weights and biases of) the encoder portion 160, the decoder portion 180, or both, based on a loss metric associated with classification output generated by an application 262. In some implementations, the one or more processors 292 provide the output 295 to the device 264. The device 264 can include a display device, a network device, a storage device, a user device, or a combination thereof.

In some aspects, the output 295 initiates one or more operations at the device 264. In an illustrative example, the device 264 and the device 202 are the same device (e.g., a vehicle), and the one or more predicted values 195 correspond to collision avoidance outputs. The device 260, in response to determining that the predicted value 195B indicates that a first predicted future location of the device 260 is expected to be within a threshold distance of a second predicted future location of an object, sends the output 295 to initiate one or more collision avoidance operations (e.g., braking) at the device 202. In some implementations, the device 260 is the same as or included in the device 202 (e.g., the vehicle). In other implementations, the device 260 is external to the device 202 and generates the output 295 based on the one or more predicted values 195, based on one or more additional predicted values (e.g., associated with the object, another vehicle, or both), or a combination thereof.

A technical advantage of using the encoder portion 160 to generate the encoded data 165 based on an estimate of information that is available at the decoder portion 180 can include reduced resource usage (e.g., memory, bandwidth, and transmission time) associated with transmitting the bitstream 235 to the device 260.

Referring to FIG. 3, an illustrative aspect of a system operable to perform prediction using a compression network is shown and generally designated 300. The system 300 includes a device 302 that is configured to couple to or include the one or more sensors 240. The device 302 is configured to couple to or include a storage device 392.

The encoder portion 160 and the decoder portion 180 are included in one or more processors 390 of the device 302. The encoder portion 160 is configured to store one or more of the sets of encoded data 165 in the storage device 392. The decoder portion 180 is configured to obtain one or more of the sets of encoded data 165 from the storage device 392. Storing one or more of the sets of encoded data 165 in the storage device 392 can use less memory than storing the corresponding values of the sensor data 226 in the storage device 392.

The decoder portion 180 processes the sets of encoded data 165 to generate the one or more predicted values 195, as described with reference to FIG. 1. The one or more processors 390 generate the output 295 based on the one or more predicted values 195. Optionally, in some implementations, the decoder portion 180 provides the one or more predicted values 195 to one or more applications 262, and the one or more applications 262 generate an output 263 based on the one or more predicted values 195. The output 295 is based on the output 263, the one or more predicted values 195, or a combination thereof. In some implementations, the one or more processors 390 provide the output 295 to the device 264.

In an illustrative example, the device 264 and the device 302 are the same device (e.g., a vehicle), and the one or more predicted values 195 correspond to collision avoidance outputs. The device 302, in response to determining that the predicted value 195B indicates that a first predicted future location of the device 302 is expected to be within a threshold distance of a second predicted future location of an object, generates the output 295 to initiate one or more collision avoidance operations (e.g., braking) at the device 302.

Referring to FIG. 4, an example 400 is shown of an encoder portion 160 of a compression network 140 that is operable to perform prediction. For example, the encoder portion 160 is configured to generate encoded data 165B that can be processed at a decoder portion 180 of the compression network 140 to generate a predicted value 195B, as further described with reference to FIG. 5.

The compression network 140 includes a neural network with multiple layers. For example, the feature generator 164 includes one or more feature layers 404 coupled to one or more encoder layers 402 of the encoder 166. The one or more feature layers 404 include a feature layer 404A, a feature layer 404B, a feature layer 404C, one or more additional feature layers including a feature layer 404N, or a combination thereof. The one or more encoder layers 402 include an encoder layer 402A, an encoder layer 402B, an encoder layer 402C, one or more additional encoder layers including an encoder layer 402N, or a combination thereof. An output of each feature layer 404 is coupled to an input of a corresponding encoder layer 402. For example, an output of the feature layer 404A is coupled to an input of the encoder layer 402A, an output of the feature layer 404B is coupled to an input of the encoder layer 402B, and so on.

An output of each preceding feature layer 404 is coupled to an input of a subsequent feature layer 404. For example, an output of the feature layer 404A is coupled to an input of the feature layer 404B, an output of the feature layer 404B is coupled to an input of the feature layer 404C, and so on. An output of each preceding encoder layer 402 is coupled to an input of a subsequent encoder layer 402. For example, an output of the encoder layer 402A is coupled to an input of the encoder layer 402B, an output of the encoder layer 402B is coupled to an input of the encoder layer 402C, and so on.

In some implementations, the encoder 166 is configured to encode multiple orders of resolution of an input value 105 to generate encoded data 165. In an illustrative example, the encoder 166 corresponds to a video encoder that is configured to encode multiple orders of spatial resolution of the input value 105 (e.g., an image frame). The one or more feature layers 404 and the one or more encoder layers 402 correspond to network layers that are associated with multiple resolutions. For example, the feature layer 404A and the encoder layer 402A are associated with a first resolution, the feature layer 404B and the encoder layer 402B are associated with a second resolution, the feature layer 404C and the encoder layer 402C are associated with a third resolution, the feature layer 404N and the encoder layer 402N are associated with an Nth resolution, or a combination thereof.

During operation, the encoder portion 160 provides the conditional input 167B to the feature generator 164 and the input value 105B (x_{b}) to the encoder 166, as described with reference to FIG. 1. The feature layer 404A processes the conditional input 167B to generate feature data 163BA associated with the first resolution and provides the feature data 163BA to the encoder layer 402A. The encoder layer 402A processes the input value 105B and the feature data 163BA to generate an output (associated with the first resolution) that is provided to the encoder layer 402B.

Each subsequent feature layer 404 processes an output of the previous feature layer 404 to generate feature data 163 and provides the feature data 163 to a corresponding encoder layer 402. For example, the feature layer 404B provides feature data 163BB associated with the second resolution to the encoder layer 402B, the feature layer 404C provides feature data 163BC associated with the third resolution to the encoder layer 402C, the feature layer 404N provides feature data 163BN associated with the Nth resolution to the encoder layer 402N, and so on. The feature data 163B (e.g., the feature data 163BA, the feature data 163BB, the feature data 163BC, the feature data 163BN, or a combination thereof) thus corresponds to multi-scale feature data having different resolutions.

Each subsequent encoder layer 402 processes an output of the previous encoder layer 402 and feature data 163 from a corresponding feature layer to generate an output. For example, the encoder layer 402B processes the output of the encoder layer 402A and the feature data 163BB to generate an output (associated with the second resolution) that is provided to the encoder layer 402C, and so on. The output of the encoder layer 402N corresponds to the encoded data 165B.

Optionally, in some implementations, the feature generator 164 can use various techniques to generate the feature data 163B. For example, the feature generator 164 can perform wavelet transforms to generate the feature data 163B corresponding to multi-scale wavelet transform data. To illustrate, the feature generator 164 can perform a wavelet transform based on the conditional input 167B to generate the feature data 163BA (e.g., first wavelet transform data) associated with the first resolution. The feature generator 164 can perform a wavelet transform based on the feature data 163BA, the conditional input 167B, or both, to generate the feature data 163BB (e.g., second wavelet transform data) associated with the second resolution. Similarly, the feature generator 164 can generate the feature data 163BC (e.g., third wavelet transform data) associated with the third resolution, and so on.

In a particular aspect, the conditional input 167B corresponds to an estimate of the conditional input 187B that can be generated at the decoder portion 180 of FIG. 5. A technical advantage of using the estimate (e.g., the conditional input 167B) of information available at the decoder portion 180 to generate the feature data 163B that is used to generate the encoded data 165B can include a reduced size of the encoded data 165B to maintain accuracy of the predicted value 195B generated at the decoder portion 180.

Referring to FIG. 5, an example 500 is shown of a decoder portion 180 of a compression network 140 that is operable to perform prediction. For example, the decoder portion 180 is configured to process the encoded data 165B (generated at the encoder portion 160 as described with reference to FIG. 4) to generate the predicted value 195B (γ) associated with the input value 105B (x_{b}).

The compression network 140 includes a neural network with multiple layers. For example, the feature generator 184 includes one or more feature layers 504 coupled to one or more decoder layers 508 of the decoder 186. The one or more feature layers 504 include a feature layer 504A, a feature layer 504B, a feature layer 504C, one or more additional feature layers including a feature layer 504N, or a combination thereof. The one or more decoder layers 508 include a decoder layer 508A, a decoder layer 508B, a decoder layer 508C, one or more additional decoder layers including a decoder layer 508N, or a combination thereof. An output of each feature layer 504 is coupled to an input of a corresponding decoder layer 508. For example, an output of the feature layer 504A is coupled to an input of the decoder layer 508A, an output of the feature layer 504B is coupled to an input of the decoder layer 508B, and so on.

An output of each preceding feature layer 504 is coupled to an input of a subsequent feature layer 504. For example, an output of the feature layer 504A is coupled to an input of the feature layer 504B, an output of the feature layer 504B is coupled to an input of the feature layer 504C, and so on. An output of each preceding decoder layer 508 is coupled to an input of a subsequent decoder layer 508. The one or more decoder layers 508 are ordered from a reference number ending with a higher alphabet to a lower alphabet. For example, the decoder layer 508B is subsequent to the decoder layer 508C, and the decoder layer 508A is subsequent to the decoder layer 508B. An output of the decoder layer 508B is coupled to an input of the decoder layer 508A, an output of the decoder layer 508C is coupled to an input of the decoder layer 508B, and so on. The output of a last decoder layer 508 (e.g., the decoder layer 508A) of the decoder 186 corresponds to a predicted value 195 associated with an input value 105.

In some implementations, the decoder 186 is configured to decode multiple orders of resolution of the encoded data 165B. In an illustrative example, the decoder 186 corresponds to a video decoder that is configured to decode multiple orders of spatial resolution of the encoded data 165B associated with the input value 105 (e.g., an image frame). The one or more feature layers 504 and the one or more decoder layers 508 correspond to network layers that are associated with multiple resolutions. For example, the feature layer 504A and the decoder layer 508A are associated with a first resolution, the feature layer 504B and the decoder layer 508B are associated with a second resolution, the feature layer 504C and the decoder layer 508C are associated with a third resolution, the feature layer 504N and the decoder layer 508N are associated with an Nth resolution, or a combination thereof.

During operation, the decoder portion 180 provides the conditional input 187B to the feature generator 184 and the encoded data 165B to the decoder 186, as described with reference to FIG. 1. The feature layer 504A processes the conditional input 187B to generate feature data 183BA associated with the first resolution and provides the feature data 183BA to the decoder layer 508A. Each subsequent feature layer 504 processes an output of the previous feature layer 504 to generate feature data 183 and provides the feature data 183 to a corresponding decoder layer 508. For example, the feature layer 504B provides feature data 183BB associated with the second resolution to the decoder layer 508B, the feature layer 504C provides feature data 183BC associated with the third resolution to the decoder layer 508C, the feature layer 504N provides feature data 183BN associated with the Nth resolution to the decoder layer 508N, and so on. The feature data 183B (e.g., the feature data 183BA, the feature data 183BB, the feature data 183BC, the feature data 183BN, or a combination thereof) thus corresponds to multi-scale feature data having different resolutions.

The decoder layer 508N processes the encoded data 165B and the feature data 183BN to generate an output (e.g., associated with the Nth resolution) that is provided to a subsequent decoder layer 508. Each subsequent decoder layer 508 processes an output of the previous decoder layer 508 and feature data 183 from a corresponding feature layer to generate an output. For example, the decoder layer 508B processes an output of the decoder layer 508C and the feature data 183BB to generate an output (e.g., associated with the second resolution). The decoder layer 508A processes the output of the decoder layer 508B and the feature data 183BA to generate an output that corresponds to the predicted value 195B (γ) associated with the input value 105B (x_{b}).

Optionally, in some implementations, the feature generator 184 can use various techniques similar to techniques performed by the feature generator 164 of FIG. 4 to generate the feature data 183B. For example, the feature generator 184 can perform wavelet transforms to generate the feature data 183B corresponding to multi-scale wavelet transform data. To illustrate, the feature generator 184 can perform a wavelet transform based on the conditional input 187B to generate the feature data 183BA (e.g., first wavelet transform data) associated with the first resolution. The feature generator 184 can perform a wavelet transform based on the feature data 183BA, the conditional input 187B, or both, to generate the feature data 183BB (e.g., second wavelet transform data) associated with the second resolution. Similarly, the feature generator 184 can generate the feature data 183BC (e.g., third wavelet transform data) associated with the third resolution, and so on.

Optionally, in some implementations, the decoder portion 180 can include a feature generator 582 that is configured to process decoder information 587 that is available at the decoder portion 180 to generate feature data 583 that is used by the decoder 186 to generate the predicted value 195B. As an example, the feature generator 582 includes one or more feature layers 506 coupled to the one or more decoder layers 508. The one or more feature layers 506 include a feature layer 506A, a feature layer 506B, a feature layer 506C, one or more additional feature layers including a feature layer 506N, or a combination thereof. An output of each feature layer 506 is coupled to an input of a corresponding decoder layer 508. For example, an output of the feature layer 506A is coupled to an input of the decoder layer 508A, an output of the feature layer 506B is coupled to an input of the decoder layer 508B, and so on.

An output of each preceding feature layer 506 is coupled to an input of a subsequent feature layer 506. For example, an output of the feature layer 506A is coupled to an input of the feature layer 506B, an output of the feature layer 506B is coupled to an input of the feature layer 506C, and so on. In a particular aspect, the one or more feature layers 506 correspond to network layers that are associated with multiple resolutions. For example, the feature layer 506A is associated with the first resolution, the feature layer 506B is associated with the second resolution, the feature layer 506C is associated with the third resolution, the feature layer 506N is associated with the Nth resolution, or a combination thereof.

The decoder portion 180 provides the decoder information 587 to the feature generator 582 in addition to (e.g., concurrently with) providing the conditional input 187B to the feature generator 184 and the encoded data 165B to the decoder 186. The feature layer 506A processes the decoder information 587 to generate feature data 583A associated with the first resolution and provides the feature data 583A to the decoder layer 508A. Each subsequent feature layer 506 processes an output of the previous feature layer 506 to generate feature data 583 and provides the feature data 583 to a corresponding decoder layer 508. For example, the feature layer 506B processes an output of the feature layer 506A to generate feature data 583B and provides the feature data 583B associated with the second resolution to the decoder layer 508B. Similarly, the feature layer 506C provides feature data 583C associated with the third resolution to the decoder layer 508C, the feature layer 506N provides feature data 583N associated with the Nth resolution to the decoder layer 508N, and so on. The feature data 583 (e.g., the feature data 583A, the feature data 583B, the feature data 583C, the feature data 583N, or a combination thereof) thus corresponds to multi-scale feature data having different resolutions.

The decoder layer 508N processes the encoded data 165B, the feature data 183BN, and the feature data 583N to generate an output (e.g., associated with the Nth resolution) that is provided to a subsequent decoder layer 508. Each subsequent decoder layer 508 processes an output of the previous decoder layer 508, feature data 183 from a corresponding feature layer of the feature generator 184, and feature data 583 from a corresponding feature layer of the feature generator 582 to generate an output. For example, the decoder layer 508B processes an output of the decoder layer 508C, the feature data 183BB, and the feature data 583B to generate an output (e.g., associated with the second resolution). The decoder layer 508A processes the output of the decoder layer 508B, the feature data 183BA, and the feature data 583A to generate an output that corresponds to the predicted value 195B (γ) associated with the input value 105B (x_{b}).

Optionally, in some implementations, the feature generator 582 can use various techniques (e.g., similar to techniques performed by the feature generator 184) to generate the feature data 583. For example, the feature generator 582 can perform wavelet transforms to generate the feature data 583 corresponding to multi-scale wavelet transform data.

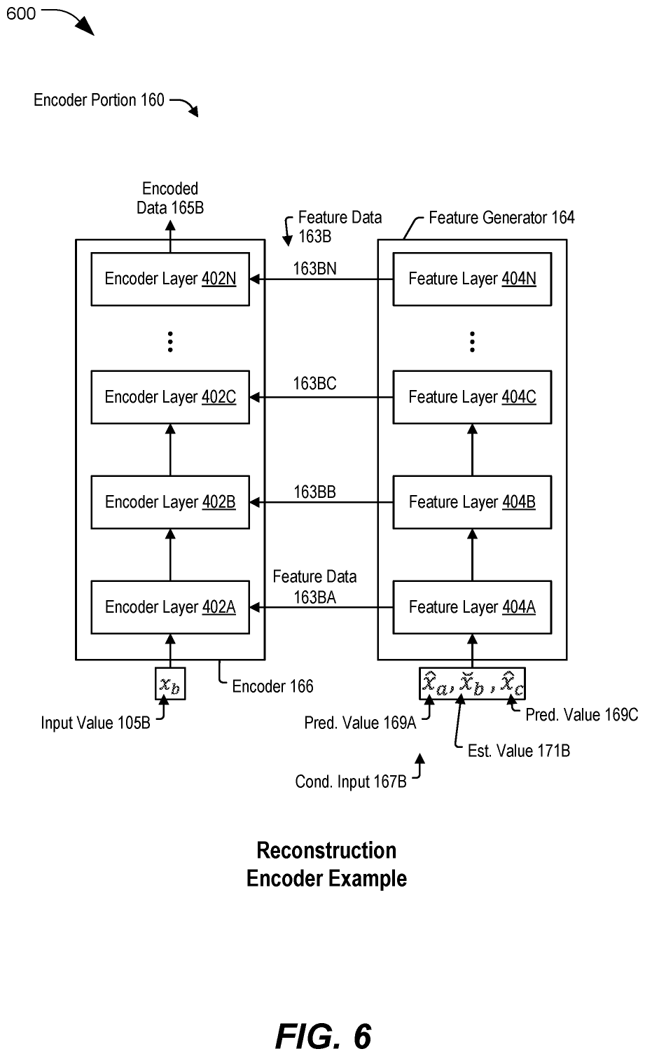

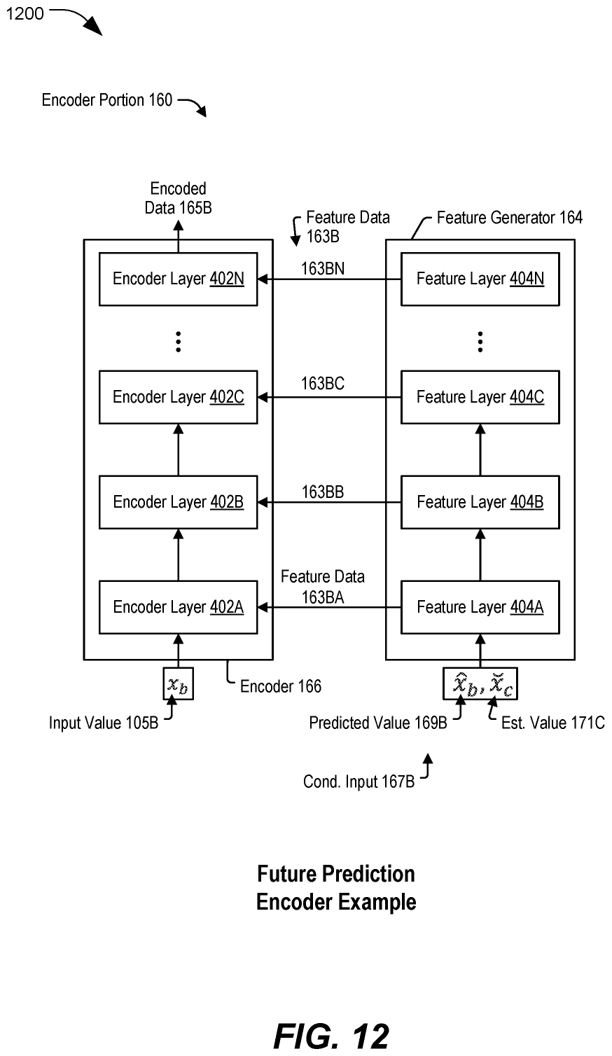

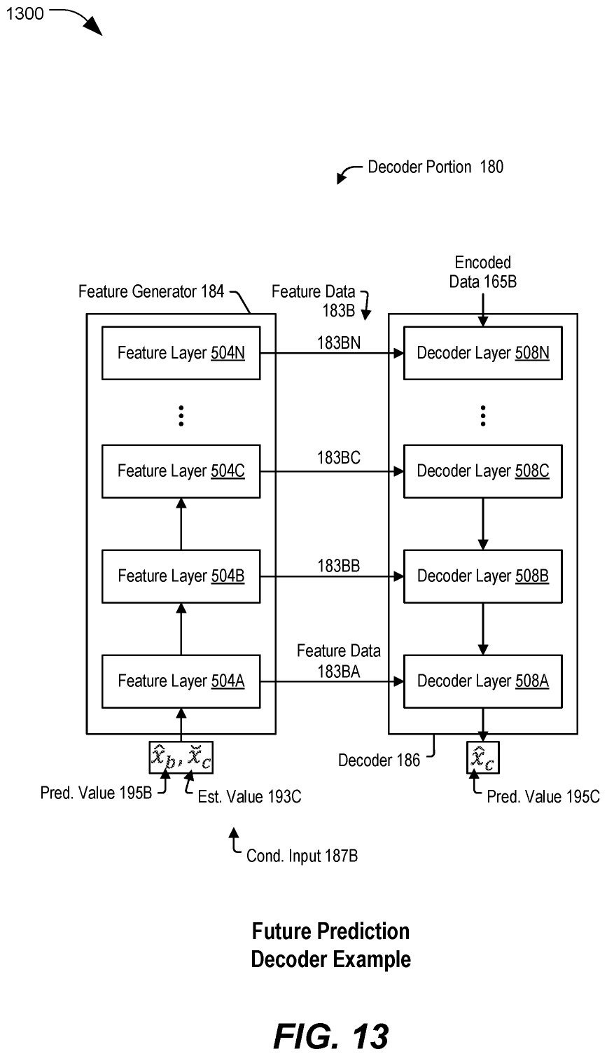

In some implementations, the predicted value 195B (γ) corresponds to a reconstructed version of the input value 105B (x_{b}), as further described with reference to FIGS. 6-11. For example, input value 105B (x_{b}) can correspond to an image unit, and the predicted value 195B (γ) can correspond to a reconstructed version of the image unit, as further described with reference to FIGS. 14-23. In some implementations, the predicted value 195B (γ) corresponds to a predicted future value of the one or more input values 105, as further described with reference to FIGS. 12-13. In other implementations, the predicted value 195B (γ) can correspond to a predicted future value that is associated with the input value 105B. In some aspects, the predicted value 195B also includes a prediction of a future value of the one or more input values 105. In other aspects, the predicted value 195B does not include a prediction of a future value of the one or more input values 105. In an example, the compression network 140 tracks an object associated with one or more motion values (e.g., the one or more input values 105) across one or more frames of pixels. To illustrate, the input value 105B can include tracking data (e.g., associated with an image frame) and the predicted value 195B (γ) can include a collision avoidance output indicating whether a future position of a vehicle relative to the object (e.g., a future position of the object) is predicted to be less than a threshold. The collision avoidance output (e.g., collision or no collision) is a future prediction associated with the tracking data. In some implementations, the collision avoidance output also indicates predicted future tracking data, such as a predicted future position of the vehicle relative to a predicted future position of the object.

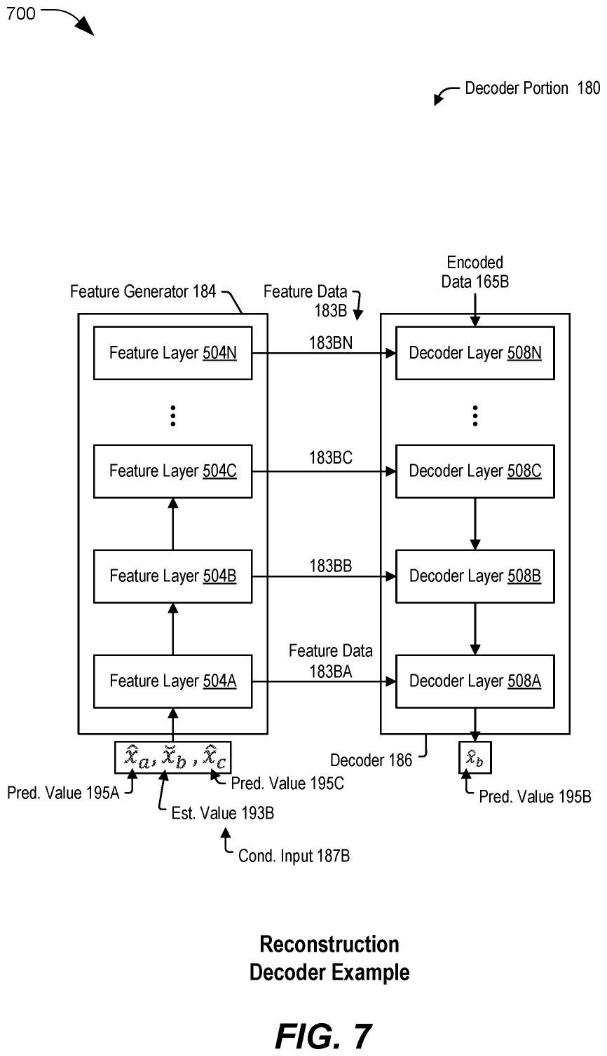

Referring to FIG. 6, an example 600 is shown of an encoder portion 160 of a compression network 140 that is operable to perform prediction corresponding to reconstruction. For example, the encoder portion 160 is configured to generate the encoded data 165B that can be processed at a decoder portion 180 of the compression network 140 to generate the predicted value 195B (\hat{x}_{b}) that corresponds to a reconstructed version of the input value 105B (x_{b}), as further described with reference to FIG. 7.

The conditional input generator 162 uses the local decoder portion 168 to process the encoded data 165A to generate the predicted value 169A, as described with reference to FIG. 1. In a particular example, the predicted value 169A (\hat{x}ₐ) corresponds to an estimate of a reconstructed version of the input value 105A (xₐ) that can be generated at the decoder portion 180.

In some implementations, the conditional input generator 162 generates one or more additional predicted values. The one or more additional predicted values can be associated with at least one input value that is prior to the input value 105B in the one or more input values 105, at least one input value that is subsequent to the input value 105B in the one or more input values 105, or both.

In an example, the one or more additional predicted values can include a predicted value 169C (\hat{x}_{c}) that is associated with an input value 105C that is subsequent to the input value 105B in the one or more input values 105 and that can be encoded as the encoded data 165C independently of (e.g., prior to) encoding the input value 105B. In an illustrative example, the input value 105C corresponds to a key value (e.g., an I-frame) that can be encoded independently of others of the one or more input values 105. The conditional input generator 162 uses the local decoder portion 168 to process the encoded data 165C to generate the predicted value 169C, process one or more additional sets of encoded data to generate one or more additional predicted values, or a combination thereof.

Optionally, in some implementations, the conditional input generator 162 uses the estimator 170 to generate an estimated value 171B (x̆_{b}) of the input value 105B (x_{b}) based on the one or more predicted values (e.g., the predicted value 169A, the predicted value 169C, the one or more additional predicted values, or a combination thereof). To illustrate, the estimated value 171B (x̆_{b}) corresponds to an estimate of the input value 105B (x_{b}) that can be generated at the decoder portion 180 based on sets of encoded data corresponding to the one or more predicted values and independently of the encoded data 165B.

In a particular implementation, the estimator 170 uses one or more estimation techniques to determine the estimated value 171B. For example, the predicted value 169A corresponds to the input value 105A (e.g., a previous image frame), the predicted value 169C corresponds to the input value 105C (e.g., a subsequent image frame), and the estimated value 171B corresponds to an estimated input value between the predicted value 169A and the predicted value 169C. In some implementations, the estimator 170 includes a neural network that is configured to process the one or more predicted values to generate the estimated value 171B.

The conditional input 167B includes the estimated value 171B (x̆_{b}), the one or more predicted values, such as the predicted value 169A (\hat{x}ₐ), the predicted value 169C (\hat{x}_{c}), one or more additional predicted values, or a combination thereof. The feature generator 164 generates the feature data 163B based on the conditional input 167B, and the encoder 166 processes the input value 105B based on the feature data 163B to generate the encoded data 165B, as described with reference to FIG. 4.

Referring to FIG. 7, an example 700 is shown of a decoder portion 180 of the compression network 140 that is operable to perform prediction corresponding to reconstruction. For example, the decoder portion 180 is configured to process the encoded data 165B (generated at the encoder portion 160 as described with reference to FIG. 6) to generate the predicted value 195B (\hat{x}_{b}) that corresponds to a reconstructed version of the input value 105B (x_{b}).

The conditional input generator 182 obtains the predicted value 195A, as described with reference to FIG. 1. For example, the decoder portion 180 processes the encoded data 165A to generate the predicted value 195A. In a particular example, the predicted value 195A (\hat{x}ₐ) corresponds to a reconstructed version of the input value 105A (xₐ).

In some implementations, the conditional input generator 182 obtains one or more additional predicted values. The one or more additional predicted values can be associated with at least one input value that is prior to the input value 105B in the one or more input values 105, at least one input value that is subsequent to the input value 105B in the one or more input values 105, or both.

In an example, the one or more additional predicted values can include a predicted value 195C (\hat{x}_{c}) that is associated with an input value 105C that is subsequent to the input value 105B in the one or more input values 105 and the corresponding encoded data 165C can be decoded to generate the predicted value 195C independently of (e.g., prior to) decoding the encoded data 165B associated with the input value 105B. In an illustrative example, the input value 105C corresponds to a key value (e.g., an I-frame) and is associated with the encoded data 165C that can be decoded independently of others of sets of encoded data 165.

Optionally, in some implementations, the conditional input generator 182 uses the estimator 188 to generate an estimated value 193B (x̆_{b}) of the input value 105B (x_{b}) based on the one or more predicted values (e.g., the predicted value 195A, the predicted value 195C, the one or more additional predicted values, or a combination thereof). To illustrate, the estimated value 193B (x̆_{b}) corresponds to an estimate of the input value 105B (x_{b}) that can be generated at the decoder portion 180 based on sets of encoded data corresponding to the one or more predicted values and independently of the encoded data 165B.

In a particular implementation, the estimator 188 uses one or more estimation techniques (similar to estimation techniques performed by the estimator 170 as described with reference to FIG. 6) to determine the estimated value 193B. For example, the predicted value 195A corresponds to the input value 105A (e.g., a previous image frame), the predicted value 195C corresponds to the input value 105C (e.g., a subsequent image frame), and the estimated value 193B corresponds to an estimated input value between the predicted value 195A and the predicted value 195C. In some implementations, the estimator 188 includes a neural network that is configured to process the one or more predicted values to generate the estimated value 193B.

The conditional input 187B includes the estimated value 193B (x̆_{b}), the one or more predicted values, such as the predicted value 195A (\hat{x}ₐ), the predicted value 195C (\hat{x}_{c}), one or more additional predicted values, or a combination thereof. The feature generator 184 generates the feature data 183B based on the conditional input 187B, and the decoder 186 processes the encoded data 165B based on the feature data 183B to generate the predicted value 195B (\hat{x}_{b}), as described with reference to FIG. 5. The predicted value 195B (\hat{x}_{b}) corresponds to a reconstructed version of the input value 105B (x_{b}).

A technical advantage of using an estimate (e.g., the conditional input 167B) of information (e.g., the conditional input 187B) that is available at the decoder portion 180 to generate the encoded data 165B can include reducing the amount of information that has to be encoded as the encoded data 165B to generate a reconstructed version (\hat{x}_{b}) of the input value 105B (x_{b}).

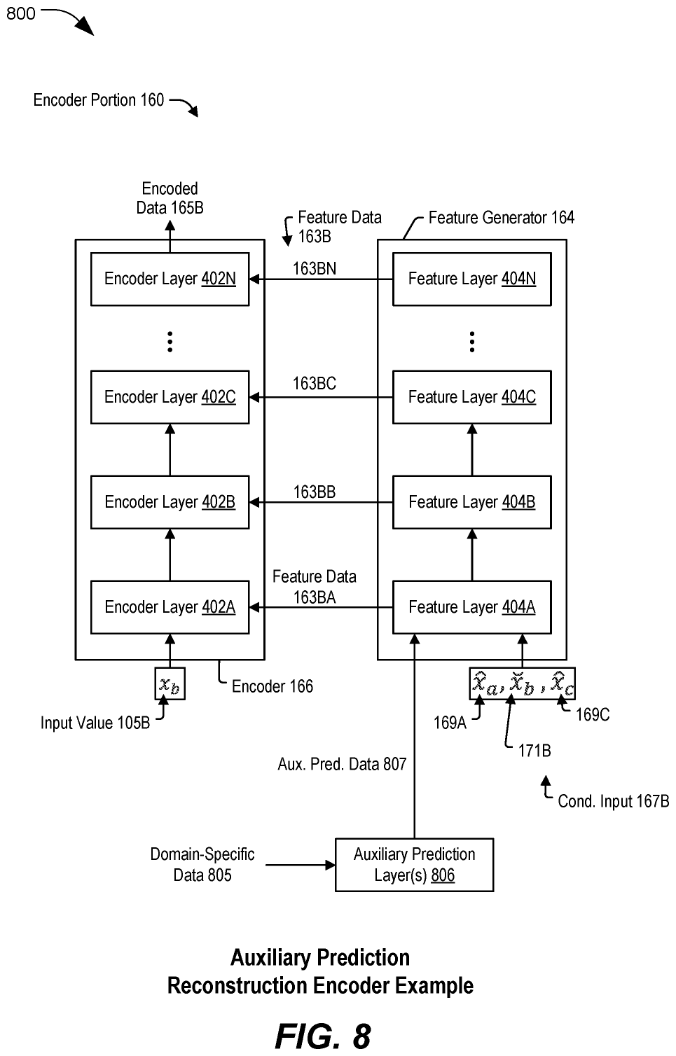

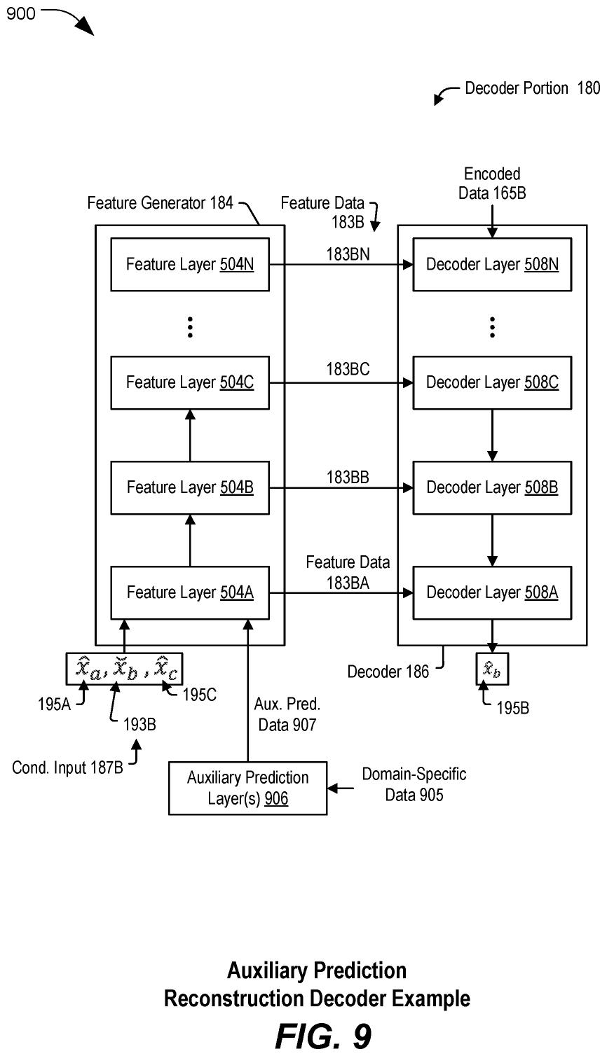

Referring to FIG. 8, an example 800 is shown of an encoder portion 160 of a compression network 140 that is operable to perform prediction corresponding to reconstruction based on auxiliary prediction. For example, the encoder portion 160 is configured to generate the encoded data 165B that can be processed at a decoder portion 180 of the compression network 140 based on auxiliary prediction data to generate the predicted value 195B (\hat{x}_{b}) that corresponds to a reconstructed version of the input value 105B (x_{b}), as further described with reference to FIG. 9.

It should be understood that the compression network 140 using the auxiliary prediction data to generate the predicted value 195B (\hat{x}_{b}) corresponding to a reconstructed version of the input value 105B (x_{b}) is provided as an illustrative example. In other examples, the compression network 140 can use auxiliary prediction data to generate various other types of predicted values 195, such as predicted future values, collision avoidance outputs, classification outputs, detection outputs, etc.

The encoder portion 160 includes or is coupled to one or more auxiliary prediction layers 806. In a particular aspect, the encoder portion 160 is configured to provide domain-specific data 805 to the one or more auxiliary prediction layers 806 concurrently with providing the input value 105B to the encoder 166 and the conditional input 167B to the feature generator 164. The one or more auxiliary prediction layers 806 process the domain-specific data 805 to generate auxiliary prediction data 807.

The feature generator 164 processes the conditional input 167B and the auxiliary prediction data 807 to generate the feature data 163B. For example, the feature layer 404A processes the auxiliary prediction data 807 and the conditional input 167B to generate the feature data 163BA. The feature layer 404B processes an output of the feature layer 404A to generate the feature data 163BB, and so on.

In some implementations, the auxiliary prediction data 807 corresponds to an estimate of auxiliary prediction data available at the decoder portion 180 that can be used to assist in generating the predicted value 195B corresponding to the input value 105B.

Referring to FIG. 9, an example is shown of a decoder portion 180 of the compression network 140 that is operable to perform prediction corresponding to reconstruction based on auxiliary prediction. For example, the decoder portion 180 is configured to process the encoded data 165B (generated at the encoder portion 160 as described with reference to FIG. 8) based on auxiliary prediction data to generate the predicted value 195B (\hat{x}_{b}) that corresponds to a reconstructed version of the input value 105B (x_{b}).

The decoder portion 180 includes or is coupled to one or more auxiliary prediction layers 906. In a particular aspect, the decoder portion 180 is configured to provide domain-specific data 905 to the one or more auxiliary prediction layers 906 concurrently with providing the encoded data 165B to the decoder 186 and the conditional input 187B to the feature generator 184. The one or more auxiliary prediction layers 906 process the domain-specific data 905 to generate auxiliary prediction data 907.

The feature generator 184 processes the conditional input 187B and the auxiliary prediction data 907 to generate the feature data 183B. For example, the feature layer 504A processes the auxiliary prediction data 907 and the conditional input 187B to generate the feature data 183BA. The feature layer 504B processes an output of the feature layer 506A to generate the feature data 183BB, and so on.

In some implementations, the auxiliary prediction data 907 is the same as the auxiliary prediction data 807. For example, the encoder portion 160 and the decoder portion 180 have access to the same auxiliary prediction data. To illustrate, the encoder portion 160 and the decoder portion 180 can be included in the same device, as described with reference to FIG. 3, obtain the auxiliary prediction data from the same source, or both. In some implementations, the auxiliary prediction data 907 is a predicted (e.g., reconstructed) version, a decoded version, or both, of the auxiliary prediction data 807.

In a particular aspect, the auxiliary prediction data 907 can be used to assist in generating the predicted value 195B corresponding to the input value 105B. In a reconstruction example, the auxiliary prediction data 907 can indicate positions of facial features of a person, and the predicted value 195B corresponds to a reconstructed version of the input value 105B (e.g., an image frame) that represents the face of the person. Having access to the positions of the facial features can improve the accuracy of the reconstruction. In a collision avoidance example, the auxiliary prediction data 907 can indicate a predicted future path of a first vehicle, and the predicted value 195B can correspond to a collision avoidance output indicating whether, given the predicted future path of the first vehicle, a future predicted position of a second vehicle is expected to be within a threshold distance of a future predicted position of an object.

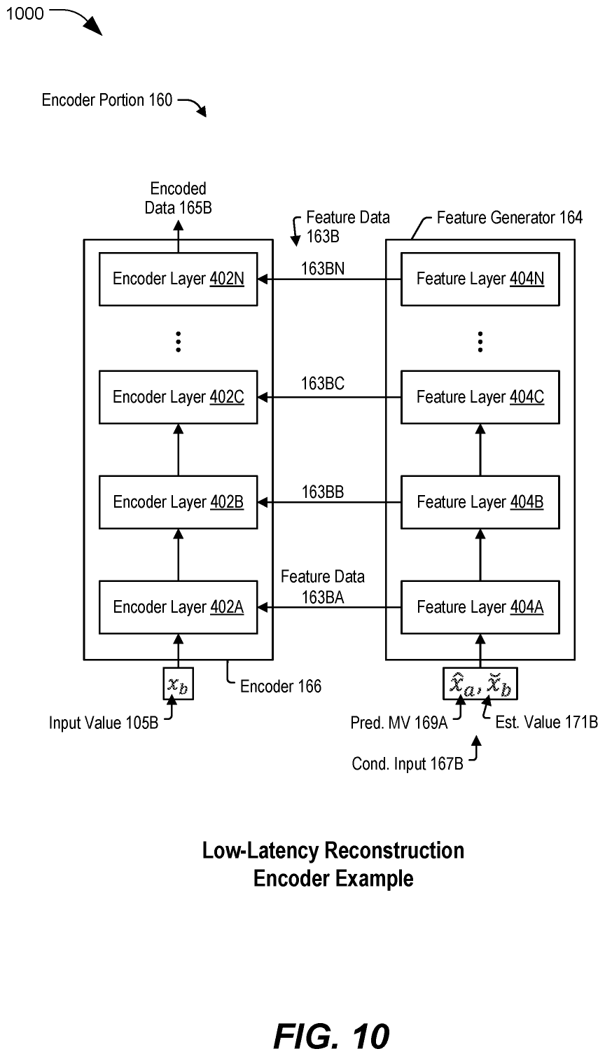

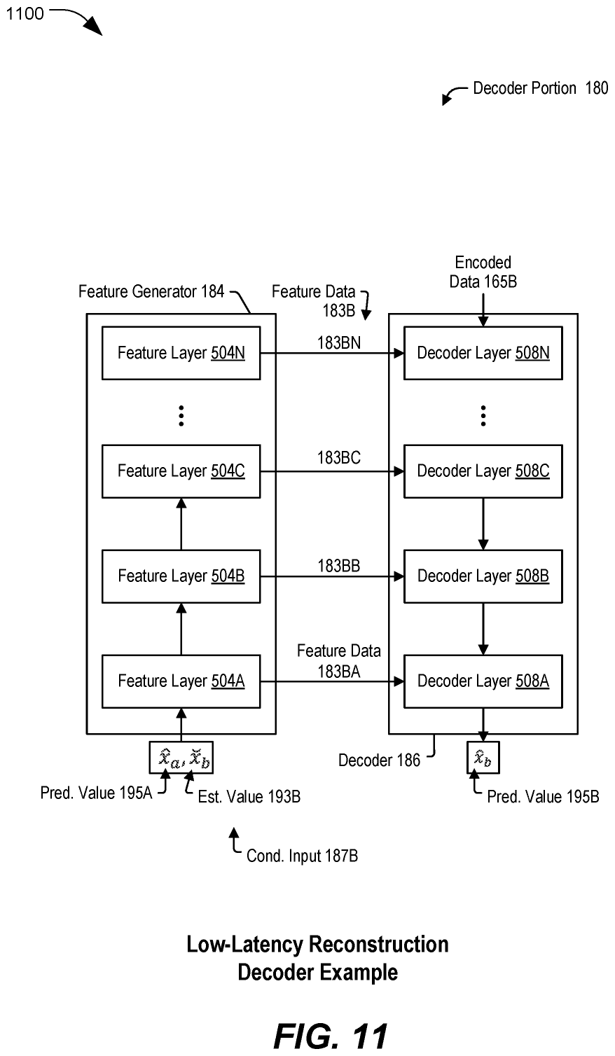

Referring to FIG. 10, an example 1000 is shown of an encoder portion 160 of a compression network that is operable to perform prediction corresponding to low-latency reconstruction. For example, the encoder portion 160 is configured to generate the encoded data 165B corresponding to the input value 105B independently of (e.g., prior to obtaining) subsequent values of the one or more input values 105, and the encoded data 165B can be processed at a decoder portion 180 of the compression network 140 independently of encoded data associated with subsequent values of the one or more input values 105, as further described with reference to FIG. 11.

The conditional input generator 162 of FIG. 1 generates the conditional input 167B corresponding to the input value 105B independently of (e.g., prior to obtaining) subsequent input values, including the input value 105C, of the one or more input values 105. For example, the conditional input generator 162 uses the estimator 170 to generate the estimated value 171B based on the predicted value 169A, one or more additional predicted values corresponding one or more input values prior to the input value 105B in the one or more input values 105, or a combination thereof. The conditional input 167B includes the estimated value 171B, the predicted value 169A, the one or more additional predicted values, or a combination thereof. The feature generator 164 generates the feature data 163B based on the conditional input 167B, and the encoder 166 processes the input value 105B based on the feature data 163B to generate the encoded data 165B, as described with reference to FIG. 4. The encoder portion 160 can thus generate the encoded data 165B independently of (e.g., prior to) obtaining the input value 105C. A technical advantage of generating the encoded data 165B independently of the input value 105C can include reduced latency associated with generating the encoded data 165B without having to wait for access to the input value 105C.

Referring to FIG. 11, an example 1100 is shown of a decoder portion 180 of the compression network that is operable to perform prediction corresponding to low-latency reconstruction. For example, the decoder portion 180 is configured to generate the predicted value 195B corresponding to the input value 105B independently of (e.g., prior to obtaining) sets of encoded data corresponding to subsequent values of the one or more input values 105.

The conditional input generator 182 generates the conditional input 187B corresponding to the input value 105B independently of (e.g., prior to obtaining) encoded data (including the encoded data 165C) corresponding to subsequent input values of the one or more input values 105. The conditional input generator 182 obtains the predicted value 195A, as described with reference to FIG. 1. For example, the decoder portion 180 processes the encoded data 165A to generate the predicted value 195A. The conditional input generator 182 uses the estimator 188 to generate the estimated value 193B based on the predicted value 195A, one or more additional predicted values corresponding one or more input values prior to the input value 105B in the one or more input values 105, or a combination thereof. The conditional input 187B includes the estimated value 193B, the predicted value 195A, the one or more additional predicted values, or a combination thereof.

The feature generator 184 generates the feature data 183B based on the conditional input 187B, and the decoder 186 processes the encoded data 165B based on the feature data 183B, as described with reference to FIG. 5. The decoder portion 180 can thus generate the predicted value 195B independently of (e.g., prior to) obtaining the encoded data 165C. A technical advantage of generating the predicted value 195B independently of the encoded data 165C can include reduced latency associated with generating the predicted value 195B without having to wait for access to the encoded data 165C.

Referring to FIG. 12, an example 1200 is shown of an encoder portion 160 of a compression network 140 that is operable to perform prediction corresponding to future prediction. For example, the encoder portion 160 is configured to generate encoded data 165B corresponding to an input value 105B (x_{b}) that can be processed at a decoder portion 180 of the compression network 140 to generate a predicted value 195C (\hat{x}_{c}) that corresponds to a predicted future value. In a particular aspect, the input value 105B (x_{b}) corresponds to a motion value, and the predicted value 195C (\hat{x}_{c}) corresponds to a predicted future motion value (e.g., a predicted future motion vector).

The conditional input generator 162 uses the local decoder portion 168 to generate a predicted value 169B (\hat{x}_{b}). For example, the local decoder portion 168 processes the encoded data 165A associated with the input value 105A (xₐ) to generate the predicted value 169B corresponding to a predicted future value of the input value 105B (x_{b}). In a particular example, the predicted value 169B (\hat{x}_{b}) corresponds to an estimate of a predicted future value that can be generated based on the encoded data 165A at the decoder portion 180.

In some implementations, the conditional input generator 162 generates one or more additional predicted values. The one or more additional predicted values can be associated with at least one input value that is prior to the input value 105B in the one or more input values 105, at least one input value that is subsequent to the input value 105B in the one or more input values 105, or both.

Optionally, in some implementations, the conditional input generator 162 uses the estimator 170 to generate an estimated value 171C (x̆_{c}) of a predicted future value of the input value 105C (x_{c}) based on the one or more predicted values (e.g., the predicted value 169B). To illustrate, the estimated value 171C (x̆_{c}) corresponds to an estimate of a predicted future value of the input value 105C (x_{c}) that can be generated at the decoder portion 180 based on sets of encoded data corresponding to the one or more predicted values and independently of the encoded data 165B.

In a particular implementation, the estimator 170 uses one or more estimation techniques to determine the estimated value 171C. For example, the predicted value 169B corresponds to an estimate of a predicted future value of the input value 105B, one or more additional predicted values correspond to estimates of predicted future values of other input values of the one or more input values 105, and the estimated value 171C corresponds to an estimated input value subsequent to the predicted value 169B. In some implementations, the estimator 170 includes a neural network that is configured to process the one or more predicted values to generate the estimated value 171C.

The conditional input 167B includes the estimated value 171C (x̆_{b}), the one or more predicted values, such as the predicted value 169B (\hat{x}_{b}), one or more additional predicted values, or a combination thereof. The feature generator 164 generates the feature data 163B based on the conditional input 167B, and the encoder 166 processes the input value 105B based on the feature data 163B to generate the encoded data 165B, as described with reference to FIG. 4.

Referring to FIG. 13, an example 1300 is shown of a decoder portion 180 of the compression network 140 that is operable to perform prediction corresponding to future prediction. For example, the decoder portion 180 is configured to process encoded data 165B (generated at an encoder portion 160 of a compression network 140 as described with reference to FIG. 12) corresponding to an input value 105B (x_{b}) to generate a predicted value 195C (\hat{x}_{c}) that corresponds to a predicted future value.

The conditional input generator 182 obtains a predicted value 195B (\hat{x}_{b}). For example, the decoder portion 180 processes the encoded data 165A to generate the predicted value 195B (\hat{x}_{b}). In a particular example, the predicted value 195B corresponds to a predicted future value of the input value 105B (x_{b}).

In some implementations, the conditional input generator 182 obtains one or more additional predicted values. The one or more additional predicted values can be associated with at least one input value that is prior to the input value 105B in the one or more input values 105, at least one input value that is subsequent to the input value 105B in the one or more input values 105, or both.

Optionally, in some implementations, the conditional input generator 182 uses the estimator 188 to generate an estimated value 193C (x̆_{c}) of a predicted future value of the input value 105C (x_{c}) based on the one or more predicted values (e.g., the predicted value 195B). To illustrate, the estimated value 193C (x̆_{c}) corresponds to an estimate of a predicted future value of the input value 105C (x_{c}) that can be generated at the decoder portion 180 based on sets of encoded data corresponding to the one or more predicted values and independently of the encoded data 165B.

In a particular implementation, the estimator 188 uses one or more estimation techniques (similar to estimation techniques performed at the estimator 170 as described with reference to FIG. 12) to determine the estimated value 193C. For example, the predicted value 195B corresponds to an estimate of a predicted future value of the input value 105B, one or more additional predicted values correspond to estimates of predicted future values of other input values of the one or more input values 105, and the estimated value 193C corresponds to an estimated input value subsequent to the predicted value 195B. In some implementations, the estimator 188 includes a neural network that is configured to process the one or more predicted values to generate the estimated value 193C.

The conditional input 187B includes the estimated value 193C (x̆_{c}), the one or more predicted values, such as the predicted value 195B (\hat{x}_{b}), one or more additional predicted values, or a combination thereof. The feature generator 184 generates the feature data 183B based on the conditional input 187B, and the decoder 186 processes the encoded data 165B based on the feature data 183B to generate the predicted value 195C (\hat{x}_{c}), as described with reference to FIG. 5.

A technical advantage of using the compression network 140 to generate a predicted future value can include initiating actions based on the predicted future value. For examples, the actions can include a preventive action, such as initiating braking, based on determining that the predicted value 195C corresponds to an alert condition (e.g., a collision). It should be understood that the predicted value 195C corresponding to a predicted future value of one of the one or more input values 105 is provided as an illustrative example. In other examples, the predicted value 195C can correspond to a predicted future value (e.g., collision or no collision) that is associated with the input value 105B (e.g., an image frame).

FIGS. 14-18 describe an example of a compression network 140 that is configured to perform prediction corresponding to image reconstruction. The compression network 140 includes a first compression network 140 associated with motion estimation, and a second compression network 140 associated with image reconstruction based on the motion estimation.

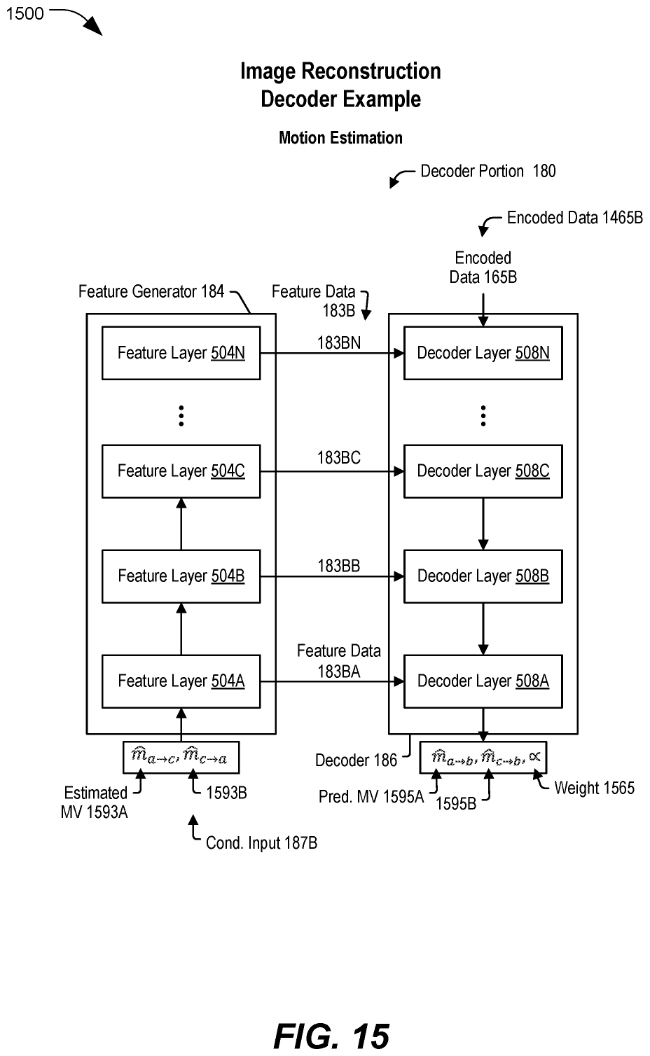

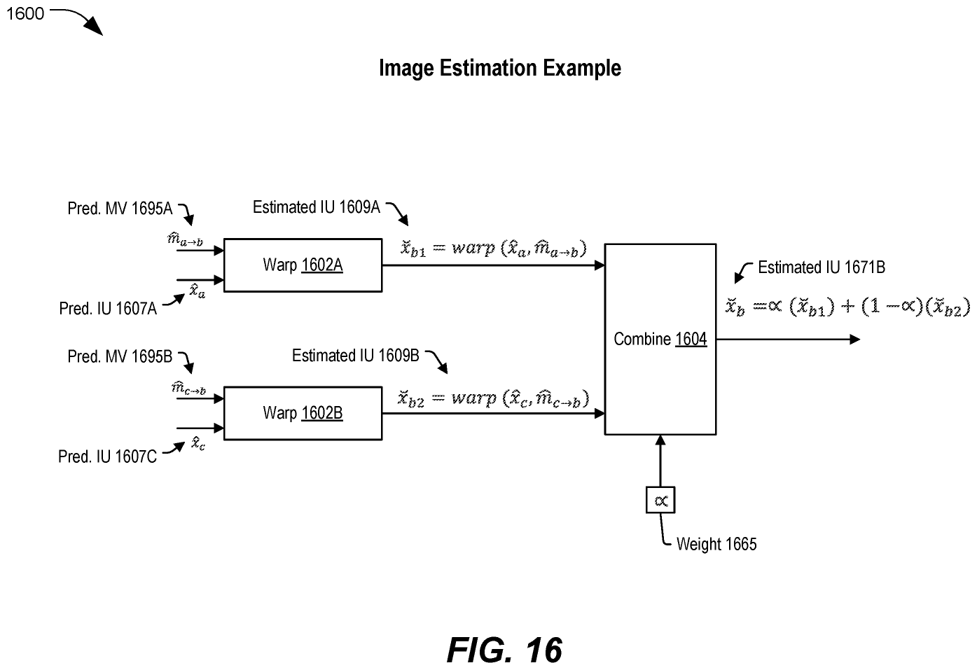

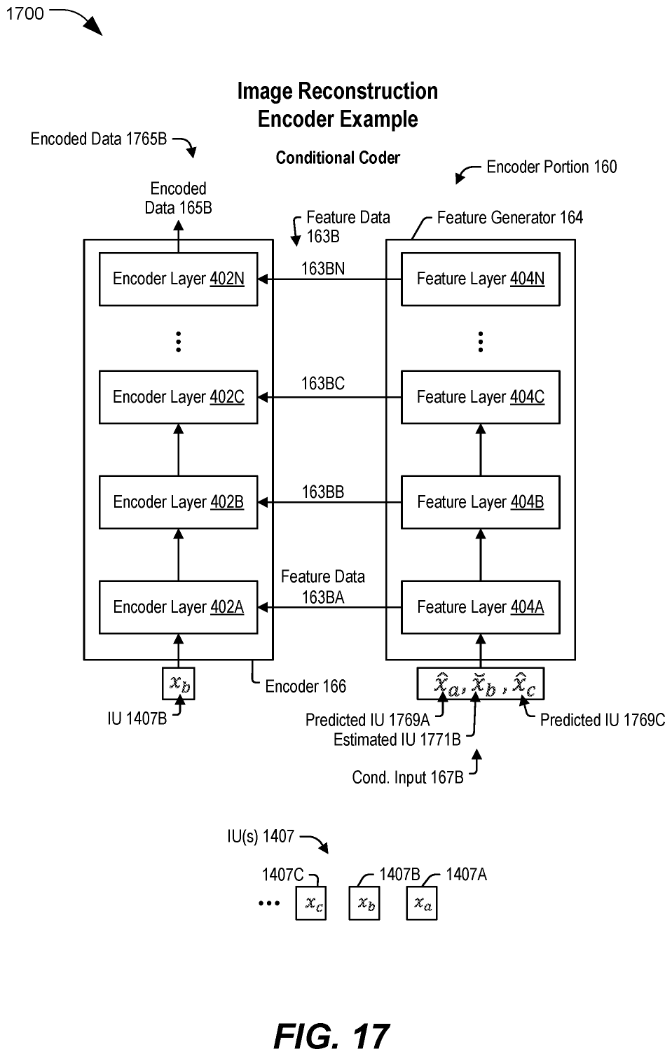

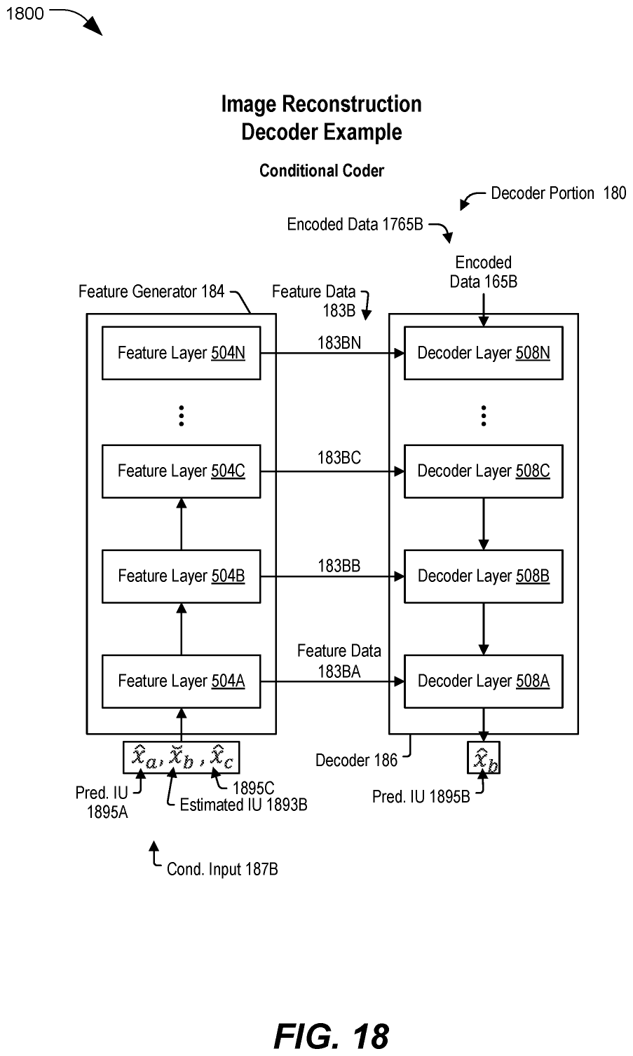

FIG. 14 includes an example of an encoder portion 160 of the first compression network 140 associated with motion estimation. FIG. 15 includes an example of a decoder portion 180 of the first compression network 140 associated with motion estimation. FIG. 17 includes an example of an encoder portion 160 of the second compression network 140 associated with image reconstruction based on the motion estimation. FIG. 18 includes an example of a decoder portion 180 of the second compression network 140 associated with image reconstruction based on the motion estimation. FIG. 16 includes an example of image estimation that can be performed at the encoder portion 160 and at the decoder portion 180 of the second compression network 140 associated with image reconstruction based on the motion estimation.

In some examples, an encoder portion 160 of the compression network 140 includes the encoder portion 160 of the first compression network 140 and the encoder portion 160 of the second compression network 140. Similarly, the decoder portion 180 of the compression network 140 includes the decoder portion 180 of the first compression network 140 and the decoder portion 180 of the second compression network 140.

Referring to FIG. 14, an example 1400 is shown of an encoder portion 160 of a compression network 140 that is operable to perform prediction corresponding to image reconstruction. For example, the encoder portion 160 is included in the first compression network 140 associated with motion estimation.

The encoder portion 160 is configured to process one or more image units 1407 to generate sets of encoded data 165. The one or more image units 1407 include an image unit 1407A, an image unit 1407B, an image unit 1407C, one or more additional image units, or a combination thereof. As illustrative non-limiting examples, an image unit 1407 can correspond to a coding unit, a block of pixels, a frame of pixels, an image frame, or a combination thereof.

The encoder portion 160 is configured to determine one or more motion values 1405 associated with the one or more image units 1407. For example, the encoder portion 160, in response to determining that the image unit 1407B (x_{b}) is to be encoded, determines one or more motion values 1405 based on a comparison of the image unit 1407B with one or more other image units of the one or more image units 1407. To illustrate, the encoder portion 160, in response to determining that the image unit 1407B is to be encoded, determines a motion value 1405A (m_{a→b}) based on a comparison of the image unit 1407A and the image unit 1407B, determines a motion value 1405B (m̆_{c→b}) based on a comparison of the image unit 1407C and the image unit 1407B, determines one or more additional motion values, or a combination thereof.

In a particular aspect, the one or more motion values 1405 represent motion vectors associated with the one or more image units 1407. For example, the motion value 1405A represents motion vectors associated with the image unit 1407A and the image unit 1407B. In a particular aspect, the one or more motion values 1405 indicate one or more of linear velocity, linear acceleration, linear position, angular velocity, angular acceleration, or angular position associated with the one or more image units 1407. For example, the motion value 1405A indicates one or more of linear velocity, linear acceleration, linear position, angular velocity, angular acceleration, or angular position associated with the image unit 1407A and the image unit 1407B. In a particular aspect, the compression network 140 is configured to track an object associated with the one or more motion values 1405 across one or more image units. In a particular aspect, the one or more motion values 1405 are based on the sensor data 226 received from the one or more sensors 240, as described with reference to FIG. 2. For example, the motion value 1405A (m_{a→b}) is based on first sensor data 226 associated with (e.g., captured concurrently with) the image unit 1407A and second sensor data 226 associated (e.g., captured concurrently with) with the image unit 1407B.

The conditional input generator 162 of the encoder portion 160 generates the conditional input 167B. For example, the conditional input generator 162 uses the local decoder portion 168 to process encoded data associated with the image unit 1407A to generate a first predicted image unit, and uses the local decoder portion 168 to process encoded data associated with the image unit 1407C to generate a second predicted image unit. In a particular aspect, the first predicted image unit (\hat{x}ₐ) corresponds to an estimate of a prediction of the image unit 1407A (xₐ) that can be generated at the decoder portion 180 of FIG. 18. In a particular aspect, the second predicted image unit (\hat{x}_{c}) corresponds to an estimate of a prediction of the image unit 1407C (x_{c}) that can be generated at the decoder portion 180 of FIG. 18. The conditional input generator 162 determines each of an estimated motion value 1469A (m̆_{a→c}) and an estimated motion value 1469B (\hat{m}_{c→a}) based on the first predicted image unit (\hat{x}ₐ) and the second predicted image unit (\hat{x}_{c}). The conditional input 167B includes the estimated motion value 1469A (m̆_{a→c}), the estimated motion value 1469B (\hat{m}_{c→a}), or both.

The feature generator 164 processes the conditional input 167B to generate feature data 163B, as described with reference to FIG. 4. The encoder 166 processes the motion value 1405A (m_{a→b}), the motion value 1405B (m_{c→b}), the image unit 1407B (x_{b}), and the feature data 163B to generate the encoded data 165B associated with the image unit 1407B. For example, the encoder layer 402A processes the motion value 1405A (m_{a→b}), the motion value 1405B (m_{c→b}), the image unit 1407B (x_{b}), and the feature data 163BA to generate an output. The encoder layer 402B processes an output of the encoder layer 402A and the feature data 163BB to generate an output, and so on. An output of the encoder layer 402N corresponds to the encoded data 165B (e.g., encoded data 1465B) associated with motion estimation. The one or more motion values 1405, one or more weights, or a combination thereof, can be used to generate an estimated image unit (x̆_{b}), as further described with reference to FIG. 16.

Referring to FIG. 15, an example 1500 is shown of a decoder portion 180 of the compression network 140 that is operable to perform prediction corresponding to image reconstruction. For example, the decoder portion 180 is included in the first compression network associated with motion estimation.

The decoder portion 180 is configured to process sets of encoded data 165 to generate one or more predicted motion values 1595, one or more weights, or a combination thereof. The one or more predicted motion values 1595, the one or more weights, or a combination thereof, can be used to generate an estimated image unit (x̆_{b}). as further described with reference to FIG. 16.

The conditional input generator 182 of the decoder portion 180 generates the conditional input 187B. For example, the conditional input generator 182 obtains a first predicted image unit (\hat{x}ₐ) that is generated by the decoder portion 180 of the second compression network 140 by processing encoded data associated with the image unit 1407A (xₐ), as further described with reference to FIG. 18. In some aspects, the conditional input generator 182 obtains a second predicted image unit (\hat{x}_{c}) that is generated by the decoder portion 180 of the second compression network 140 by processing encoded data associated with the image unit 1407C (x_{c}), as further described with reference to FIG. 18. In a particular aspect, the image unit 1407A (xₐ), the image unit 1407C (x_{c}), or both, correspond to key units (e.g., I-frames) that can be decoded independently of decoding encoded data associated with the image unit 1407B (x_{b}).

The conditional input generator 182 determines each of an estimated motion value 1593A (\hat{m}_{a→c}) and an estimated motion value 1593B (\hat{m}_{c→a}) based on the first predicted image unit (\hat{x}ₐ) and the second predicted image unit (\hat{x}_{c}). The conditional input 187B includes the estimated motion value 1593A (\hat{m}_{a→c}), the estimated motion value 1593B (\hat{m}_{c→a}), or both.

The feature generator 184 processes the conditional input 187B to generate feature data 183B. For example, the feature layer 504A processes the estimated motion value 1593A (\hat{m}_{a→c}), the estimated motion value 1593B (\hat{m}_{c→a}), or both, to generate the feature data 183BA. The feature layer 504B processes an output of the feature layer 504A to generate the feature data 183BB, and so on. The decoder 186 processes the encoded data 165B (e.g., the encoded data 1465B) and the feature data 183B, as described with reference to FIG. 5, to generate a predicted motion value 1595A (\hat{m}_{a→b}), a predicted motion value 1595B (m̆_{c→b}), a weight 1565 (x), or a combination thereof.

In a particular example, the decoder portion 180 uses the estimated motion value 1593A (\hat{m}_{a→c}) and the estimated motion value 1593B (\hat{m}_{c→a}) corresponding to motion values (e.g., motion vectors) between the first predicted image unit (\hat{x}ₐ) and the second predicted image unit (\hat{x}_{c}) as the conditional input 187B, and generates the predicted motion value 1595A (\hat{m}_{a→b}), the predicted motion value 1595B (m̆_{c→b}), and the weight 1565 (∝) that can be used to generate a predicted image unit (\hat{x}_{b}) associated with the image unit 1407B (x_{b}), as further described with reference to FIGS. 16-18.

Referring to FIG. 16, an example is shown of an image estimator 1600 of a compression network 140 that is operable to perform prediction corresponding to image reconstruction. For example, the image estimator 1600 is included in the estimator 170 of the encoder portion 160, the estimator 188 of the decoder portion 180, or both of the second compression network 140 associated with image reconstruction.

The image estimator 1600 performs a warp 1602A of a predicted image unit 1607A (\hat{x}ₐ) based on a predicted motion value 1695A (\hat{m}_{a→b}) to generate an estimated image unit 1609A (x̆_{b1}). The image estimator 1600 performs a warp 1602B of a predicted image unit 1607C (\hat{x}_{c}) based on a predicted motion value 1695B (m̆_{c→b}) to generate an estimated image unit 1609B (x̆_{b2}). The image estimator 1600 performs a combine 1604 of the estimated image unit 1609A (x̆_{b1}) and the estimated image unit 1609B (x̆_{b2}) to generate an estimated image unit 1671B (x̆_{b}). For example, the estimated image unit 1671B (x̆_{b}) corresponds to a weighted combination of the estimated image unit 1609A (x̆_{b1}) and the estimated image unit 1609B (x̆_{b2}). To illustrate, the image estimator 1600 applies a first weight (e.g., a weight 1665) to the estimated image unit 1609A (x̆_{b1}) to generate a first weighted image unit, applies a second weight (e.g., 1—the weight 1665) to the estimated image unit 1609B (x̆_{b2}) to generate a second weighted image unit, and combines the first weighted image unit and the second image unit to generate the estimated image unit 1671B (x̆_{b}).

The image estimator 1600 generating the estimated image unit 1671B based on two predicted image units 1607 is provided as an illustrative example. In other examples, the image estimator 1600 can generate the estimated image unit 1671B based on more than two predicted image units 1607. For example, the image estimator 1600 can warp one or more additional predicted image units 1607 to generate one or more additional estimated image units, and combine the estimated image units based on various weights to generate the estimated image unit 1671B.

In a particular aspect, the encoder portion 160 of the second compression network 140 uses the image estimator 1600 to generate a first estimated image unit (x̆_{b}) corresponding to the image unit 1407B, as further described with reference to FIG. 17. In a particular aspect, the decoder portion 180 of the second compression network 140 uses the image estimator 1600 to generate a second estimated image unit (x̆_{b}) corresponding to the image unit 1407B, as further described with reference to FIG. 18.

Referring to FIG. 17, an example 1700 is shown of an encoder portion 160 of the compression network 140 that is operable to perform prediction corresponding to image reconstruction. For example, the encoder portion 160 corresponds to an image encoder portion of the second compression network 140 associated with image reconstruction based on motion estimation.

The encoder portion 160 is configured to process the one or more image units 1407 to generate sets of encoded data 165. The conditional input generator 162 uses the local decoder portion 168 to generate a predicted image unit 1769A (\hat{x}ₐ). For example, the local decoder portion 168 processes encoded data associated with the image unit 1407A (xₐ) to generate the predicted image unit 1769A (\hat{x}ₐ). In a particular example, the predicted image unit 1769A (\hat{x}ₐ) corresponds to an estimate of a predicted image unit associated with the image unit 1407A that can be generated at the decoder portion 180 of FIG. 18. Similarly, the conditional input generator 162 uses the local decoder portion 168 to generate a predicted image unit 1769C (\hat{x}_{c}). For example, the local decoder portion 168 processes encoded data associated with the image unit 1407C (x_{c}) to generate the predicted image unit 1769C (\hat{x}_{c}).

The conditional input generator 162 uses the estimator 170 (e.g., the image estimator 1600) to generate an estimated image unit 1771B (x̆_{b}) based on the motion value 1405A (m_{a→b}) and the motion value 1405B (m_{c→b}) that are generated by the motion estimation performed by the encoder portion 160 of FIG. 14. For example, the predicted image unit 1769A (\hat{x}ₐ) corresponds to the predicted image unit 1607A (\hat{x}ₐ), the predicted image unit 1769C (\hat{x}_{c}) corresponds to the predicted image unit 1607C (\hat{x}_{c}), the motion value 1405A (m_{a→b}) corresponds to the predicted motion value 1695A (\hat{m}_{a→b}), and the motion value 1405B (m_{c→b}) corresponds to the predicted motion value 1695B (\hat{m}_{c→b}). The conditional input generator 162 also provides a weight as the weight 1665. In a particular aspect, the weight is based on a configuration setting, default data, a user input, or a combination thereof. The estimated image unit 1671B (x̆_{b}) corresponds to the estimated image unit 1771B (x̆_{b}). The conditional input 167B includes the predicted image unit 1769A (\hat{x}ₐ), the estimated image unit 1771B (x̆_{b}), and the predicted image unit 1769C (\hat{x}_{c}).

The feature generator 164 processes the conditional input 167B to generate feature data 163B, as described with reference to FIG. 4. For example, the feature layer 404A processes the predicted image unit 1769A (\hat{x}ₐ), the estimated image unit 1771B (x̆_{b}), and the predicted image unit 1769C (\hat{x}_{c}) to generate the feature data 163BA. The feature layer 404B processes an output of the feature layer 404A to generate the feature data 163BB, and so on. The encoder 166 processes the image unit 1407B (x_{b}) and the feature data 163B to generate the encoded data 165B, as described with reference to FIG. 4. For example, the encoder layer 402A processes the image unit 1407B (x_{b}) and the feature data 163BA to generate an output. The encoder layer 402B processes an output of the encoder layer 402A and the feature data 163BB to generate an output, and so on. An output of the encoder layer 402N corresponds to the encoded data 165B (e.g., encoded data 1765B) associated with image reconstruction.

Referring to FIG. 18, an example 1800 is shown of a decoder portion 180 of the compression network 140 that is operable to perform prediction corresponding to image reconstruction. For example, the decoder portion 180 corresponds to an image decoder portion of the second compression network 140 associated with image reconstruction based on motion estimation.

The decoder portion 180 is configured to process sets of encoded data 165 to generate one or more predicted image units 1895. The conditional input generator 182 obtains a predicted image unit 1895A (\hat{x}ₐ). For example, the decoder portion 180 processes encoded data associated with the image unit 1407A (xₐ) to generate the predicted image unit 1895A (\hat{x}ₐ). Similarly, the conditional input generator 182 obtains a predicted image unit 1895C (\hat{x}_{c}). For example, the decoder portion 180 processes encoded data associated with the image unit 1407C (x_{c}) to generate the predicted image unit 1895C (\hat{x}_{c}).

The conditional input generator 182 uses the estimator 188 (e.g., the image estimator 1600) to generate an estimated image unit 1893B (x̆_{b}) based on the predicted motion value 1595A (\hat{m}_{a→b}) and the predicted motion value 1595B (m̆_{c→b}) that are generated by the motion estimation performed by the decoder portion 180 of FIG. 15. For example, the predicted image unit 1895A (\hat{x}ₐ) corresponds to the predicted image unit 1607A (\hat{x}ₐ), the predicted image unit 1895C (\hat{x}_{c}) corresponds to the predicted image unit 1607C (\hat{x}_{c}), the predicted motion value 1595A (\hat{m}_{a→b}) corresponds to the predicted motion value 1695A (\hat{m}_{a→b}), the predicted motion value 1595B (m̆_{c→b}) corresponds to the predicted motion value 1695B (m̆_{c→b}), and the weight 1565 (∝) of FIG. 15 corresponds to the weight 1665. The estimated image unit 1671B (x̆_{b}) corresponds to the estimated image unit 1893B (x̆_{b}). The conditional input 187B includes the predicted image unit 1895A (\hat{x}ₐ), the estimated image unit 1893B (x̆_{b}), and the predicted image unit 1895C (\hat{x}_{c}).

The feature generator 184 processes the conditional input 187B to generate feature data 183B, as described with reference to FIG. 5. For example, the feature layer 504A processes the predicted image unit 1895A (\hat{x}ₐ), the estimated image unit 1893B (x̆_{b}), the predicted image unit 1895C (\hat{x}_{c}) to generate the feature data 183BA. The feature layer 504B processes an output of the feature layer 504A to generate the feature data 183BB, and so on. The decoder 186 processes the encoded data 165B (e.g., the encoded data 1765B) and the feature data 183B, as described with reference to FIG. 5. to generate a predicted image unit 1895B (\hat{x}_{b}). A technical advantage of using the compression network 140 to process the image unit 1407B to generate the encoded data 1465B and the encoded data 1765B and to process the encoded data 1465B and the encoded data 1765B to generate the predicted image unit 1895B can include a reduced size of the encoded data 1465B, the encoded data 1765B, or both.

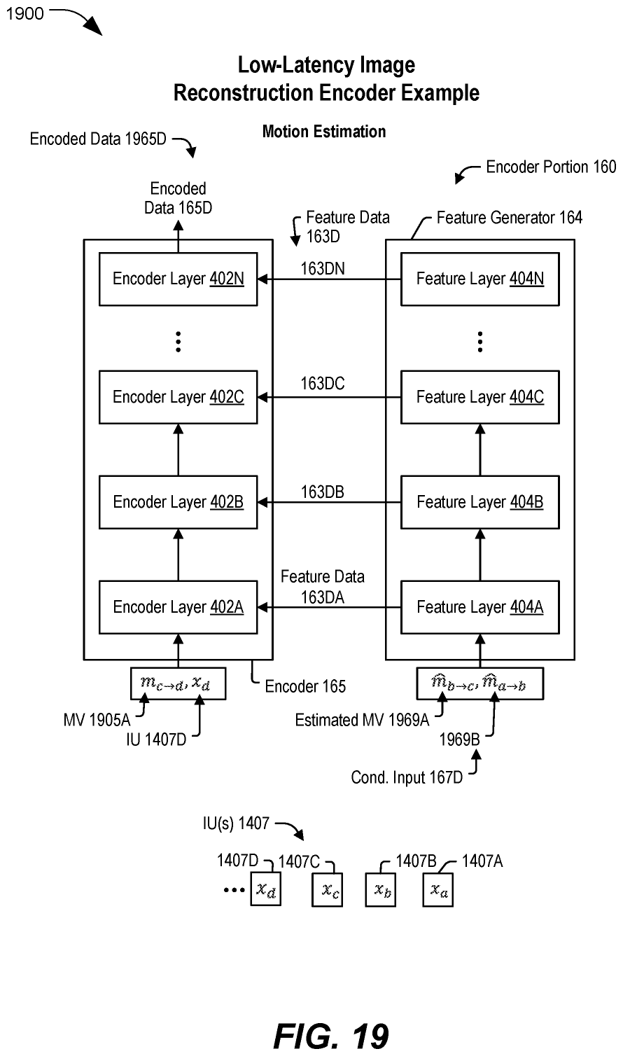

FIGS. 19-23 describe an example of a compression network 140 that is configured to perform prediction corresponding to low-latency image reconstruction. The compression network 140 includes a first compression network 140 associated with low-latency motion estimation, and a second compression network 140 associated with low-latency image reconstruction based on the low-latency motion estimation.

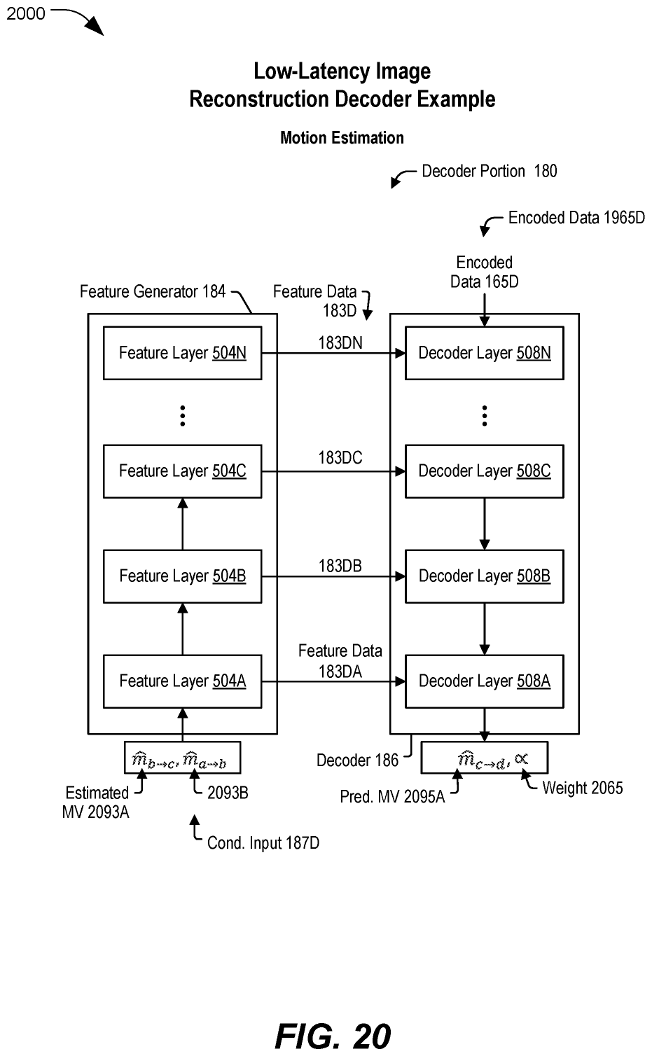

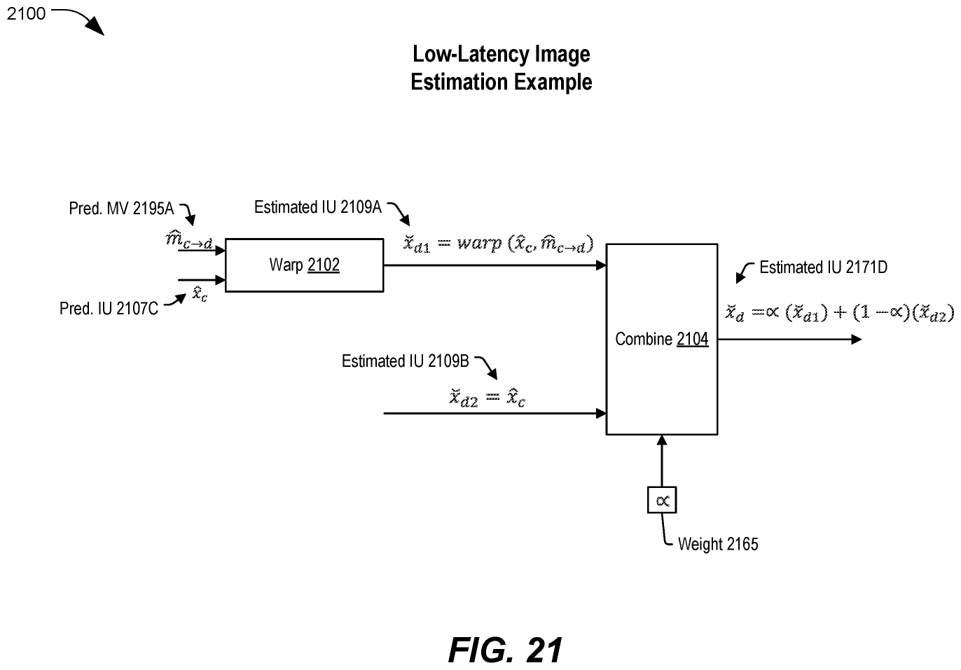

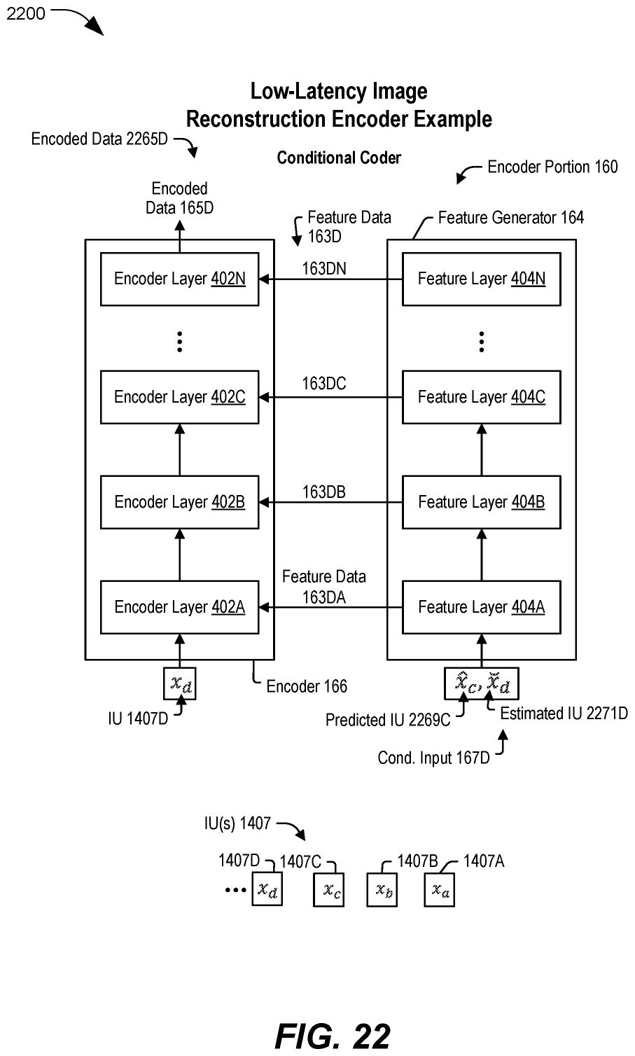

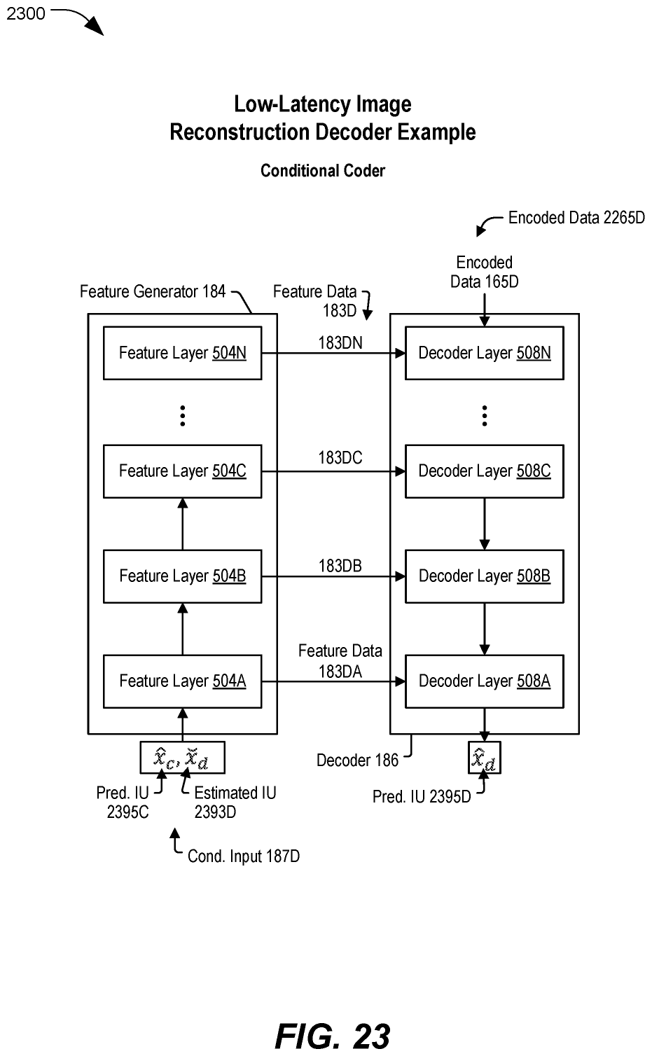

FIG. 19 includes an example of an encoder portion 160 of the first compression network 140 associated with low-latency motion estimation. FIG. 20 includes an example of a decoder portion 180 of the first compression network 140 associated with low-latency motion estimation. FIG. 22 includes an example of an encoder portion 160 of the second compression network 140 associated with low-latency image reconstruction based on low-latency motion estimation. FIG. 23 includes an example of a decoder portion 180 of the second compression network 140 associated with low-latency image reconstruction based on low-latency motion estimation. FIG. 21 includes an example of image estimation that can be performed at the encoder portion 160 and at the decoder portion 180 of the second compression network 140 associated with low-latency image reconstruction based on low-latency motion estimation.

In some examples, an encoder portion 160 of the compression network 140 includes the encoder portion 160 of the first compression network 140 and the encoder portion 160 of the second compression network 140. Similarly, the decoder portion 180 of the compression network 140 includes the decoder portion 180 of the first compression network 140 and the decoder portion 180 of the second compression network 140.

Referring to FIG. 19 is a diagram of an illustrative aspect of an example of a encoder portion 160 of a compression network 140 that is operable to perform prediction corresponding to low-latency image reconstruction. For example, the encoder portion 160 is included in the first compression network 140 associated with low-latency motion estimation.

The encoder portion 160 is configured to process the one or more image units 1407 to generate sets of encoded data 165. The encoder portion 160 is configured to determine one or more motion values 1905 associated with the one or more image units 1407. For example, the encoder portion 160, in response to determining that an image unit 1407D (x_{d}) of the one or more image units 1407 is to be encoded, determines one or more motion values 1905 based on a comparison of the image unit 1407D with one or more other image units of the one or more image units 1407. To illustrate, the encoder portion 160, in response to determining that the image unit 1407D is to be encoded, determines a motion value 1905A (m_{c→d}) based on a comparison of the image unit 1407C (x_{c}) and the image unit 1407D (x_{d}), determines one or more additional motion values based on a comparison of the image unit 1407D and one or more image units that are prior to the image unit 1407D in the one or more image units 1407, or a combination thereof.

In a particular aspect, the one or more motion values 1905 represent motion vectors associated with the one or more image units 1407. For example, the motion value 1905A (m_{c→d}) represents motion vectors associated with the image unit 1407C and the image unit 1407D. In a particular aspect, the one or more motion values 1905 indicate one or more of linear velocity, linear acceleration, linear position, angular velocity, angular acceleration, or angular position associated with the one or more image units 1407. For example, the motion value 1905A indicates one or more of linear velocity, linear acceleration, linear position, angular velocity, angular acceleration, or angular position associated with the image unit 1407C and the image unit 1407D. In a particular aspect, the one or more motion values 1905 are based on the sensor data 226 received from the one or more sensors 240, as described with reference to FIG. 2. For example, the motion value 1905A (m_{c→d}) is based on first sensor data 226 associated with (e.g., captured concurrently with) the image unit 1407C and second sensor data 226 associated (e.g., captured concurrently with) with the image unit 1407D.

The conditional input generator 162 of the encoder portion 160 generates conditional input 167D. For example, the conditional input generator 162 uses the local decoder portion 168 to processes encoded data associated with the image unit 1407A to generate a first predicted image unit (\hat{x}ₐ), uses the local decoder portion 168 to process encoded data associated with the image unit 1407B to generate a second predicted image unit (\hat{x}_{b}), and uses the local decoder portion 168 to process encoded data associated with the image unit 1407C to generate a third predicted image unit (\hat{x}_{c}). In a particular aspect, the first predicted image unit (\hat{x}ₐ) corresponds to an estimate of a prediction of the image unit 1407A (xₐ) that can be generated at the decoder portion 180 of FIG. 23. The conditional input generator 162 determines an estimated motion value 1969A (\hat{m}_{b→c}) based on the second predicted image unit (\hat{x}_{b}) and the third predicted image unit (\hat{x}_{c}). The conditional input generator 162 determines an estimated motion value 1969B (\hat{m}_{a→b}) based on the first predicted image unit (\hat{x}ₐ) and the second predicted image unit (\hat{x}_{b}). The conditional input 167D includes the estimated motion value 1969A (\hat{m}_{b→c}), the estimated motion value 1969B (\hat{m}_{a→b}), or both.

The feature generator 164 processes the conditional input 167D to generate feature data 163D, as described with reference to FIG. 4. For example, the feature layer 404A processes the estimated motion value 1969A and the estimated motion value 1969B to generate feature data 163DA. The feature layer 404B processes an output of the feature layer 404A to generate feature data 163DB, and so on. The feature data 163D includes the feature data 163DA, the feature data 163DB, feature data 163DC, one or more additional sets of feature data including feature data 163DN, or a combination thereof. The encoder 166 processes the motion value 1905A (m_{c→d}), the image unit 1407D (x_{d}), and the feature data 163D to generate the encoded data 165D associated with the image unit 1407D. For example, the encoder layer 402A processes the motion value 1905A (m_{c→d}), the image unit 1407D (x_{d}), and the feature data 163DA to generate an output. The encoder layer 402B processes an output of the encoder layer 402A and the feature data 163DB to generate an output, and so on. An output of the encoder layer 402N corresponds to the encoded data 165D (e.g., encoded data 1965D) associated with motion estimation. The one or more motion values 1905, one or more weights, or a combination thereof, can be used to generate an estimated image unit (x̆_{d}), as further described with reference to FIG. 21.

The encoder portion 160 can thus generate the encoded data 165D independently of (e.g., prior to) obtaining any image units subsequent to the image unit 1407D in the one or more image units 1407. A technical advantage of generating the encoded data 165D independently of subsequent image units can include reduced latency associated with generating the encoded data 165D without having to wait for access to the subsequent image units.

Referring to FIG. 20, an example 2000 is shown of a decoder portion 180 of the compression network 140 that is operable to perform prediction corresponding to low-latency image reconstruction. For example, the decoder portion 180 is included in the first compression network associated with low-latency motion estimation.

The decoder portion 180 is configured to process sets of encoded data 165 to generate one or more predicted motion values 2095, one or more weights, or a combination thereof. The one or more predicted motion values 2095, the one or more weights, or a combination thereof, can be used to generate an estimated image unit (x̆_{b}), as further described with reference to FIG. 21.

The conditional input generator 182 of the decoder portion 180 generates the conditional input 187D. For example, the conditional input generator 182 obtains a first predicted image unit (\hat{x}ₐ) that is generated by the decoder portion 180 of the second compression network 140 by processing encoded data associated with the image unit 1407A (xₐ), as further described with reference to FIG. 23. Similarly, in some aspects, the conditional input generator 182 obtains a second predicted image unit (\hat{x}_{b}) and a third predicted image unit (\hat{x}_{c}) associated with the image unit 1407B (x_{b}) and the image unit 1407C (x_{c}), respectively, as further described with reference to FIG. 23. In a particular aspect, the image unit 1407A (xₐ), the image unit 1407B (x_{b}), the image unit 1407C (x_{c}), or a combination thereof, are prior to the image unit 1407D (x_{d}) that is being encoded.

The conditional input generator 182 determines an estimated motion value 2093A (\hat{m}_{b→c}) based on a comparison of the second predicted image unit (\hat{x}_{b}) and the third predicted image unit (\hat{x}_{c}). Similarly, the conditional input generator 182 determines an estimated motion value 2093B (\hat{m}_{a→b}) based on a comparison of the first predicted image unit (\hat{x}ₐ) and the second predicted image unit (\hat{x}_{b}). The conditional input 187D includes the estimated motion value 2093A (\hat{m}_{b→c}), the estimated motion value 2093B (\hat{m}_{a→b}), or both.

The feature generator 184 processes the conditional input 187D to generate feature data 183D, as described with reference to FIG. 5. For example, the feature layer 504A processes the estimated motion value 2093A (\hat{m}_{b→c}), the estimated motion value 2093B (\hat{m}_{a→b}), or both, to generate feature data 183DA. The feature layer 504B processes an output of the feature layer 504A to generate feature data 183 DB, and so on. The feature data 183D includes the feature data 183DA, the feature data 183 DB, feature data 183DC, one or more additional sets of feature data including feature data 183DN, or a combination thereof. The decoder 186 processes the encoded data 165D (e.g., the encoded data 1965D) and the feature data 183D, as described with reference to FIG. 5, to generate a predicted motion value 2095A (\hat{m}_{c→d}), a weight 2065 (∝), or both. For example, the decoder layer 508N processes the encoded data 165D and the feature data 183DN to generate an output. The decoder layer 508B processes an output of the decoder layer 508C and the feature data 183DB to generate an output, and so on. An output of the decoder layer 508A corresponds to the predicted motion value 2095A (\hat{m}_{c→d}), the weight 2065 (∝), or both associated with image unit 1407D.

In a particular example, the decoder portion 180 uses the estimated motion value 2093A (\hat{m}_{b→c}) and the estimated motion value 2093B (\hat{m}_{a→b}) corresponding to motion values (e.g., motion vectors) between predicted image units that are prior to the image unit 1407D as the conditional input 187D, and generates the predicted motion value 2095A (\hat{m}_{c→d}) and the weight 2065 (∝) that can be used to generate a predicted image unit (x̆_{d}) associated with the image unit 1407D (x_{d}), as further described with reference to FIGS. 21-23. A technical advantage of generating the predicted motion value 2095A (\hat{m}_{c→d}) independently of the encoded data associated with any image units subsequent to the image unit 1407D can include reduced latency associated with generating the predicted motion value 2095A (\hat{m}_{c→d}).

Referring to FIG. 21, an example is shown of an image estimator 2100 of a compression network 140 that is operable to perform prediction corresponding to low-latency image reconstruction. For example, the image estimator 2100 is included in the estimator 170 of the encoder portion 160, the estimator 188 of the decoder portion 180, or both of the second compression network 140 associated with low-latency image reconstruction.

The image estimator 2100 performs a warp 2102 of a predicted image unit 2107C (\hat{x}_{c}) based on a predicted motion value 2195A (\hat{m}_{c→d}) to generate an estimated image unit 2109A (x̆_{d1}). The image estimator 2100 uses the predicted image unit 2107C (\hat{x}_{c}) as an estimated image unit 2109B (x̆_{d2}). The image estimator 2100 performs a combine 2104 of the estimated image unit 2109A (x̆_{d1}) and the estimated image unit 2109B (x̆_{d2}) to generate an estimated image unit 2171D (x̆_{d}). For example, the estimated image unit 2171D (x̆_{d}) corresponds to a weighted combination of the estimated image unit 2109A (x̆_{d1}) and the estimated image unit 2109B (x̆_{d2}). To illustrate, the image estimator 2100 applies a first weight (e.g., a weight 2165) to the estimated image unit 2109A (x̆_{d1}) to generate a first weighted image unit, applies a second weight (e.g., 1—the weight 2165) to the estimated image unit 2109B (x̆_{d2}) to generate a second weighted image unit, and combines the first weighted image unit and the second image unit to generate the estimated image unit 2171D (x̆_{d}).

The image estimator 2100 generating the estimated image unit 2171D based on a single predicted image unit 2107 is provided as an illustrative example. In other examples, the image estimator 2100 can generate the estimated image unit 2171D based on multiple predicted image units 2107. For example, the image estimator 2100 can warp one or more additional predicted image units 2107 to generate one or more additional estimated image units, and combine the estimated image units based on various weights to generate the estimated image unit 2171D.

In a particular aspect, the encoder portion 160 of the second compression network 140 uses the image estimator 2100 to generate a first estimated image unit (x̆_{d}) corresponding to the image unit 1407D, as further described with reference to FIG. 22. In a particular aspect, the decoder portion 180 of the second compression network 140 uses the image estimator 2100 to generate a second estimated image unit (x̆_{d}) corresponding to the image unit 1407D, as further described with reference to FIG. 23.

Referring to FIG. 22, an example 2200 is shown of an encoder portion 160 of the compression network 140 that is operable to perform prediction corresponding to low-latency image reconstruction. For example, the encoder portion 160 corresponds to an image encoder portion of the second compression network 140 associated with low-latency image reconstruction based on low-latency motion estimation.

The encoder portion 160 is configured to process the one or more image units 1407 to generate sets of encoded data 165. The conditional input generator 162 uses the local decoder portion 168 to generate a predicted image unit 2269C (\hat{x}_{c}). For example, the local decoder portion 168 processes encoded data associated with the image unit 1407C (x_{c}) to generate the predicted image unit 2269C (\hat{x}_{c}). In a particular example, the predicted image unit 2269C (\hat{x}_{c}) corresponds to an estimate of a predicted image unit associated with the image unit 1407C that can be generated at the decoder portion 180 of FIG. 23.

The conditional input generator 162 uses the estimator 170 (e.g., the image estimator 2100) to generate an estimated image unit 2271D (x̆_{d}) based on the motion value 1905A (m_{c→d}) that is generated by the motion estimation performed at the encoder portion 160 of FIG. 19. For example, the predicted image unit 2269C (\hat{x}_{c}) corresponds to the predicted image unit 2107C (\hat{x}_{c}), and the motion value 1905A (m_{c→d}) corresponds to the predicted motion value 2195A (\hat{m}_{c→d}). The conditional input generator 162 also provides a weight as the weight 2165. In a particular aspect, the weight is based on a configuration setting, default data, a user input, or a combination thereof. The estimated image unit 2171D (x̆_{d}) corresponds to the estimated image unit 2271D (x̆_{d}). Conditional input 167D associated with the image unit 1407D includes the predicted image unit 2269C (\hat{x}_{c}) and the estimated image unit 2271D (x̆_{d}).

The feature generator 164 processes the conditional input 167D to generate feature data 163D, as described with reference to FIG. 4. For example, the feature layer 404A processes the conditional input 167D to generate feature data 163DA. The feature layer 404B processes an output of the feature layer 404A to generate feature data 163DB, and so on. The feature data 163D includes the feature data 163DA, the feature data 163DB, feature data 163DC, one or more additional sets of feature data including feature data 163DN, or a combination thereof. The encoder 166 processes the image unit 1407D (x_{d}) to generate the encoded data 165D. For example, the encoder layer 402A processes the image unit 1407D (x_{d}) and the feature data 163DA to generate an output. The encoder layer 402B processes an output of the encoder layer 402A and the feature data 163DB to generate an output, and so on. An output of the encoder layer 402N corresponds to the encoded data 165D (e.g., encoded data 2265D) associated with low-latency image reconstruction.

The encoder portion 160 can thus generate the encoded data 165D independently of (e.g., prior to) obtaining any image units subsequent to the image unit 1407D in the one or more image units 1407. A technical advantage of generating the encoded data 165D independently of subsequent image units can include reduced latency associated with generating the encoded data 165D without having to wait for access to the subsequent image units.

Referring to FIG. 23, an example 2300 is shown of a decoder portion 180 of the compression network 140 that is operable to perform prediction corresponding to low-latency image reconstruction. For example, the decoder portion 180 corresponds to an image decoder portion of the second compression network 140 associated with low-latency image reconstruction based on low-latency motion estimation.

The decoder portion 180 is configured to process sets of encoded data 165 to generate one or more predicted image units 2395. The conditional input generator 182 obtains a predicted image unit 2395C (\hat{x}_{c}). For example, the decoder portion 180 processes encoded data associated with the image unit 1407C (x_{c}) to generate the predicted image unit 2395C (\hat{x}_{c}).

The conditional input generator 182 uses the estimator 188 (e.g., the image estimator 2100) to generate an estimated image unit 2393D (x̆_{d}) based on the predicted motion value 2095A (\hat{m}_{c→d}) that is generated by the motion estimation performed by the decoder portion 180 of FIG. 20. For example, the predicted image unit 2395C (\hat{x}_{c}) corresponds to the predicted image unit 2107C (\hat{x}_{c}), the predicted motion value 2095A (\hat{m}_{c→d}) corresponds to the predicted motion value 2195A (\hat{m}_{c→d}), and the weight 2065 (x) of FIG. 20 corresponds to the weight 2165. The estimated image unit 2171D (x̆a) corresponds to the estimated image unit 2393D (x̆_{d}). Conditional input 187D associated with the image unit 1407D includes the predicted image unit 2395C (\hat{x}_{c}), and the estimated image unit 2393D (x̆_{d}).

The feature generator 184 processes the conditional input 187D to generate feature data 183D, as described with reference to FIG. 5. For example, the feature layer 504A processes the predicted image unit 2395C (\hat{x}_{c}), and the estimated image unit 2393D (x̆a) to generate feature data 183DA. The feature layer 504B processes an output of the feature layer 504A to generate feature data 183 DB, and so on. The feature data 183D includes the feature data 183DA, the feature data 183 DB, feature data 183DC, one or more additional sets of feature data including feature data 183DN, or a combination thereof. The decoder 186 processes the encoded data 165B (e.g., the encoded data 2265D) and the feature data 183D, as described with reference to FIG. 5, to generate a predicted image unit 2395D (\hat{x}_{d}). A technical advantage of using the compression network 140 can include a reduced size of the encoded data 1965D, the encoded data 2265D, or both. A technical advantage of generating the predicted image unit 2395D (x̆_{d}) independently of encoded data of any subsequent image units of the one or more image units 1407 can include reduced latency associated with generating the predicted image unit 2395D (x̆_{d}).

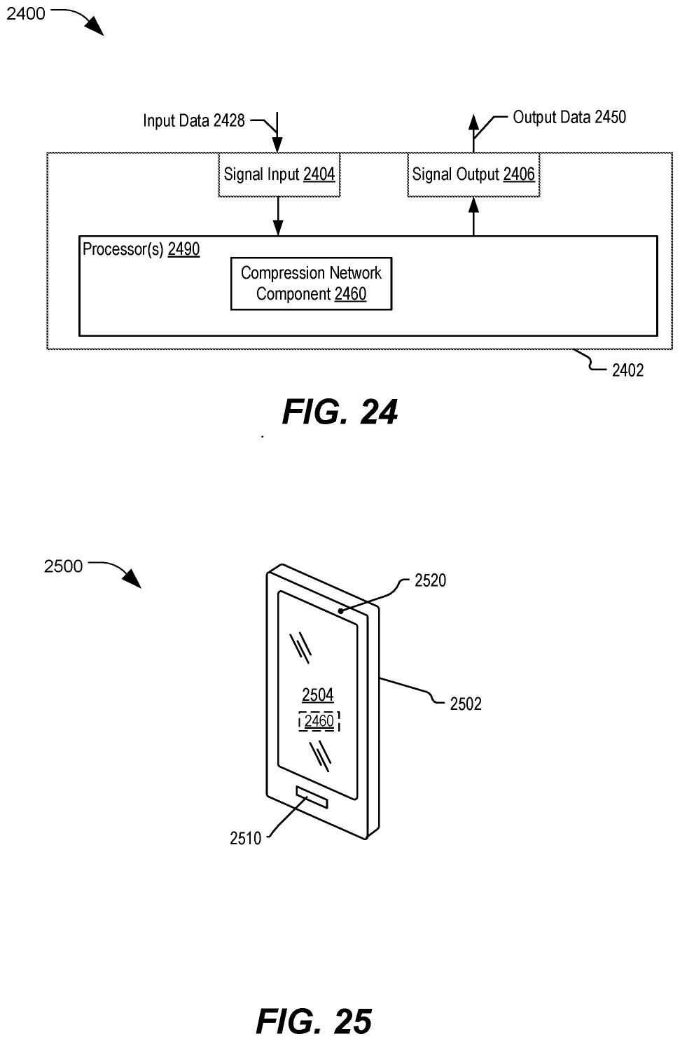

FIG. 24 depicts an implementation 2400 of an integrated circuit 2402 that includes one or more processors 2490. The one or more processors 2490 include a compression network component 2460, such as the encoder portion 160, the decoder portion 180, or both, of the compression network 140 of FIG. 1. The integrated circuit 2402 also includes a signal input 2404, such as one or more bus interfaces, to enable input data 2428 to be received for processing. The integrated circuit 2402 also includes a signal output 2406, such as a bus interface, to enable sending of output data 2450. For example, in implementations in which the compression network component 2460 includes the encoder portion 160, the input data 2428 can include the input value(s) 105 and the output data 2450 can include the sets of encoded data 165. In implementations in which the compression network component 2460 includes the decoder portion 180, the input data 2428 can include the sets of encoded data 165 and the output data 2450 can include the predicted value(s) 195. In implementations in which the compression network component 2460 includes the encoder portion 160 and the decoder portion 180, the input data 2428 can include the input value(s) 105 and the output data 2450 can include the predicted value(s) 195. The integrated circuit 2402 enables implementation of at least a portion of the compression network 140 as a component in various systems, such as a mobile phone or tablet as depicted in FIG. 25, a headset as depicted in FIG. 26, a wearable electronic device as depicted in FIG. 27, a voice-controlled speaker system as depicted in FIG. 28, a camera as depicted in FIG. 29, a virtual reality, mixed reality, or augmented reality headset as depicted in FIG. 30, or a vehicle as depicted in FIG. 31 or FIG. 32.

FIG. 25 depicts an implementation 2500 in which the compression network component 2460 is implemented in a mobile device 2502, such as a phone or tablet, as illustrative, non-limiting examples. The mobile device 2502 includes one or more microphones 2510, one or more speakers 2520, and a display screen 2504. In addition, the compression network component 2460 is integrated in the mobile device 2502 and is illustrated using dashed lines to indicate internal components that are not generally visible to a user of the mobile device 2502. In a particular example, the compression network component 2460 operates to improve a coding efficiency to reduce an amount of resources used for transmission or storage of encoded data. In an illustrative, non-limiting example, the compression network component 2460 operates to encode video data captured by a camera of the mobile device 2502 for transmission to another device, to decode video data received from another device, or a combination thereof. In another illustrative, non-limiting example, the compression network component 2460 operates to encode data for storage at the mobile device 2502 and to decode the data upon retrieval from storage.

FIG. 26 depicts an implementation 2600 in which the compression network component 2460 is implemented in a headset device 2602. The headset device 2602 includes a microphone 2610 and a camera 2620. In a particular example, the compression network component 2460 operates to improve a coding efficiency to reduce an amount of resources used for transmission or storage of encoded data. In an illustrative, non-limiting example, the compression network component 2460 operates to encode data, such as audio data captured by the microphone 2610, video data captured by the camera 2620, and/or head tracking data (e.g., sensor data from an IMU of the headset device 2602) for transmission to another device, to decode data, such as audio data received from another device for playout at earphone speakers of the headset device 2602, or a combination thereof. In another illustrative, non-limiting example, the compression network component 2460 operates to encode data for storage at the headset device 2602 and to decode the data upon retrieval from storage.

FIG. 27 depicts an implementation 2700 in which the compression network component 2460 is implemented in a wearable electronic device 2702, illustrated as a “smart watch.” The compression network component 2460, a microphone 2710, a speaker 2720, and a display screen 2704 are integrated into the wearable electronic device 2702. In a particular example, the compression network component 2460 operates to improve a coding efficiency to reduce an amount of resources used for transmission or storage of encoded data. In an illustrative, non-limiting example, the compression network component 2460 operates to encode data, such as audio data captured by the microphone 2710, for transmission to another device; alternatively, the compression network component 2460 operates to decode data, such as audio data received from another device for playout at the speaker 2720 or video data for playout at the display screen 2704; or both. In another illustrative, non-limiting example, the compression network component 2460 operates to encode data for storage at the wearable electronic device 2702 and to decode the data upon retrieval from storage.

In a particular example, the wearable electronic device 2702 includes a haptic device that provides a haptic notification (e.g., vibrates) in response to detection of activity associated with operation of the compression network component 2460. For example, the haptic notification can cause a user to look at the wearable electronic device 2702 to see a displayed notification that data (e.g., audio or video data) has been received from a remote device and is available for playout at wearable electronic device 2702. The wearable electronic device 2702 can thus alert a user with a hearing impairment or a user wearing a headset of such notifications.

FIG. 28 is an implementation 2800 in which the compression network component 2460 is implemented in a wireless speaker and voice activated device 2802. The wireless speaker and voice activated device 2802 can have wireless network connectivity and is configured to execute an assistant operation. One or more processors 2890 including the compression network component 2460, a microphone 2810, a camera 2820, a speaker 2804, or a combination thereof, are included in the wireless speaker and voice activated device 2802. In a particular example, the compression network component 2460 operates to improve a coding efficiency to reduce an amount of resources used for transmission or storage of encoded data. In an illustrative, non-limiting example, the compression network component 2460 operates to encode video data captured by the camera 2820 for transmission to another device, to decode audio data for playout at the speaker 2804, to decode video data received from another device for playout at a display screen (not shown) of the wireless speaker and voice activated device 2802, or a combination thereof. In another illustrative, non-limiting example, the compression network component 2460 operates to encode data for storage at the wireless speaker and voice activated device 2802 and to decode the data upon retrieval from storage.

During operation, in response to receiving a verbal command from a user via the microphones 2810, the wireless speaker and voice activated device 2802 can execute assistant operations, such as via execution of a voice activation system (e.g., an integrated assistant application). The assistant operations can include adjusting a temperature, playing music, turning on lights, etc. For example, the assistant operations can include initiating transmission of data to a remote device, receipt of data from a remote device, and/or storage/retrieval of data from a local memory of the wireless speaker and voice activated device 2802, each of which is conducted more efficiently due to operation of the compression network component 2460.

FIG. 29 depicts an implementation 2900 in which the compression network component 2460 is implemented in a portable electronic device that corresponds to a camera device 2902. The compression network component 2460, and a microphone 2910 are integrated in the camera device 2902. In a particular example, the compression network component 2460 operates to improve a coding efficiency to reduce an amount of resources used for transmission or storage of encoded data. In an illustrative, non-limiting example, the compression network component 2460 operates to encode data that is captured at the camera device 2902, such as image data, video data, audio data, or a combination thereof, for transmission to another device. In another illustrative, non-limiting example, the compression network component 2460 operates to encode data, such as video or image data captured at the camera device 2902, for storage at a memory of the camera device 2902 and also to decode the data upon retrieval from memory.

FIG. 30 depicts an implementation 3000 in compression network component 2460 is implemented in a portable electronic device that corresponds to a virtual reality, mixed reality, or augmented reality headset 3002. The compression network component 2460, a microphone 3010, and a camera 3020 are integrated into the headset 3002. A visual interface device, such as a display screen, is positioned in front of the user's eyes to enable display of augmented reality, mixed reality, or virtual reality images or scenes to the user while the headset 3002 is worn. In a particular example, the compression network component 2460 operates to improve a coding efficiency to reduce an amount of resources used for transmission or storage of encoded data. In an illustrative, non-limiting example, the compression network component 2460 operates to decode data that is received at the headset 3002, such as video data, audio data, other data associated with providing a virtual, augmented, or mixed reality experience for a user of the headset 3002, or a combination thereof. In an illustrative, non-limiting example, the compression network component 2460 operates to encode data that is captured at the headset 3002, such head tracking data from an IMU of the headset 3002, for transmission to a remote device (e.g., a virtual reality (VR) session server). In another illustrative, non-limiting example, the compression network component 2460 operates to encode data, such as video, audio, or image data captured at or received by the headset 3002, for storage at a memory of the headset 3002 and also operates to decode the data upon retrieval from memory.

FIG. 31 depicts an implementation 3100 in which the compression network component 2460 corresponds to, or is integrated within, a vehicle 3102, illustrated as a manned or unmanned aerial device (e.g., a package delivery drone). The compression network component 2460, a microphone 3110, a speaker 3120, a camera 3104, or a combination thereof, are integrated into the vehicle 3102. User voice activity detection can be performed based on audio signals received from the microphone 3110 of the vehicle 3102, such as for delivery instructions from an authorized user of the vehicle 3102.

In a particular example, the compression network component 2460 operates to improve a coding efficiency to reduce an amount of resources used for transmission or storage of encoded data. In an illustrative, non-limiting example, the compression network component 2460 operates to encode video data captured by the camera 3104 of the vehicle 3102 for transmission to another device, to decode video data received from another device, or a combination thereof. In another illustrative, non-limiting example, the compression network component 2460 operates to encode data for storage at the vehicle 3102 and to decode the data upon retrieval from storage.

FIG. 32 depicts another implementation 3200 in which the compression network component 2460 corresponds to, or is integrated within, a vehicle 3202, illustrated as a car. The vehicle 3202 includes the one or more processors 290, the one or more processors 292, the one or more processors 390, or a combination thereof, including the compression network component 2460. The vehicle 3202 also includes a microphone 3210, a camera 3204, or both.

User voice activity detection can be performed based on audio signals received from the microphone 3210 of the vehicle 3202. In some implementations, user voice activity detection can be performed based on an audio signal received from interior microphones (e.g., the microphone 3210), such as for a voice command from an authorized passenger. For example, the user voice activity detection can be used to detect a voice command from an operator of the vehicle 3202 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed based on an audio signal received from external microphones (e.g., the microphone 3210), such as an authorized user of the vehicle. In a particular implementation, in response to receiving a verbal command identified as user speech, a voice activation system initiates one or more operations of the vehicle 3202 based on one or more detected keywords (e.g., “unlock,” “start engine,” “play music,” “display weather forecast,” or another voice command), such as by providing feedback or information via a display 3220 or one or more speakers (e.g., a speaker 3230).

In a particular example, the compression network component 2460 operates to improve a coding efficiency to reduce an amount of resources used for transmission or storage of encoded data. In an illustrative, non-limiting example, the compression network component 2460 operates to encode video data captured by the camera 3204 of the vehicle 3202 for transmission to another device, to decode video data received from another device, or a combination thereof. In another illustrative, non-limiting example, the compression network component 2460 operates to encode data for storage at the vehicle 3202 and to decode the data upon retrieval from storage.

The camera 3204 can capture one or more image frames while the vehicle 3202 is in operation. The compression network component 2460 can process one or more motion values (e.g., the one or more input values 105) associated with the one or more image frames to generate sets of encoded data 165. The one or more motion values can include the one or more image frames, one or more speed measurements, one or more acceleration measurements, other sensor data, a navigation route of the vehicle 3202, or a combination thereof. The vehicle 3202 can store the encoded data 165 at the vehicle 3202, transmit the sets of encoded data 165 to another device (e.g., a server), or both.

In some implementations, the compression network component 2460 generates the one or more predicted values 195 based on the sets of encoded data 165. In a collision avoidance example, the compression network component 2460 can track an object in the one or more image frames. The compression network component 2460 generates the one or more predicted values 195 corresponding to predicted future motion values. For example, the one or more predicted values 195 indicate whether a predicted future position of the vehicle 3202 is within a distance threshold of a predicted future position of the object. In some implementations, the compression network component 2460, in response to determining that the predicted future position of the vehicle 3202 is within the distance threshold of the predicted future position of the object, initiates one or more collision avoidance actions, such as generating an alert, initiating braking, activating an alarm, sending an alert to an emergency vehicle, or a combination thereof.

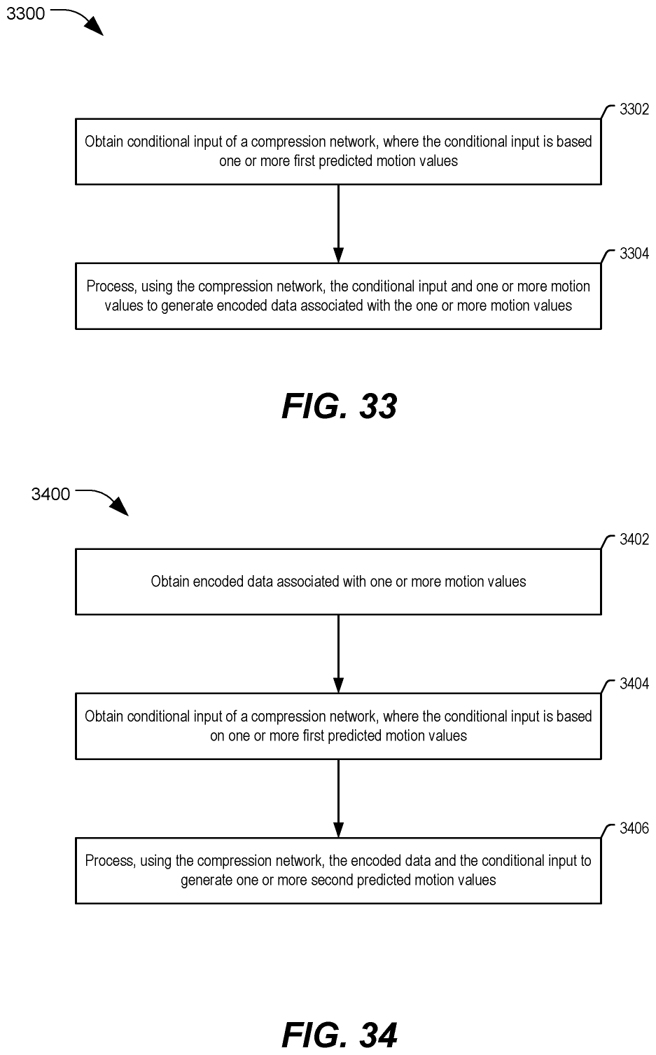

Referring to FIG. 33, a particular implementation of a method 3300 of generating encoded data using a compression network is shown. In a particular aspect, one or more operations of the method 3300 are performed by at least one of the conditional input generator 162, the feature generator 164, the encoder 166, the local decoder portion 168, the estimator 170, the encoder portion 160, the compression network 140 of FIG. 1, the one or more processors 290, the device 202, the system 200 of FIG. 2, the one or more processors 390, the device 302, the system 300 of FIG. 3, the compression network component 2460 of FIG. 24, or a combination thereof.

The method 3300 includes obtaining conditional input of a compression network, where the conditional input is based one or more first predicted motion values, at 3302. For example, the conditional input generator 162 of FIG. 1 obtains the conditional input 167B of the compression network 140, as described with reference to FIG. 1. The conditional input 167B is based on a predicted value 169A (e.g., a predicted motion value).

The method 3300 also includes processing, using the compression network, the conditional input and one or more motion values to generate encoded data associated with the one or more motion values, at 3304. For example, the encoder portion 160 uses the feature generator 164 of the compression network 140 to process the conditional input 167B to generate the feature data 163B, and uses the encoder 166 of the compression network 140 to process the feature data 163B and the input value 105B to generate the encoded data 165B associated with the input value 105B, as described reference to FIG. 1.

The method 3300 thus enables reducing the amount of information to be provided to the decoder portion 180 as the encoded data 165A by generating the encoded data 165A based on an estimate (e.g., the conditional input 167B) of information (e.g., the conditional input 187B) that can be generated at the decoder portion 180.

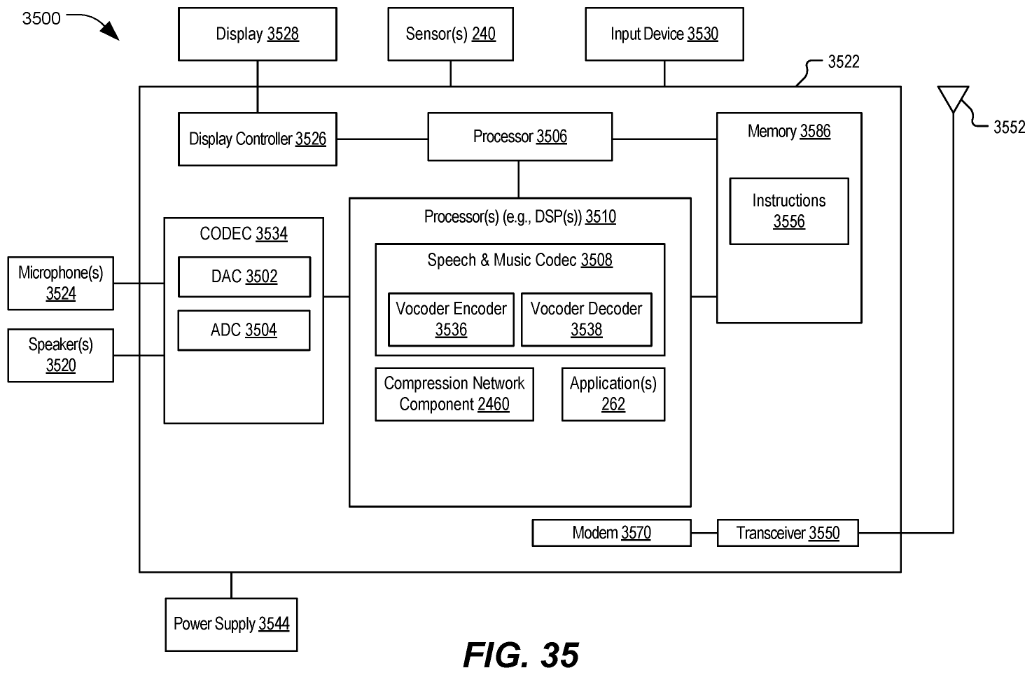

The method 3300 of FIG. 33 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 3300 of FIG. 33 may be performed by a processor that executes instructions, such as described with reference to FIG. 35.

Referring to FIG. 34, a particular implementation of a method 3400 of generating predicted data from encoded data using a compression network is shown. In a particular aspect, one or more operations of the method 3400 are performed by at least one of the conditional input generator 182, the feature generator 184, the decoder 186, the estimator 188, the decoder portion 180, the compression network 140 of FIG. 1, the one or more processors 292, the device 260, the system 200 of FIG. 2, the one or more processors 390, the device 302, the system 300 of FIG. 3, the compression network component 2460 of FIG. 24, or a combination thereof.

The method 3400 includes obtaining encoded data associated with one or more motion values, at 3402. For example, the decoder portion 180 obtains, from the encoder portion 160, the encoded data 165B associated with the input value 105B, as described with reference to FIG. 1.

The method 3400 also includes obtaining conditional input of a compression network, where the conditional input is based on one or more first predicted motion values, at 3404. For example, the conditional input generator 182 obtains the conditional input 187B of the compression network 140, as described with reference to FIG. 1. The conditional input 187B is based on the predicted value 195A.

The method 3400 further includes processing, using the compression network, the encoded data and the conditional input to generate one or more second predicted motion values, at 3406. For example, the decoder portion 180 uses the feature generator 184 of the compression network 140 to process the conditional input 187B to generate the feature data 183B and uses the decoder 186 of the compression network 140 to process the feature data 183B and the encoded data 165B to generate the predicted value 195B, as described with reference to FIG. 1.

The method 3400 thus enables reducing the amount of information to be obtained by the decoder portion 180 as the encoded data 165A by generating the predicted value 195B based on information (e.g., the conditional input 187B) that can be estimated (e.g., the conditional input 167B) at the encoder portion 160.

The method 3400 of FIG. 34 may be implemented by a FPGA device, an ASIC, a processing unit such as a CPU, a DSP, a controller, another hardware device, firmware device, or any combination thereof. As an example, the method 3400 of FIG. 34 may be performed by a processor that executes instructions, such as described with reference to FIG. 35.

Referring to FIG. 35, a block diagram of a particular illustrative implementation of a device is depicted and generally designated 3500. In various implementations, the device 3500 may have more or fewer components than illustrated in FIG. 35. In an illustrative implementation, the device 3500 may correspond to one or more of the device 202, the device 260 of FIG. 2, or the device 302 of FIG. 3. In an illustrative implementation, the device 3500 may perform one or more operations described with reference to FIGS. 1-34.

In a particular implementation, the device 3500 includes a processor 3506 (e.g., a CPU). The device 3500 may include one or more additional processors 3510 (e.g., one or more DSPs). In a particular aspect, the one or more processors 290, the one or more processors 292 of FIG. 2, the one or more processors 390 of FIG. 3, or a combination thereof, correspond to the processor 3506, the processors 3510, or a combination thereof. The processors 3510 may include a speech and music coder-decoder (CODEC) 3508 that includes a voice coder (“vocoder”) encoder 3536, a vocoder decoder 3538, or both. The processors 3510 may include the compression network component 2460, the one or more applications 262, or a combination thereof.

The device 3500 may include a memory 3586 and a CODEC 3534. The memory 3586 may include instructions 3556, that are executable by the one or more additional processors 3510 (or the processor 3506) to implement the functionality described with reference to the compression network component 2460. The device 3500 may include a modem 3570 coupled, via a transceiver 3550, to an antenna 3552. In a particular aspect, the modem 3570 corresponds to the modem 270, the modem 280, or both, of FIG. 2.

The device 3500 may include a display 3528 coupled to a display controller 3526. One or more speakers 3520, one or more microphones 3524, or a combination thereof, may be coupled to the CODEC 3534. The CODEC 3534 may include a digital-to-analog converter (DAC) 3502, an analog-to-digital converter (ADC) 3504, or both. In a particular implementation, the CODEC 3534 may receive analog signals from the one or more microphones 3524, convert the analog signals to digital signals using the analog-to-digital converter 3504, and provide the digital signals to the speech and music codec 3508. The speech and music codec 3508 may process the digital signals, and the digital signals may further be processed by the compression network component 2460, the one or more applications 262, or a combination thereof. In a particular implementation, the speech and music codec 3508 may provide digital signals to the CODEC 3534. The CODEC 3534 may convert the digital signals to analog signals using the digital-to-analog converter 3502 and may provide the analog signals to the one or more speakers 3520.

In a particular implementation, the device 3500 may be included in a system-in-package or system-on-chip device 3522. In a particular implementation, the memory 3586, the processor 3506, the processors 3510, the display controller 3526, the CODEC 3534, and the modem 3570 are included in the system-in-package or system-on-chip device 3522. In a particular implementation, an input device 3530, the one or more sensors 240, and a power supply 3544 are coupled to the system-in-package or the system-on-chip device 3522. Moreover, in a particular implementation, as illustrated in FIG. 35, the display 3528, the input device 3530, the one or more speakers 3520, the one or more microphones 3524, the one or more sensors 240, the antenna 3552, and the power supply 3544 are external to the system-in-package or the system-on-chip device 3522. In a particular implementation, each of the display 3528, the input device 3530, the one or more speakers 3520, the one or more microphones 3524, the one or more sensors 240, the antenna 3552, and the power supply 3544 may be coupled to a component of the system-in-package or the system-on-chip device 3522, such as an interface or a controller.

The device 3500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IOT) device, a VR device, an extended reality (XR) device, a base station, a mobile device, or any combination thereof.

In conjunction with the described implementations, an apparatus includes means for obtaining encoded data associated with one or more motion values. For example, the means for obtaining encoded data can correspond to the decoder portion 180, the encoder portion 160, the compression network 140 of FIG. 1, the modem 280, the one or more processors 292, the device 260, the system 200 of FIG. 2, the storage device 392, the device 302, the system 300 of FIG. 3, the processor 3506, the processors 3510, the antenna 3552, the transceiver 3550, the modem 3570, one or more other circuits or components configured to obtain encoded data associated with one or more motion values, or any combination thereof.

The apparatus also includes means for obtaining conditional input of a compression network, where the conditional input is based on one or more first predicted motion values. For example, the means for obtaining conditional input can correspond to the estimator 188, the conditional input generator 182, the decoder portion 180, the compression network 140 of FIG. 1, the one or more processors 292, the device 260, the system 200 of FIG. 2, the device 302, the system 300 of FIG. 3, the image estimator 1600 of FIG. 16, the image estimator 2100 of FIG. 21, the processor 3506, the processors 3510, one or more other circuits or components configured to obtain the conditional input, or any combination thereof.

The apparatus further includes means for processing, using the compression network, the encoded data and the conditional input to generate one or more second predicted motion values. For example, the means for processing the encoded data and the conditional input can correspond to the feature generator 184, the decoder 186, the decoder portion 180, the compression network 140 of FIG. 1, the one or more processors 292, the device 260, the system 200 of FIG. 2, the device 302, the system 300 of FIG. 3, the processor 3506, the processors 3510, one or more other circuits or components configured to process the encoded data and the conditional input, or any combination thereof.

Also in conjunction with the described implementations, an apparatus includes means for obtaining conditional input of a compression network, wherein the conditional input is based on one or more first predicted motion values. For example, the means for obtaining conditional input can correspond to the local decoder portion 168, the estimator 170, the conditional input generator 162, the encoder portion 160, the compression network 140 of FIG. 1, the one or more processors 290, the device 202, the system 200 of FIG. 2, the device 302, the system 300 of FIG. 3, the image estimator 1600 of FIG. 16, the image estimator 2100 of FIG. 21, the processor 3506, the processors 3510, one or more other circuits or components configured to obtain the conditional input, or any combination thereof.

The apparatus also includes means for processing, using the compression network, the conditional input and one or more motion values to generate encoded data associated with one or more motion values. For example, the means for processing the conditional input and one or more motion values can correspond to the feature generator 164, the encoder 166, the encoder portion 160, the compression network 140 of FIG. 1, the one or more processors 290, the device 202, the system 200 of FIG. 2, the device 302, the system 300 of FIG. 3, the processor 3506, the processors 3510, one or more other circuits or components configured to process the conditional input and the one or more motion values, or any combination thereof.

In some implementations, a non-transitory computer-readable medium (e.g., a computer-readable storage device, such as the memory 3586) includes instructions (e.g., the instructions 3556) that, when executed by one or more processors (e.g., the one or more processors 3510 or the processor 3506), cause the one or more processors to obtain encoded data (e.g., the encoded data 165B) associated with one or more motion values (e.g., the input value 105B). The instructions, when executed by the one or more processors, also cause the one or more processors to obtain conditional input (e.g., the conditional input 187B) of a compression network (e.g., the compression network 140), wherein the conditional input is based on one or more first predicted motion values (e.g., the predicted value 195A). The instructions, when executed by the one or more processors, further cause the one or more processors to process, using the compression network, the encoded data and the conditional input to generate one or more second predicted motion values (e.g., the predicted value 195B).

In some implementations, a non-transitory computer-readable medium (e.g., a computer-readable storage device, such as the memory 3586) includes instructions (e.g., the instructions 3556) that, when executed by one or more processors (e.g., the one or more processors 3510 or the processor 3506), cause the one or more processors to obtain conditional input (e.g., the conditional input 167B) of a compression network (e.g., the compression network 140), wherein the conditional input is based on one or more first predicted motion values (e.g., the predicted value 169A). The instructions, when executed by the one or more processors, also cause the one or more processors to process, using the compression network, the conditional input and one or more motion values (e.g., the input value 105B) to generate encoded data (e.g., the encoded data 165B) associated with the one or more motion values.

Particular aspects of the disclosure are described below in sets of interrelated Examples:

According to Example 1, a device includes one or more processors configured to obtain encoded data associated with one or more motion values; obtain conditional input of a compression network, wherein the conditional input is based on one or more first predicted motion values; and process, using the compression network, the encoded data and the conditional input to generate one or more second predicted motion values.

Example 2 includes the device of Example 1, wherein the one or more motion values are based on output of one or more sensors.

Example 3 includes the device of Example 1 or Example 2, wherein the one or more sensors include an inertial measurement unit (IMU).

Example 4 includes the device of any of Examples 1 to 3, wherein the one or more motion values represent one or more motion vectors associated with one or more image units.

Example 5 includes the device of Example 4, wherein an image unit of the one or more image units includes a coding unit.

Example 6 includes the device of Example 4 or Example 5, wherein an image unit of the one or more image units includes a block of pixels.

Example 7 includes the device of any of Examples 4 to 6, wherein an image unit of the one or more image units includes a frame of pixels.

Example 8 includes the device of any of Examples 1 to 7, wherein the one or more second predicted motion values represent future motion vectors.

Example 9 includes the device of any of Examples 1 to 8, wherein the one or more second predicted motion values correspond to a reconstructed version of the one or more motion values.

Example 10 includes the device of any of Examples 1 to 9, wherein the one or more processors are integrated in at least one of a headset, a mobile communication device, an extended reality (XR) device, or a vehicle.

Example 11 includes the device of any of Examples 1 to 10, wherein the one or more motion values indicate one or more of linear velocity, linear acceleration, linear position, angular velocity, angular acceleration, or angular position.

Example 12 includes the device of any of Examples 1 to 11, wherein the compression network includes a neural network with multiple layers.

Example 13 includes the device of any of Examples 1 to 12, wherein the compression network includes a video decoder, and wherein the video decoder has multiple decoder layers configured to decode multiple orders of resolution of the encoded data associated with the one or more motion values.

Example 14 includes the device of any of Examples 1 to 13, wherein the one or more processors are configured to track an object associated with the one or more motion values across one or more frames of pixels.

Example 15 includes the device of Example 14, wherein the one or more second predicted motion values represent a collision avoidance output associated with a vehicle.

Example 16 includes the device of Example 15, wherein the collision avoidance output indicates a predicted future position of the vehicle relative to the object.

Example 17 includes the device of Example 15 or Example 16, wherein the collision avoidance output indicates a predicted future position of the vehicle and a predicted future position of the object.

Example 18 includes the device of any of Examples 1 to 17 and further includes a modem configured to receive a bitstream from an encoder device, wherein the bitstream includes the encoded data.

Example 19 includes the device of any of Example 1 to 18, wherein the one or more processors are configured to process the encoded data and feature data to generate the one or more second predicted motion values, and wherein the feature data is based on the conditional input.

Example 20 includes the device of Example 19 and further includes a modem configured to receive a bitstream from an encoder device, wherein the bitstream includes the feature data and the encoded data.

Example 21 includes the device of Example 19 or Example 20, wherein the one or more processors are configured to process the conditional input using the compression network to generate the feature data.

Example 22 includes the device of any of Examples 19 to 21, wherein the feature data corresponds to multi-scale feature data having different spatial resolutions.

Example 23 includes the device of any of Examples 19 to 22, wherein the feature data includes multi-scale wavelet transform data.

Example 24 includes the device of any of Examples 1 to 23, wherein the encoded data includes motion estimation encoded data associated with an image unit (e.g., x_{b}), and wherein the one or more processors are configured to: determine estimated motion values (e.g., \hat{m}_{a→c}, \hat{m}_{c→a}) based on a comparison of a reconstructed previous image unit (e.g., \hat{x}ₐ) and a reconstructed subsequent image unit (e.g., \hat{x}_{c}); process the estimated motion values to generate motion estimation feature data corresponding to the image unit; and process, using the compression network, the motion estimation encoded data and the motion estimation feature data to generate the one or more second predicted motion values, wherein the one or more second predicted motion values include one or more reconstructed motion values (e.g., \hat{m}_{a→b}, \hat{m}_{c→b}) corresponding to the one or more motion values.

Example 25 includes the device of Example 24, wherein the encoded data includes reconstruction encoded data, and wherein the one or more processors are configured to: generate an estimated image unit (e.g., x̆_{b}) based on the one or more reconstructed motion values (e.g., \hat{m}_{a→b}, \hat{m}_{c→b}); process the estimated image unit to generate reconstruction feature data corresponding to the image unit; and process, using the compression network, the reconstruction encoded data and the reconstruction feature data to generate a reconstructed image unit (e.g., \hat{x}_{b}).

Example 26 includes the device of Example 25, wherein the one or more first predicted motion values include a first reconstructed motion value (e.g., \hat{m}_{a→b}) and a second reconstructed motion value (e.g., \hat{m}_{c→b}), and wherein the one or more processors are configured to: determine a first estimated version of the image unit based on applying the first reconstructed motion value (e.g., \hat{m}_{a→b}) to the reconstructed previous image unit (e.g., \hat{x}ₐ); determine a second estimated version of the image unit based on applying the second reconstructed motion value (e.g., \hat{m}_{c→b}) to the reconstructed subsequent image unit (e.g., \hat{x}_{c}); and generate the estimated image unit (e.g., x̆_{b}) based on a combination of the first estimated version of the image unit and the second estimated version of the image unit.

Example 27 includes the device of any of Examples 1 to 23, wherein the encoded data includes motion estimation encoded data associated with an image unit (e.g., x_{d}), and wherein the one or more processors are configured to: determine a first estimated motion value (e.g., \hat{m}_{b→c}) based on a comparison of a first reconstructed previous image unit (e.g., \hat{x}_{c}) and a second reconstructed previous image unit (e.g., \hat{x}_{b}); process at least the first estimated motion value to generate motion estimation feature data corresponding to the image unit; and process, using the compression network, the motion estimation encoded data and the motion estimation feature data to generate the one or more second predicted motion values, wherein the one or more second predicted motion values include one or more reconstructed motion values (e.g., \hat{m}_{c→d}) corresponding to the one or more motion values.

Example 28 includes the device of Example 27, wherein the encoded data includes reconstruction encoded data, and wherein the one or more processors are configured to: generate an estimated image unit (e.g., x̆ₐ) based on the one or more reconstructed motion values (e.g., \hat{m}_{c→d}); process the estimated image unit to generate reconstruction feature data corresponding to the image unit; and process, using the compression network, the reconstruction encoded data and the reconstruction feature data to generate a reconstructed image unit (e.g., \hat{x}_{d}).

Example 29 includes the device of Example 28, wherein the one or more processors are configured to determine a second estimated motion value (e.g., \hat{m}_{a→b}) based on a comparison of the second reconstructed previous image unit (e.g., \hat{x}_{b}) and a third reconstructed previous image unit (e.g., \hat{x}ₐ), wherein the motion estimation feature data corresponding to the image unit is further based on processing the second estimated motion value.

Example 30 includes the device of Example 28 or Example 29, wherein the one or more first predicted motion values include a first reconstructed motion value (e.g., \hat{m}_{c→d}), and wherein the one or more processors are configured to determine the estimated image unit (e.g., x̆_{d}) based on applying the first reconstructed motion value (e.g., \hat{m}_{c→d}) to the first reconstructed previous image unit (e.g., \hat{x}_{c}), wherein the reconstruction feature data is based on the estimated image unit (e.g., x̆_{d}).

According to Example 31, a method includes obtaining, at a device, encoded data associated with one or more motion values; obtaining, at the device, conditional input of a compression network, wherein the conditional input is based on one or more first predicted motion values; and processing, using the compression network, the encoded data and the conditional input to generate one or more second predicted motion values.

Example 32 includes the method of Example 31, wherein the one or more motion values are based on output of one or more sensors.

Example 33 includes the method of Example 31 or Example 32, wherein the one or more sensors include an inertial measurement unit (IMU).

Example 34 includes the method of any of Examples 31 to 33, wherein the one or more motion values represent one or more motion vectors associated with one or more image units.

Example 35 includes the method of Example 34, wherein an image unit of the one or more image units includes a coding unit.

Example 36 includes the method of Example 34 or Example 35, wherein an image unit of the one or more image units includes a block of pixels.

Example 37 includes the method of any of Examples 34 to 36, wherein an image unit of the one or more image units includes a frame of pixels.

Example 38 includes the method of any of Examples 31 to 37, wherein the one or more second predicted motion values represent future motion vectors.

Example 39 includes the method of any of Examples 31 to 38, wherein the one or more second predicted motion values correspond to a reconstructed version of the one or more motion values.

Example 40 includes the method of any of Examples 31 to 39, wherein the device includes at least one of a headset, a mobile communication device, an extended reality (XR) device, or a vehicle.

Example 41 includes the method of any of Examples 31 to 40, wherein the one or more motion values indicate one or more of linear velocity, linear acceleration, linear position, angular velocity, angular acceleration, or angular position.

Example 42 includes the method of any of Examples 31 to 41, wherein the compression network includes a neural network with multiple layers.

Example 43 includes the method of any of Examples 31 to 42, wherein the compression network includes a video decoder, and wherein the video decoder has multiple decoder layers configured to decode multiple orders of resolution of the encoded data associated with the one or more motion values.

Example 44 includes the method of any of Examples 31 to 43, further including tracking an object associated with the one or more motion values across one or more frames of pixels.

Example 45 includes the method of Example 44, wherein the one or more second predicted motion values represent a collision avoidance output associated with a vehicle.

Example 46 includes the method of Example 45, wherein the collision avoidance output indicates a predicted future position of the vehicle relative to the object.

Example 47 includes the method of Example 45 or Example 46, wherein the collision avoidance output indicates a predicted future position of the vehicle and a predicted future position of the object.

Example 48 includes the method of any of Examples 31 to 47 and further including receiving a bitstream via modem from an encoder device, wherein the bitstream includes the encoded data.

Example 49 includes the method of any of Example 31 to 48 and further including processing the encoded data and feature data to generate the one or more second predicted motion values, wherein the feature data is based on the conditional input.

Example 50 includes the method of Example 49 and further including receiving a bitstream via a modem from an encoder device, wherein the bitstream includes the feature data and the encoded data.

Example 51 includes the method of Example 49 or Example 50 and further including processing the conditional input using the compression network to generate the feature data.

Example 52 includes the method of any of Examples 31 to 51, wherein processing the encoded data and the conditional input includes: processing the conditional input using the compression network to generate feature data; and processing the encoded data and the feature data to generate the one or more second predicted motion values.

Example 53 includes the method of any of Examples 49 to 52, wherein the feature data corresponds to multi-scale feature data having different spatial resolutions.

Example 54 includes the method of any of Examples 49 to 53, wherein the feature data includes multi-scale wavelet transform data.

Example 55 includes the method of any of Examples 31 to 54 and further including: determining estimated motion values (e.g., \hat{m}_{a→c}, \hat{m}_{c→a}) based on a comparison of a reconstructed previous image unit (e.g., \hat{x}ₐ) and a reconstructed subsequent image unit (e.g., \hat{x}_{c}), wherein the encoded data includes motion estimation encoded data associated with an image unit (e.g., x_{b}); processing the estimated motion values to generate motion estimation feature data corresponding to the image unit; and processing, using the compression network, the motion estimation encoded data and the motion estimation feature data to generate the one or more second predicted motion values, wherein the one or more second predicted motion values include one or more reconstructed motion values (e.g., \hat{m}_{a→b}, \hat{m}_{c→b}) corresponding to the one or more motion values.

Example 56 includes the method of Example 55, and further including: generating an estimated image unit (e.g., x̆_{b}) based on the one or more reconstructed motion values (e.g., \hat{m}_{a→b}, \hat{m}_{c→b}); processing the estimated image unit to generate reconstruction feature data corresponding to the image unit; and processing, using the compression network, reconstruction encoded data and the reconstruction feature data to generate a reconstructed image unit (e.g., \hat{x}_{b}), wherein the encoded data includes the reconstruction encoded data.

Example 57 includes the method of Example 56 and further including: determining a first estimated version of the image unit based on applying a first reconstructed motion value (e.g., \hat{m}_{a→b}) to the reconstructed previous image unit (e.g., \hat{x}ₐ), wherein the one or more first predicted motion values include the first reconstructed motion value (e.g., \hat{m}_{a→b}); determining a second estimated version of the image unit based on applying a second reconstructed motion value (e.g., \hat{m}_{c→b}) to the reconstructed subsequent image unit (e.g., \hat{x}_{c}), wherein the one or more first predicted motion values include the second reconstructed motion value (e.g., \hat{m}_{c→b}); and generating the estimated image unit (e.g., x̆_{b}) based on a combination of the first estimated version of the image unit and the second estimated version of the image unit.

Example 58 includes the method of any of Examples 31 to 54 and further including: determining a first estimated motion value (e.g., \hat{m}_{b→c}) based on a comparison of a first reconstructed previous image unit (e.g., \hat{x}_{c}) and a second reconstructed previous image unit (e.g., \hat{x}_{b}), wherein the encoded data includes motion estimation encoded data associated with an image unit (e.g., xₐ); processing at least the first estimated motion value to generate motion estimation feature data corresponding to the image unit; and processing, using the compression network, the motion estimation encoded data and the motion estimation feature data to generate the one or more second predicted motion values, wherein the one or more second predicted motion values include one or more reconstructed motion values (e.g., \hat{m}_{c→d}) corresponding to the one or more motion values.

Example 59 includes the method of Example 58 and further including: generating an estimated image unit (e.g., x̆_{d}) based on the one or more reconstructed motion values (e.g., \hat{m}_{c→d}); processing the estimated image unit to generate reconstruction feature data corresponding to the image unit; and processing, using the compression network, reconstruction encoded data and the reconstruction feature data to generate a reconstructed image unit (e.g., \hat{x}_{d}), wherein the encoded data includes the reconstruction encoded data.

Example 60 includes the method of Example 59 and further including determining a second estimated motion value (e.g., \hat{m}_{a→b}) based on a comparison of the second reconstructed previous image unit (e.g., \hat{x}_{b}) and a third reconstructed previous image unit (e.g., \hat{x}ₐ), wherein the motion estimation feature data corresponding to the image unit is further based on processing the second estimated motion value.

Example 61 includes the method of Example 59 or Example 60 and further including determining the estimated image unit (e.g., x̆_{d}) based on applying a first reconstructed motion value (e.g., \hat{m}_{c→d}) to the first reconstructed previous image unit (e.g., \hat{x}_{c}), wherein the one or more first predicted motion values include the first reconstructed motion value (e.g., \hat{m}_{c→d}), and wherein the reconstruction feature data is based on the estimated image unit (e.g., x̆_{d}).

According to Example 62, a device includes: a memory configured to store instructions; and a processor configured to execute the instructions to perform the method of any of Example 31 to 61.

According to Example 63, a non-transitory computer-readable medium stores instructions that, when executed by a processor, cause the processor to perform the method of any of Examples 31 to 61.

According to Example 64, an apparatus includes means for carrying out the method of any of Examples 31 to 61.

According to Example 65, a device includes one or more processors configured to obtain conditional input of a compression network, wherein the conditional input is based one or more first predicted motion values; and process, using the compression network, the conditional input and one or more motion values to generate encoded data associated with the one or more motion values.

Example 66 includes the device of Example 65, wherein the one or more motion values are based on output of one or more sensors.

Example 67 includes the device of Example 66, wherein the one or more sensors include an inertial measurement unit (IMU).

Example 68 includes the device of any of Examples 65 to 67, wherein the one or more motion values represent one or more motion vectors associated with one or more image units.

Example 69 includes the device of Example 68, wherein an image unit of the one or more image units includes a coding unit.

Example 70 includes the device of Example 68 or Example 69, wherein an image unit of the one or more image units includes a block of pixels.

Example 71 includes the device of any of Examples 68 to 70, wherein an image unit of the one or more image units includes a frame of pixels.

Example 72 includes the device of any of Examples 65 to 71 and further includes a modem configured to transmit a bitstream to a decoder device, wherein the bitstream includes the encoded data.

Example 73 includes the device of any of Examples 65 to 72, wherein the one or more processors are integrated in at least one of a headset, a mobile communication device, an extended reality (XR) device, or a vehicle.

Example 74 includes the device of any of Examples 65 to 73, wherein the one or more motion values indicate one or more of linear velocity, linear acceleration, linear position, angular velocity, angular acceleration, or angular position.

Example 75 includes the device of any of Examples 65 to 74, wherein the compression network includes a neural network with multiple layers.

Example 76 includes the device of any of Examples 65 to 75, wherein the compression network includes a video encoder, and wherein the video encoder has multiple encoder layers configured to encode higher orders of resolution of video data associated with the one or more motion values.

Example 77 includes the device of any of Examples 65 to 76, further comprising a modem configured to transmit a bitstream to a decoder device, wherein the bitstream includes the encoded data.

Example 78 includes the device of any of Examples 65 to 77, wherein the one or more processors are configured to: process the conditional input using the compression network to generate feature data; and process, using the compression network, the one or more motion values and the feature data to generate the encoded data.

Example 79 includes the device of Example 78, further comprising a modem configured to transmit a bitstream to a decoder device, wherein the bitstream includes the feature data and the encoded data.

Example 80 includes the device of Example 78 or Example 79, wherein the feature data includes multi-scale feature data having different spatial resolutions.

Example 81 includes the device of any of Examples 78 to 80, wherein the feature data includes multi-scale wavelet transform data.

Example 82 includes the device of any of Examples 65 to 81, wherein the one or more processors are configured to: determine, based on a comparison of an image unit (e.g., x_{b}) and a previous image unit (e.g., xₐ), a first motion value (e.g., \hat{m}_{a→b}) of the one or more motion values; determine, based on a comparison of the image unit and a subsequent image unit (e.g., x_{c}), a second motion value (e.g., \hat{m}_{c→b}) of the one or more motion values; determine estimated motion values (e.g., \hat{m}_{a→c}, \hat{m}_{c→a}) based on a comparison of a reconstructed previous image unit (e.g., \hat{x}ₐ) and a reconstructed subsequent image unit (e.g., \hat{x}_{c}); process the estimated motion values to generate motion estimation feature data corresponding to the image unit; and process, using the compression network, the motion estimation feature data, the first motion value, the second motion value, and the image unit to generate motion estimation encoded data associated with the image unit, wherein the encoded data includes the motion estimation encoded data.

Example 83 includes the device of Example 82, wherein the one or more first predicted motion values include a first reconstructed motion value (e.g., \hat{m}_{a→b}) and a second reconstructed motion value (e.g., \hat{m}_{c→b}), and wherein the one or more processors are configured to: determine a first estimated version of the image unit based on applying the first reconstructed motion value (e.g., \hat{m}_{a→b}) to a reconstructed previous image unit (e.g., \hat{x}ₐ); determine a second estimated version of the image unit based on applying the second reconstructed motion value (e.g., \hat{m}_{c→b}) to a reconstructed subsequent image unit (e.g., \hat{x}_{c}); generate an estimated image unit (e.g., x̆_{b}) based on a combination of the first estimated version of the image unit and the second estimated version of the image unit; process the estimated image unit (e.g., x̆_{b}) to generate reconstruction feature data; and process, using the compression network, the image unit and the reconstruction feature data to generate reconstruction encoded data associated with the image unit, wherein the encoded data includes the reconstruction encoded data.

Example 84 includes the device of any of Examples 65 to 81, wherein the one or more processors are configured to: determine, based on a comparison of an image unit (e.g., x_{d}) and a previous image unit (e.g., x_{c}), a motion value (e.g., m_{c→d}) of the one or more motion values; determine a first estimated motion value (e.g., \hat{m}_{b→c}) based on a comparison of a first reconstructed previous image unit (e.g., \hat{x}_{c}) and a second reconstructed previous element (e.g., \hat{x}_{b}); process at least the first estimated motion value to generate motion estimation feature data corresponding to the image unit; and process, using the compression network, the motion estimation feature data, the motion value, and the image unit to generate motion estimation encoded data associated with the image unit, wherein the encoded data includes the motion estimation encoded data.

Example 85 includes the device of Example 84, wherein the one or more processors are configured to determine a second estimated motion value (e.g., \hat{m}_{a→b}) based on a comparison of the second reconstructed previous element (e.g., \hat{x}_{b}) and a third reconstructed previous element (e.g., \hat{x}ₐ), wherein the motion estimation feature data corresponding to the image unit is further based on processing the second estimated motion value.

Example 86 includes the device of Example 84 or Example 85, wherein the one or more first predicted motion values include a first reconstructed motion value (e.g., \hat{m}_{c→d}), and wherein the one or more processors are configured to: determine an estimated image unit (e.g., x̆_{d}) based on applying the first reconstructed motion value (e.g., \hat{m}_{c→d}) to the first reconstructed previous image unit (e.g., \hat{x}_{c}); process the estimated image unit (e.g., x̆_{d}) to generate reconstruction feature data; and process, using the compression network, the image unit and the reconstruction feature data to generate reconstruction encoded data associated with the image unit, wherein the encoded data includes the reconstruction encoded data.

According to Example 87, a method includes obtaining, at a device, conditional input of a compression network, wherein the conditional input is based one or more first predicted motion values; and processing, using the compression network, the conditional input and one or more motion values to generate encoded data associated with the one or more motion values.

Example 88 includes the method of Example 87, further includes processing, at the device, the conditional input using the compression network to generate feature data; and processing, using the compression network, the one or more motion values and the feature data to generate the encoded data.

Example 89 includes the method of Example 87 or Example 88, wherein the feature data includes multi-scale feature data having different spatial resolutions.

Example 90 includes the method of any of Examples 87 to 89, wherein the one or more motion values are based on output of one or more sensors.

Example 91 includes the method of Example 90, wherein the one or more sensors include an inertial measurement unit (IMU).

Example 92 includes the method of any of Examples 87 to 91, wherein the one or more motion values represent one or more motion vectors associated with one or more image units.

Example 93 includes the method of Example 92, wherein an image unit of the one or more image units includes a coding unit.

Example 94 includes the method of Example 92 or Example 93, wherein an image unit of the one or more image units includes a block of pixels.

Example 95 includes the method of any of Examples 92 to 94, wherein an image unit of the one or more image units includes a frame of pixels.

Example 96 includes the method of any of Examples 87 to 95 and further includes transmitting a bitstream via a modem to a decoder device, wherein the bitstream includes the encoded data.

Example 97 includes the method of any of Examples 87 to 96, wherein the device includes at least one of a headset, a mobile communication device, an extended reality (XR) device, or a vehicle.

Example 98 includes the method of any of Examples 87 to 97, wherein the one or more motion values indicate one or more of linear velocity, linear acceleration, linear position, angular velocity, angular acceleration, or angular position.

Example 99 includes the method of any of Examples 87 to 98, wherein the compression network includes a neural network with multiple layers.

Example 100 includes the method of any of Examples 97 to 99, wherein the compression network includes a video encoder, and wherein the video encoder has multiple encoder layers configured to encode higher orders of resolution of video data associated with the one or more motion values.

Example 101 includes the method of any of Examples 87 to 100, further including transmitting a bitstream via a modem to a decoder device, wherein the bitstream includes the encoded data.

Example 102 includes the method of any of Examples 87 to 101 and further including: processing the conditional input using the compression network to generate feature data; and processing, using the compression network, the one or more motion values and the feature data to generate the encoded data.

Example 103 includes the method of Example 102, further including transmitting a bitstream via a modem to a decoder device, wherein the bitstream includes the feature data and the encoded data.

Example 104 includes the method of Example 102 or Example 103, wherein the feature data includes multi-scale feature data having different spatial resolutions.

Example 105 includes the method of any of Examples 102 to 104, wherein the feature data includes multi-scale wavelet transform data.

Example 106 includes the method of any of Examples 87 to 105 and including: determining, based on a comparison of an image unit (e.g., \hat{x}_{b}) and a previous image unit (e.g., \hat{x}ₐ), a first motion value (e.g., m_{a→b}) of the one or more motion values; determining, based on a comparison of the image unit and a subsequent image unit (e.g., \hat{x}_{c}), a second motion value (e.g., m_{c→b}) of the one or more motion values; determine estimated motion values (e.g., \hat{m}_{a→c}, \hat{m}_{c→a}) based on a comparison of a reconstructed previous image unit (e.g., \hat{x}ₐ) and a reconstructed subsequent image unit (e.g., \hat{x}_{c}); processing the estimated motion values to generate motion estimation feature data corresponding to the image unit; and processing, using the compression network, the motion estimation feature data, the first motion value, the second motion value, and the image unit to generate motion estimation encoded data associated with the image unit, wherein the encoded data includes the motion estimation encoded data.

Example 107 includes the method of Example 106 and further including: determining a first estimated version of the image unit based on applying a first reconstructed motion value (e.g., \hat{m}_{a→b}) to a reconstructed previous image unit (e.g., \hat{x}ₐ), wherein the one or more first predicted motion values include the first reconstructed motion value (e.g., \hat{m}_{a→b}); determining a second estimated version of the image unit based on applying a second reconstructed motion value (e.g., \hat{m}_{c→b}) to a reconstructed subsequent image unit (e.g., \hat{x}_{c}), wherein the one or more first predicted motion values include the second reconstructed motion value (e.g., \hat{m}_{c→b}); generating an estimated image unit (e.g., x̆_{b}) based on a combination of the first estimated version of the image unit and the second estimated version of the image unit; processing the estimated image unit (e.g., x̆_{c}) to generate reconstruction feature data; and processing, using the compression network, the image unit and the reconstruction feature data to generate reconstruction encoded data associated with the image unit, wherein the encoded data includes the reconstruction encoded data.

Example 108 includes the method of any of Examples 87 to 105 and further including: determining, based on a comparison of an image unit (e.g., x_{d}) and a previous image unit (e.g., x_{c}), a motion value (e.g., m_{c→d}) of the one or more motion values; determining a first estimated motion value (e.g., \hat{m}_{b→c}) based on a comparison of a first reconstructed previous image unit (e.g., \hat{x}_{c}) and a second reconstructed previous element (e.g., \hat{x}_{b}); processing at least the first estimated motion value to generate motion estimation feature data corresponding to the image unit; and processing, using the compression network, the motion estimation feature data, the motion value, and the image unit to generate motion estimation encoded data associated with the image unit, wherein the encoded data includes the motion estimation encoded data.

Example 109 includes the method of Example 108 and further including determining a second estimated motion value (e.g., \hat{m}_{a→b}) based on a comparison of the second reconstructed previous element (e.g., \hat{x}_{d}) and a third reconstructed previous element (e.g., \hat{x}ₐ), wherein the motion estimation feature data corresponding to the image unit is further based on processing the second estimated motion value.

Example 110 includes the method of Example 108 or Example 109 and further including: determining an estimated image unit (e.g., x̆_{d}) based on applying a first reconstructed motion value (e.g., \hat{m}_{c→d}) to the first reconstructed previous image unit (e.g., \hat{x}_{c}), wherein the one or more first predicted motion values include the first reconstructed motion value (e.g., \hat{m}_{c→d}); processing the estimated image unit (e.g., x̆ₐ) to generate reconstruction feature data; and processing, using the compression network, the image unit and the reconstruction feature data to generate reconstruction encoded data associated with the image unit, wherein the encoded data includes the reconstruction encoded data.

According to Example 111, a device includes: a memory configured to store instructions; and a processor configured to execute the instructions to perform the method of any of Example 87 to 110.

According to Example 112, a non-transitory computer-readable medium stores instructions that, when executed by a processor, cause the processor to perform the method of any of Examples 87 to 110.

According to Example 113, an apparatus includes means for carrying out the method of any of Examples 87 to 110.

According to Example 114, a non-transitory computer-readable medium includes instructions that, when executed by one or more processors, cause the one or more processors to: obtain encoded data associated with one or more motion values; obtain conditional input of a compression network, wherein the conditional input is based on one or more first predicted motion values; and process, using the compression network, the encoded data and the conditional input to generate one or more second predicted motion values.

According to Example 115, an apparatus includes: means for obtaining encoded data associated with one or more motion values; means for obtaining conditional input of a compression network, wherein the conditional input is based on one or more first predicted motion values; and means for processing, using the compression network, the encoded data and the conditional input to generate one or more second predicted motion values.

According to Example 116, a non-transitory computer-readable medium includes instructions that, when executed by one or more processors, cause the one or more processors to: obtain conditional input of a compression network, wherein the conditional input is based on one or more first predicted motion values; and process, using the compression network, the conditional input and one or more motion values to generate encoded data associated with the one or more motion values.

According to Example 117, an apparatus includes: means for obtaining conditional input of a compression network, wherein the conditional input is based on one or more first predicted motion values; and means for processing, using the compression network, the conditional input and one or more motion values to generate encoded data associated with the one or more motion values.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain encoded data associated with one or more motion values;
obtain conditional input of a compression network, wherein the conditional input is based on one or more first predicted motion values; and
process, using the compression network, the encoded data and the conditional input to generate one or more second predicted motion values.

2. The device of claim 1, wherein the one or more motion values are based on output of one or more sensors.

3. The device of claim 2, wherein the one or more sensors include an inertial measurement unit (IMU).

4. The device of claim 1, wherein the one or more motion values represent one or more motion vectors associated with one or more image units.

5. The device of claim 4, wherein an image unit of the one or more image units includes a coding unit.

6. The device of claim 4, wherein an image unit of the one or more image units includes a block of pixels.

7. The device of claim 4, wherein an image unit of the one or more image units includes a frame of pixels.

8. The device of claim 1, wherein the one or more second predicted motion values represent future motion vectors.

9. The device of claim 1, wherein the one or more second predicted motion values correspond to a reconstructed version of the one or more motion values.

10. The device of claim 1, wherein the one or more processors are integrated in at least one of a headset, a mobile communication device, an extended reality (XR) device, or a vehicle.

11. The device of claim 1, wherein the one or more motion values indicate one or more of linear velocity, linear acceleration, linear position, angular velocity, angular acceleration, or angular position.

12. The device of claim 1, wherein the compression network includes a neural network with multiple layers.

13. The device of claim 1, wherein the compression network includes a video decoder, and wherein the video decoder has multiple decoder layers configured to decode multiple orders of resolution of the encoded data associated with the one or more motion values.

14. The device of claim 1, wherein the one or more processors are configured to track an object associated with the one or more motion values across one or more frames of pixels.

15. The device of claim 14, wherein the one or more second predicted motion values represent a collision avoidance output associated with a vehicle.

16. The device of claim 15, wherein the collision avoidance output indicates a predicted future position of the vehicle relative to the object.

17. The device of claim 15, wherein the collision avoidance output indicates a predicted future position of the vehicle and a predicted future position of the object.

18. The device of claim 1, further comprising a modem configured to receive a bitstream from an encoder device, wherein the bitstream includes the encoded data.

19. A method comprising:
obtaining, at a device, encoded data associated with one or more motion values;
obtaining, at the device, conditional input of a compression network, wherein the conditional input is based on one or more first predicted motion values; and
processing, using the compression network, the encoded data and the conditional input to generate one or more second predicted motion values.

20. The method of claim 19, wherein processing the encoded data and the conditional input includes:
processing the conditional input using the compression network to generate feature data; and
processing the encoded data and the feature data to generate the one or more second predicted motion values.

21. The method of claim 20, wherein the feature data corresponds to multi-scale feature data having different spatial resolutions.

22. The method of claim 20, wherein the feature data includes multi-scale wavelet transform data.

23. A device comprising:
one or more processors configured to:
obtain conditional input of a compression network, wherein the conditional input is based one or more first predicted motion values; and
process, using the compression network, the conditional input and one or more motion values to generate encoded data associated with the one or more motion values.

24. The device of claim 23, wherein the one or more motion values are based on output of one or more sensors.

25. The device of claim 24, wherein the one or more sensors include an inertial measurement unit (IMU).

26. The device of claim 23, wherein the one or more motion values represent one or more motion vectors associated with one or more image units.

27. The device of claim 23, further comprising a modem configured to transmit a bitstream to a decoder device, wherein the bitstream includes the encoded data.

28. A method comprising:
obtaining, at a device, conditional input of a compression network, wherein the conditional input is based one or more first predicted motion values; and
processing, using the compression network, the conditional input and one or more motion values to generate encoded data associated with the one or more motion values.

29. The method of claim 28, further comprising:
processing, at the device, the conditional input using the compression network to generate feature data; and
processing, using the compression network, the one or more motion values and the feature data to generate the encoded data.

30. The method of claim 29, wherein the feature data includes multi-scale feature data having different spatial resolutions.
